(19) United States
(12) Patent Application Publication
(10) Pub. No.: US 2025/0179299 A1
(43) Pub. Date: Jun. 5, 2025

(54) DYES FOR MONITORING CELL STATES

(71) Applicants: SUNNYBROOK RESEARCH INSTITUTE, Toronto (CA); SAGUARO TECHNOLOGIES INC., Québec (CA)

(72) Inventors: David W. ANDREWS, Toronto (CA); Jarkko Veli Joosua YLANKO, Toronto (CA); Yuniel Fernandez MARRERO, Toronto (CA); Martin COTTET, Québec (CA)

(21) Appl. No.: 18/862,071

(22) PCT Filed: May 4, 2023
(86) PCT No.: PCT/CA2023/050607

§ 371 Date: Oct. 31, 2024

Related U.S. Application Data
(60) Provisional application No. 63/364,126, filed on May 4, 2022.

(51) Int. Cl. C09B 23/14; G01N 1/30; G01N 15/14; G01N 21/64

(52) U.S. Cl. CPC C09B 23/145; G01N 1/30; G01N 15/14; G01N 21/6486; G01N 2001/302

(57) ABSTRACT

The present application relates to a dye compound of the formula (I), or a salt thereof. The present application relates to the use of the fluorescent dye or salt for various applications, such as for staining cells and for assessing the effect of an agent on a cell phenotypic state.

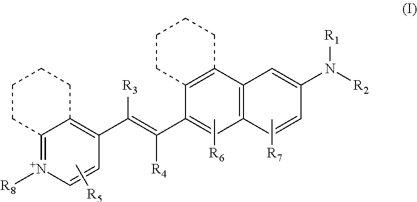

### CROSS REFERENCE TO RELATED APPLICATIONS

The present application claims the benefit of U.S. provisional patent application No. 63/364,126 filed on May 4, 2022, which is incorporated herein by reference in its entirety.

### TECHNICAL FIELD

The present invention generally relates to the field of cell biology, and more particularly to the staining and assessment of cells using dyes.

### BACKGROUND ART

Fluorescent dyes are widely used in biological research and medical diagnostics. Fluorescent dyes are superior to conventional radioactive materials because fluorescent dyes are less expensive and less toxic, and can typically be detected with sufficient sensitivity. Further, the availability of a diversity of fluorophores with distinguishable color ranges has made it more practical to perform multiplexed assays capable of detecting several biological targets at the same time. The ability to visualize multiple targets in parallel is often required for delineating the spatial and temporal relationships amongst different biological targets in vitro and in vivo. Techniques such as spectrum imaging and spectrum flow cytometry are able to resolve even more optical signals than traditional wavelength band-based detection methods by advanced deconvolution of spectral shapes and peak positions. Because infra-red radiation can penetrate deeper into living tissues than visible light, fluorescent dyes are used in vivo if their characteristic wavelengths are sufficiently long. Generally, the availability of a wide range of fluorescent dyes has opened a new avenue for conducting high-throughput and automated assays, thus dramatically reducing the unit cost per assay.

Further improvements in the properties of the dyes are needed in order to meet the increasing demands of new instruments and new biological applications.

The present description refers to a number of documents, the content of which is herein incorporated by reference in their entirety.

### SUMMARY

In various aspects and embodiments, the present disclosure provides the following items 1 to 30:

1. A dye compound of formula I:

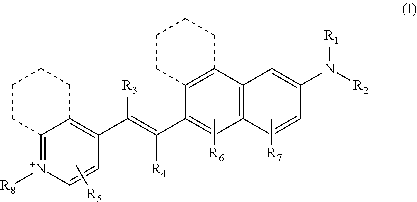

wherein:
R₁ is substituted alkyl_{(C≤14)}, alkenyl_{(C≤14)}, substituted alkenyl_{(C≤14)}, aryl, or substituted aryl;
R₂ is substituted alkyl_{(C≤14)}, alkenyl_{(C≤14)}, substituted alkenyl_{(C≤14)}, aryl, or substituted aryl;
R₃ is hydrogen, Cl, Br, F or CX₃;
R₄ is hydrogen, Cl, Br, F or CX₃;
R₅ is hydrogen, Cl, Br, F or CX₃;
R₆ is hydrogen, Cl, Br, F or CX₃;
R₇ is hydrogen, Cl, Br, F or CX₃; and
R₈ is —(CH₂)ₙSO₃⁻, —(CH₂)ₙN⁺(R₉)₃ or

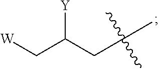

wherein
R₉ is alkyl_{(C≤14)}, substituted alkyl_{(C≤14)}, aryl, or substituted aryl;
Y is H or OH;
W is

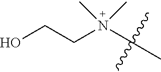

X is H, F, Cl, or Br; and
n is 1, 2, 3, 4, 5, 6, 7, 8, 9 or 10; and
   wherein the dotted lines indicate the presence or absence of a phenyl ring or a substituted phenyl ring, wherein the substituent may be one or more selected from Cl, Br, F, CX₃, alkyl_{(C≤14)}, and substituted alkyl_{(C≤14)},
   or a salt thereof.

2. The dye compound or salt thereof of item 1, having the structure of formula II:

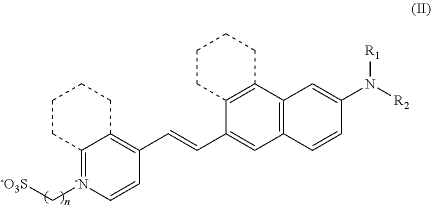

wherein:
R₁ is substituted alkyl_{(C≤14)}, alkenyl_{(C≤14)}, substituted alkenyl_{(C≤14)}, phenyl, or substituted phenyl;
R₂ is substituted alkyl_{(C≤14)}, alkenyl_{(C≤14)}, substituted alkenyl_{(C≤14)}, phenyl, or substituted phenyl; and
n is 1, 2, 3, 4, 5, 6, 7, 8, 9 or 10; and
   wherein the dotted lines indicate the presence or absence of a phenyl ring.

3. The dye compound or salt thereof of item 1 or 2, wherein n is an integer from 1 to 5.

4. The dye compound or salt thereof of item 3, wherein n is an integer from 2 to 4.

5. The dye compound or salt thereof of item 4, wherein n is 3.

6. The dye compound or salt thereof of any one of items 1 to 5, wherein R₁ and/or R₂ is alkenyl_{(C1-6)} or substituted alkenyl_{(C1-6)}.

7. The dye compound or salt thereof of any one of items 1 to 5, wherein R₁ and/or R₂ is phenyl, or substituted phenyl.

8. The dye compound or salt thereof of any one of items 1 to 7, wherein R₁ and R₂ are the same.

9. The dye compound or salt thereof of item 8, wherein NR₁R₂ is

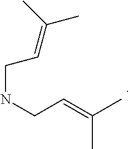

10. The dye compound or salt thereof of item 8, wherein NR₁R₂ is

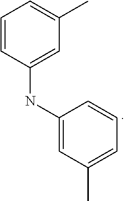

11. The dye compound or salt thereof of item 1 or 2, having a structure selected from:

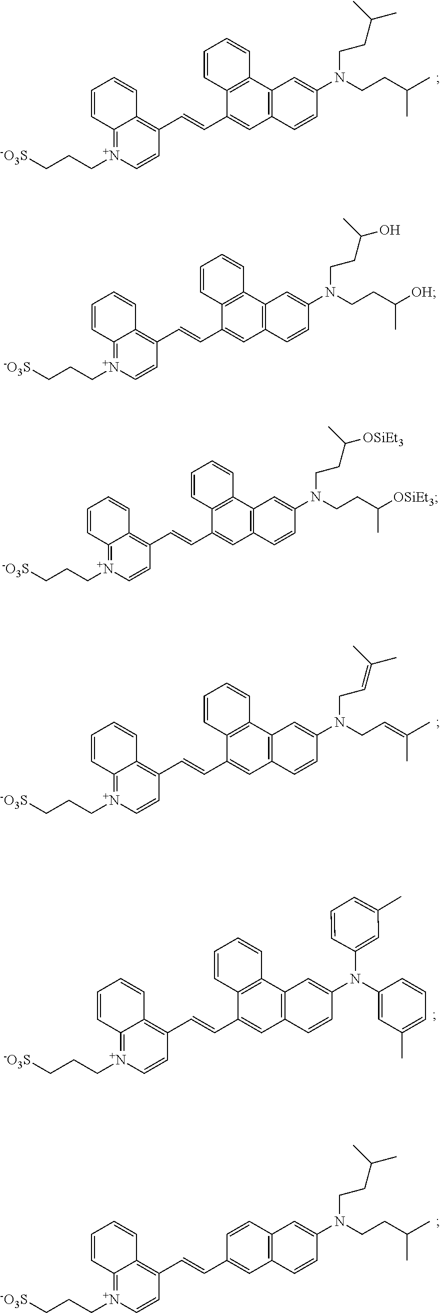

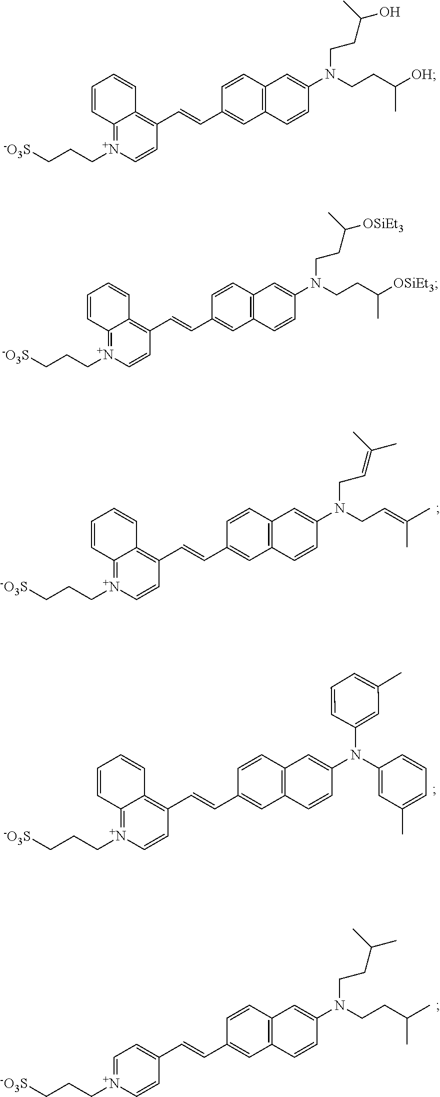

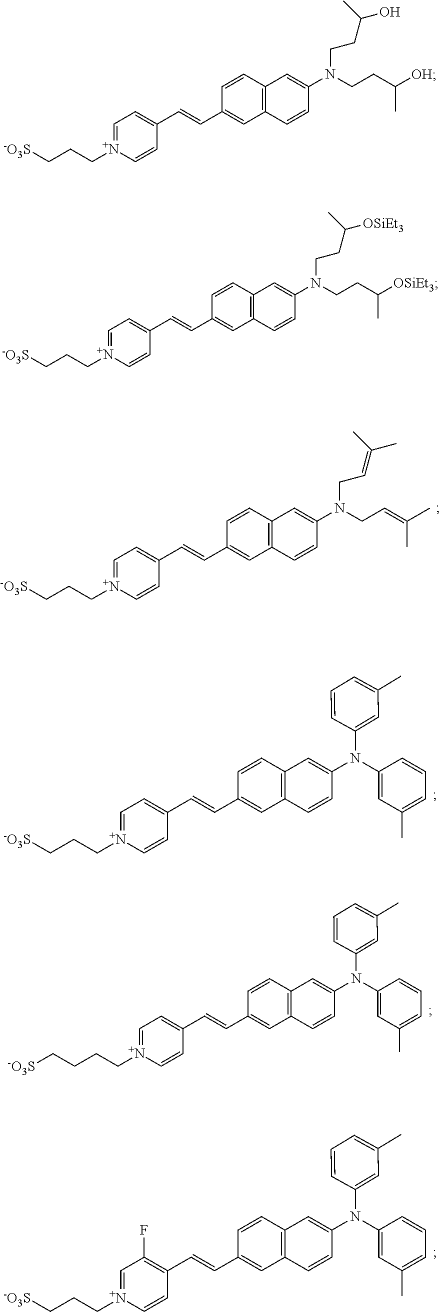

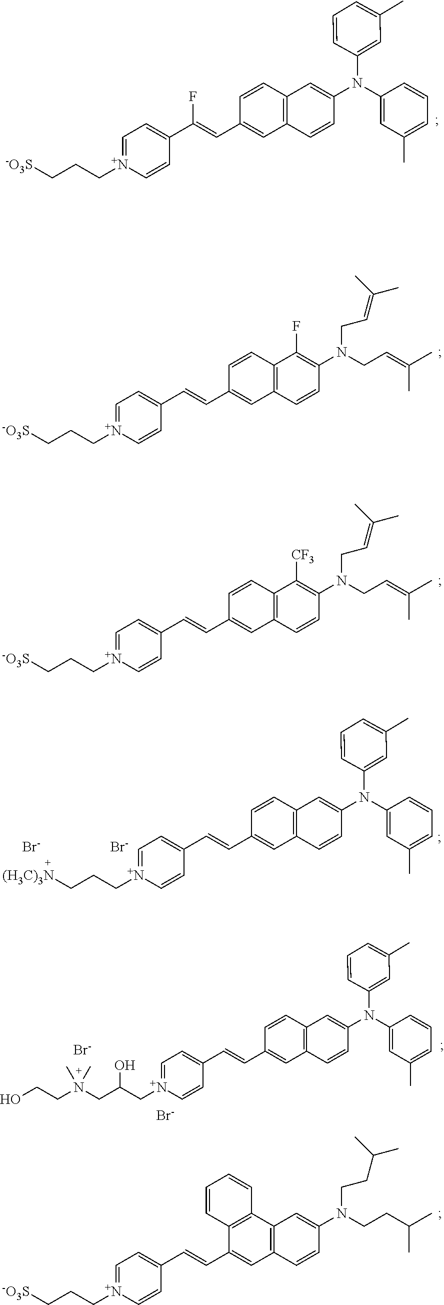

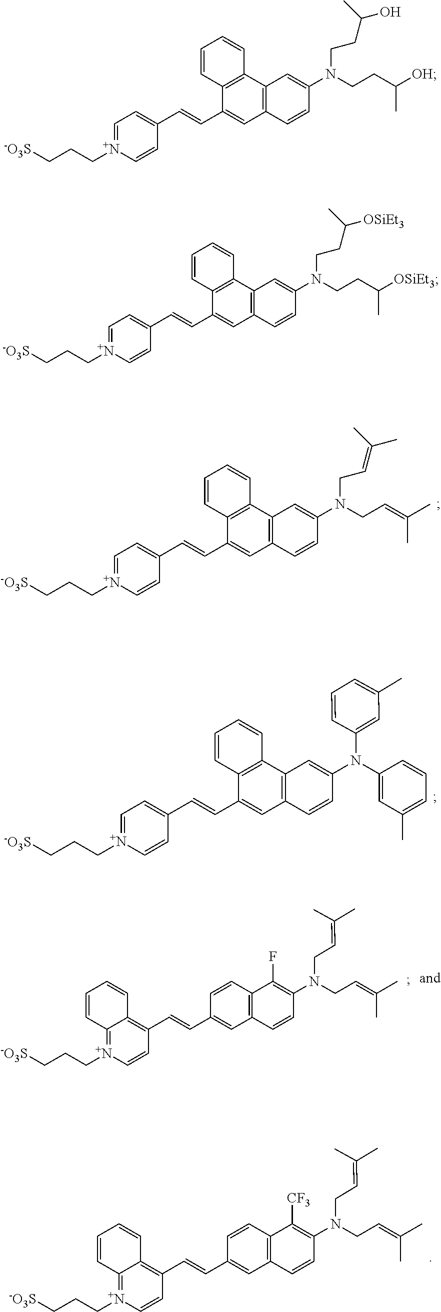

12. The dye compound or salt thereof of item 11, having the following structure:

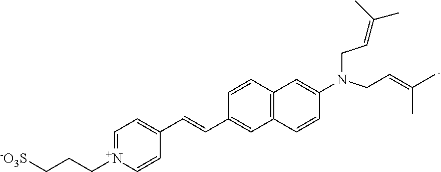

13. The dye compound or salt thereof of item 11, having the following structure:

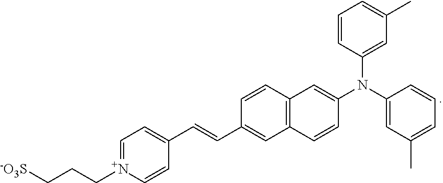

14. A kit comprising the dye compound according to any one of items 1 to 13.

15. The kit of item 14, further comprising instructions for using the dye compound or salt thereof.

16. The kit of item 14 or 15, further comprising one or more containers.

17. The kit of any one of items 14 to 16, further comprising at least one additional dye.

18. A method for staining a cell comprising contacting the cell with the dye compound or salt thereof according to any one of items 1 to 13.

19. A method for determining whether an agent induces a change in a cell phenotypic state comprising detecting the fluorescence of a dye compound of formula (I):

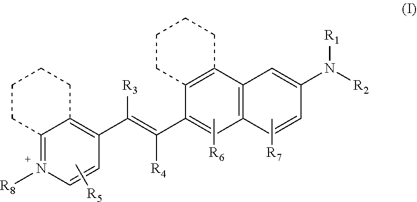

wherein:
R₁ is H, alkyl, substituted alkyl_{(C≤14)}, alkenyl_{(C≤14)}, substituted alkenyl_{(C≤14)}, aryl, or substituted aryl;
R₂ is H, alkyl, substituted alkyl_{(C≤14)}, alkenyl_{(C≤14)}, substituted alkenyl_{(C≤14)}, aryl, or substituted aryl;
R₃ is hydrogen, Cl, Br, F or CX₃;
R₄ is hydrogen, Cl, Br, F or CX₃;
R₅ is hydrogen, Cl, Br, F or CX₃;
R₆ is hydrogen, Cl, Br, F or CX₃;
R₇ is hydrogen, Cl, Br, F or CX₃; and
R₈ is —(CH₂)ₙSO₃⁻, —(CH₂)ₙN⁺(R₉)₃ or

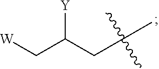

wherein
R₉ is alkyl_{(C≤14)}, substituted alkyl_{(C≤14)}, aryl, or substituted aryl;
   Y is H or OH;
   W is

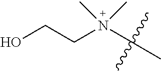

X is H, F, Cl, or Br; and
n is 1, 2, 3, 4, 5, 6, 7, 8, 9 or 10; and
   wherein the dotted lines indicate the presence or absence of a phenyl ring or a substituted phenyl ring, wherein the substituent may be one or more selected from Cl, Br, F, CX₃, alkyl_{(C≤14)}, and substituted alkyl_{(C≤14)},
   or a salt thereof;
   in the cell in the presence or absence of the agent, wherein a change in the florescence intensity and/or distribution in the cell in the presence of the agent relative to the absence thereof is indicative that the agent induces a change in the cell phenotypic state.

20. A method for determining whether an agent induces apoptosis in a cell comprising measuring the fluorescence intensity of the dye compound or salt thereof defined in item 19 in the cell in the presence or absence of the agent, wherein a higher florescence intensity in in the presence of the agent relative to the absence thereof is indicative that the agent induces apoptosis in the cell.

21. The method of item 19 or 20, wherein the dye compound or salt thereof is the dye compound or salt thereof according to any one of items 1 to 13.

22. The method of any one of items 18 to 21, further comprising contacting the cell with an excitation light and detecting the emission signal from the dye.

23. The method of item 22, wherein the excitation light has a wavelength of about 400 to about 650 nm, about 480 to about 500 nm, preferably about 488 nm.

24. The method of item 22 or 23, wherein the emission signal is detected at a wavelength of between about 450 nm to about 850 nm, about 520 nm to about 750 n, about 500 to about 700 nm, preferably between about 520 to about 690 nm.

25. The method of any one of items 14 to 17, wherein the method does not comprise a washing step.

26. The method of any one of items 18 to 25, wherein the method further comprises contacting the cell with at least one additional dye.

27. The method of any one of items 19 to 26, wherein the fluorescence intensity is measured by microscopy or flow cytometry.

28. The method of any one of items 18 to 27, wherein the cell is a tumor cell.

29. The method of item 28, wherein the tumor cell is a primary tumor cell or a tumor cell line.

30. The method of item 28 or 29, wherein the agent is an antitumor agent or a candidate antitumor agent.

Other objects, advantages and features of the present disclosure will become more apparent upon reading of the following non-restrictive description of specific embodiments thereof, given by way of example only with reference to the accompanying drawings.

### BRIEF DESCRIPTION OF DRAWINGS

The following figures/drawings form part of the present specification and are included to further demonstrate certain aspects of the present specification. The present specification may be better understood by reference to one or more of these figures/drawings in combination with the detailed description. In the appended drawings:

FIG. 1 depicts microscopy images showing fluorescence change of MT2 and reference dyes following drug treatment of primary lymphocytes. Primary lymphocytes were cultured for 24 hrs with 1 μM Staurosporine (STS, pan-kinase inhibitor) or DMSO (solvent control). Cells were stained with Hoechst (left images), tetramethylrhodamine ethyl ester (TMRE) (middle images) and MT2 (right images). Scale bar, 20 μm.

FIGS. 2A-E depict microscopy images showing fluorescence change of 1 μM MT3 and reference dyes following drug treatment of non-tumorigenic MCF10A epithelial breast cells.

MCF10A cells were cultured for 24 hrs prior to 72 hr dual treatment with 0.312 μM each of AZD 5991 (Bcl-XL inhibitor) and A1331852 (MCL-1 inhibitor) or DMSO (solvent control). FIG. 2A: cells were stained with Hoechst (left images), TMRE (middle images) and MT3 (right images). Scale bar, 100 μm. FIGS. 2B-E: comparison of the staining pattern of Hoechst, MT3, and TMRE in control and treated MCF10A epithelial breast cells.

FIG. 3 depicts microscopy images showing fluorescence change of 1 μM MT3 and reference dyes following drug treatment of CAMA-1 luminal-type human breast cancer cells. CAMA-1 cells were cultured for 24 hrs prior to 72 hr dual treatment with 0.312 μM each of AZD 5991 (Bcl-XL inhibitor) and A1331852 (MCL-1 inhibitor) or DMSO (solvent control). Cells were stained with Hoechst (left images), TMRE (middle images) and MT3 (right images). Scale bar, 100 μm.

FIG. 4 depicts microscopy images showing fluorescence change of MT3 and reference dyes following drug treatment of MCF-7 human epithelial breast adenocarcinoma cells. MCF-7 cells were cultured for 24 hrs prior to 72 hr dual treatment with 0.312 μM each of AZD 5991 (Bcl-XL inhibitor) and A1331852 (MCL-1 inhibitor) or DMSO (solvent control). Cells were stained with Hoechst (left images), TMRE (middle images) and MT3. Scale bar, 100 μm.

FIG. 5 depicts microscopy images showing fluorescence change of MT3 and reference dyes following drug treatment of Zr-75-1 epithelial breast ductal carcinoma cells. Zr-75-1 cells were cultured for 24 hrs prior to 72 hr dual treatment with 0.312 μM each of AZD 5991 (Bcl-XL inhibitor) and A1331852 (MCL-1 inhibitor) or DMSO (solvent control). Cells were stained with Hoechst (left images), TMRE (middle images) and MT3 (right images). Scale bar, 100 μm.

FIG. 6 depicts microscopy images showing fluorescence change of MT3 and reference dyes following drug treatment of MDA-MB-231 epithelial breast adenocarcinoma cells. MDA-MB-231 cells were cultured for 24 hrs prior to 72 hr dual treatment with 0.312 μM each of AZD 5991 (Bcl-XL inhibitor) and A1331852 (MCL-1 inhibitor) or DMSO (solvent control). Cells were stained with Hoechst (left images), TMRE (middle images) and MT3 (right images). Scale bar, 100 μm.

FIG. 7 depicts microscopy images showing fluorescence change of MT3 and reference dyes following drug treatment of MDA-MB-468 epithelial breast adenocarcinoma cells. MDA-MB-468 cells were cultured for 24 hrs prior to 72 hr dual treatment with 0.312 μM each of AZD 5991 (Bcl-XL inhibitor) and A1331852 (MCL-1 inhibitor) or DMSO (solvent control). Cells were stained with Hoechst (left images), TMRE (middle images) and MT3. Scale bar, 100 μm.

FIG. 8 depicts microscopy images showing fluorescence change of MT3 and reference dyes following drug treatment of T47D epithelial breast ductal carcinoma cells. T47D cells were cultured for 24 hrs prior to 72 hr dual treatment with 0.312 μM each of AZD 5991 (Bcl-XL inhibitor) and A1331852 (MCL-1 inhibitor) or DMSO (solvent control). Cells were stained with Hoechst (left images), TMRE (middle images) and MT3 (right images). Scale bar, 100 μm.

FIG. 9 depicts microscopy images showing fluorescence change of MT2 and reference dyes following drug treatment of MCF-7 human epithelial breast adenocarcinoma cells. MCF-7 cells were cultured for 12 hrs in standard conditions and treated with drugs to induce autophagy (Rapamycin), endoplasmic reticulum stress (Thapsigargin), apoptosis (Tumor Necrosis Factor alpha, TNFα, and Cyclohexamide, CHx), or solvent control (DMSO). Dye MT2 was excited at 488 nm, and emission was simultaneously collected at three wavelengths, 520 nm (Green), 600 nm (Red), and 690 (Far Red) nm.

FIG. 10 is an illustration of a ¹³C NMR spectrum of the MT1 dye in accordance with an embodiment of the present disclosure.

FIG. 11 is an illustration of an m/z (M−H) spectrum of the MT2 dye in accordance with an embodiment of the present disclosure.

FIGS. 12A-D depict graphs comparing the emission profiles of MT2 (FIG. 12A), MT3 (FIG. 12B), MT4 (FIG. 12C) and MT5 (FIG. 120) to that of MT1 in untreated cells. Membrane indicates manually selected membrane regions. Cytoplasm includes granular contents. Intensity profiles were measured on manually defined regions of interest in ImageJ and were normalized to the maximum membrane emission intensity of each respective dye.

FIGS. 13A and 13B depicts images of MCF10A cell ascinar structures at Day 19 following staining with the indicated dyes.

FIGS. 14A-J depict microscopy images showing staining of MCF7 cells with 1 μM of the following dyes: MT3 (FIG. 14A), MT20 (FIG. 14B), MT21 (FIG. 14C), MT22 (FIG. 14D), MT23 (FIG. 14E), MT24 (FIG. 14F), MT25 (FIG. 14G), MT26 (FIG. 14H), MT27 (FIG. 14I), and MT28 (FIG. 14J). Scale bar, 25 μm.

### DETAILED DISCLOSURE

The use of the terms “a” and “an” and “the” and similar referents in the context of describing the technology (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted.

All methods described herein can be performed in any suitable order unless otherwise indicated herein or otherwise clearly contradicted by context.

The use of any and all examples, or exemplary language (“e.g.”, “such as”) provided herein, is intended merely to better illustrate embodiments of the claimed technology and does not pose a limitation on the scope unless otherwise claimed.

No language in the specification should be construed as indicating any non-claimed element as essential to the practice of embodiments of the claimed technology.

Herein, the term “about” has its ordinary meaning. The term “about” is used to indicate that a value includes an inherent variation of error for the device or the method being employed to determine the value, or encompass values close to the recited values, for example within 10% of the recited values (or range of values).

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

Where features or aspects of the disclosure are described in terms of Markush groups or list of alternatives, those skilled in the art will recognize that the disclosure is also thereby described in terms of any individual member, or subgroup of members, of the Markush group or list of alternatives.

Unless specifically defined otherwise, all technical and scientific terms used herein shall be taken to have the same meaning as commonly understood by one of ordinary skill in the art (e.g., in stem cell biology, cell culture, molecular genetics, immunology, immunohistochemistry, protein chemistry, and biochemistry).

Unless otherwise indicated, the recombinant protein, cell culture, and immunological techniques utilized in the present disclosure are standard procedures, well known to those skilled in the art. Such techniques are described and explained throughout the literature in sources such as, J. Perbal, A Practical Guide to Molecular Cloning, John Wiley and Sons (1984), J. Sambrook et al., Molecular Cloning: A Laboratory Manual, Cold Spring Harbour Laboratory Press (1989), T.

A. Brown (editor), Essential Molecular Biology: A Practical Approach, Volumes 1 and 2, IRL Press (1991), D. M. Glover and B. D. Hames (editors), DNA Cloning: A Practical Approach, Volumes 1-4, IRL Press (1995 and 1996), and F. M. Ausubel et al. (editors), Current Protocols in Molecular Biology, Greene Pub. Associates and Wiley-Interscience (1988, including all updates until present), Ed Harlow and David Lane (editors) Antibodies: A Laboratory Manual, Cold Spring Harbour Laboratory, (1988), and J. E. Coligan et al. (editors) Current Protocols in Immunology, John Wiley & Sons (including all updates until present).

In the context of chemical formulas, the symbol “ [symbol] .” means a single bond, “ [symbol] ,” means a double bond, and “ [symbol] ” means a triple bond. The symbol “ [symbol] ” represents an optional bond, which if present is either single or double. The symbol “ [symbol] ” represents a single bond or a double bond. Furthermore, it is noted that the covalent bond symbol “ [symbol] .”, when connecting one or two stereogenic atoms, does not indicate any preferred stereochemistry. Instead, it covers all stereoisomers as well as mixtures thereof. The symbol” [symbol] ” means a single bond where the geometry around a double bond (e.g., either E or Z) is undefined. Both options, as well as combinations thereof are therefore intended. Any undefined valency on an atom of a structure shown in this application implicitly represents a hydrogen atom bonded to that atom.

As used herein, the term “alkyl” refers to straight-chain or branched-chain alkyl residues. This also applies if they carry substituents or occur as substituents on other residues, for example in alkoxy residues, alkoxycarbonyl residues or arylalkyl residues. Substituted alkyl residues are substituted in any suitable position. Examples of alkyl residues containing from 1 to 18 carbon atoms are methyl, ethyl, propyl, butyl, pentyl, hexyl, heptyl, octyl, nonyl, decyl, undecyl, dodecyl, tetradecyl, hexadecyl and octadecyl, the n-isomers of all these residues, isopropyl, isobutyl, isopentyl, neopentyl, isohexyl, isodecyl, 3-methylpentyl, 2,3,4-trimethylhexyl, sec-butyl, tert-butyl, or tert-pentyl. A specific group of alkyl residues is formed by the residues methyl, ethyl, n-propyl, isopropyl, n-butyl, isobutyl, sec-butyl and tert-butyl.

As used herein, the term “alkenyl” refers to straight-chain or branched-chain alkyl residues containing from 2 to 18 carbons, and having at least one carbon-carbon double bond. This also applies if they carry substituents or occur as substituents on other residues. Substituted alkenyl residues are substituted in any suitable position. Examples of alkenyl residues, as used herein include, vinyl (ethenyl), propenyl, 2-methyl-1-propenyl, 1-butenyl, 2-butenyl, and isobutenyl.

The term “aryl” as used herein, represents mono- and/or bicyclic carbocyclic ring systems and/or multiple rings fused together and is exemplified by phenyl, naphthyl, 1,2-dihydronaphthyl, 1,2,3,4-tetrahydronaphthyl, fluorenyl, indanyl, indenyl and the like and may be optionally substituted with one, two, three, four or five substituents.

The term “substituted” as used herein is generally understood to include all permissible substituents of organic compounds, provided a) that such substitution is in accordance with permitted valence of the substituted atom and the substituent and b) that the substitution results in a compound sufficiently stable to perform under the conditions practical for the disclosed method, i.e. that a compound does not spontaneously undergo transformation such as by rearrangement, fragmentation, elimination, hydrolysis etc. long enough to practically perform as disclosed herein. More specifically, the term “substituted” as used herein, may refer to the presence of one or more substituents including straight or branched alkyl, in particular C1-C4 alkyl, e.g. methyl, ethyl, propyl, butyl, including isoalkyl, e.g. isopropyl, isobutyl, a secondary alkyl group, e.g. but-2-yl, a tert-alkyl group, e.g., 2-methylpropyl, alkenyl, alkynyl, aryl, hetaryl and functional groups such as halogen (fluoro, chloro, bromo, iodo), hydroxy, alkoxy, mercapto, alkylthio, amino, cyano, carboxylic acid, ester, ether, amide, sulfonamide, phosphonate, etc.

In the studies presented herein, new non-cytotoxic fluorescent dyes are described. Changes in the fluorescence emission properties of these dyes in cells were shown to correlate with changes in cell state. Notably, fluorescence intensity was shown to be increased following treatment of cells with cytotoxic agents. Some of the fluorescent dyes according to the present disclosure were shown to be compatible with a “mix and read” procedure, i.e., they only emit fluorescence in the cells and do not require a washing step to get rid of the dye in the medium. Also, compared to other dyes such as Hoechst and TMRE that stain the same structures in a predictable way, fluorescent dyes according to the present disclosure stain the plasma membrane under certain conditions and stain the nuclei under other conditions, and thus may provide more information about the cell state.

The present disclosure relates to dye compounds of formula I, or salts thereof:

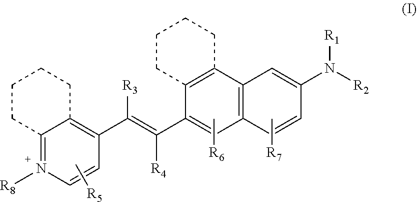

wherein R₁ is hydrogen, alkyl_{(C≤14)}, substituted alkyl_{(C≤14)}, alkenyl_{(C≤14)}, substituted alkenyl_{(C≤14)}, aryl, or substituted aryl; R₂ is alkyl_{(C≤14)}, substituted alkyl_{(C≤14)}, alkenyl_{(C≤14)}, substituted alkenyl_{(C≤14)}, aryl, or substituted aryl; R₃ is hydrogen, Cl, Br, F or CX₃; R₄ is hydrogen, Cl, Br, F or CX₃; R₅ is hydrogen, Cl, Br, F or CX₃; R₆ is hydrogen, Cl, Br, F or CX₃; R₇ is hydrogen, Cl, Br, F or CX₃; R₈ is —(CH₂)ₙSO₃⁻, (CH₂)ₙN⁺(R₉)₃ or

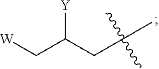

wherein R₉ is alkyl_{(C≤14)}, substituted alkyl_{(C≤14)}, aryl, or substituted aryl; Y is H or OH; W is

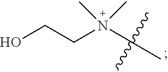

X is H, F, Cl, or Br; and n is 1, 2, 3, 4, 5, 6, 7, 8, 9 or 10; and wherein the dotted lines indicate the presence or absence of a phenyl ring or a substituted phenyl ring, wherein the substituent may be one or more selected from Cl, Br, F, CX₃, alkyl_{(C≤14)}, and substituted alkyl_{(C≤14)}.

In an embodiment, the fluorescent dye is not:

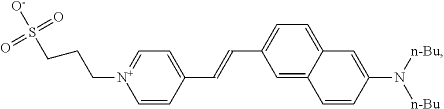

The term “dye” or “dye compound” as used herein refers to a compound that emits light to produce an observable detectable signal.

In an embodiment, R₁ is alkyl_{(C1-6)}, substituted alkyl_{(C1-6)}, alkenyl_{(C1-6)} or substituted alkenyl_{(C1-6)}. In a further embodiment, R₁ is substituted alkyl_{(C3-6)}, alkenyl_{(C3-6)} or substituted alkenyl_{(C3-6)}. In an embodiment, R₁ is a substituted alkyl_{(C3-6)} or substituted alkenyl_{(C3-6)}. In a further embodiment, R₁ is a substituted alkenyl_{(C3-6)}. In an embodiment, the substituent on the alkyl or alkenyl is alkyl. In another embodiment, the substituent on the alkyl or alkenyl is OR₉, wherein R₉ is H or trialkylsilane (e.g., trimethylsilane, triethylsilane). In another embodiment, R₁ is phenyl or substituted phenyl. In an embodiment, the phenyl is substituted with an alkyl, for example an alkyl_{(C1-6)} such as methyl.

In an embodiment, R₂ is alkyl_{(C1-6)}, substituted alkyl_{(C1-6)}, alkenyl_{(C1-6)} or substituted alkenyl_{(C1-6)}. In a further embodiment, R₂ is substituted alkyl_{(C3-6)}, alkenyl_{(C3-6)} or substituted alkenyl_{(C3-6)}. In an embodiment, R₂ is a substituted alkyl or substituted alkenyl. In a further embodiment, R₂ is a substituted alkenyl. In an embodiment, the substituent on the alkyl or alkenyl is alkyl. In another embodiment, the substituent on the alkyl or alkenyl is OR₉, wherein R₉ is H, or trialkylsilane (e.g., trimethylsilane, triethylsilane). In another embodiment, R₂ is phenyl or substituted phenyl. In an embodiment, the phenyl is substituted with an alkyl, for example an alkyl_{(C1-6)} such as methyl.

In an embodiment, R₃ is H or F. In a further embodiment, R₃ is H.

In an embodiment, R₄ is H.

In an embodiment, R₅ is H or F. In a further embodiment, R₅ is H.

In an embodiment, R₆ is H.

In an embodiment, R₇ is H, F or CF₃. In a further embodiment, R₇ is H.

In an embodiment, R₈ is —(CH₂)ₙSO₃⁻.

R₁ and R₂ may be the same or different. In an embodiment, R₁ and R₂ are the same.

In an embodiment, NR₁R₂ is

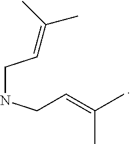

In another embodiment, NR₁R₂ is

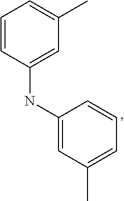

In an embodiment, the dye compound or salt thereof is of formula II:

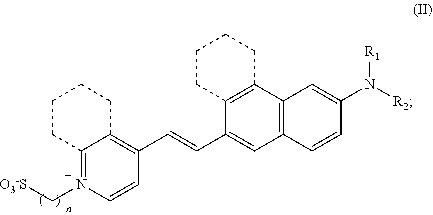

wherein R₁, R₂, n and the dotted lines are as defined herein.

In certain aspects, the present disclosure relates to fluorescent dyes or salts thereof of formula IIa, IIb or IIc:

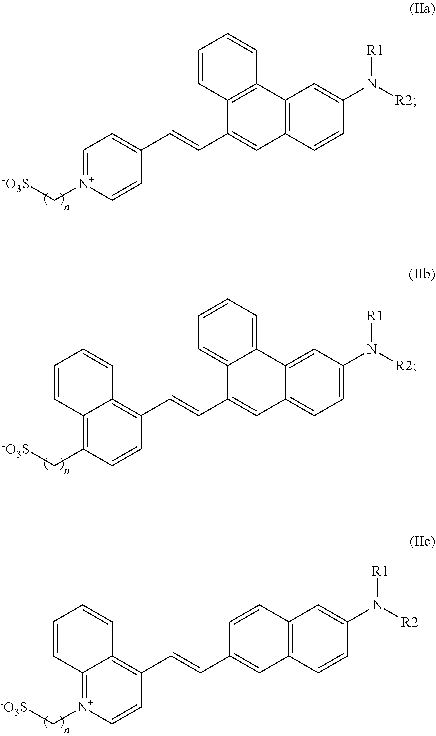

In an embodiment, n is an integer from 1 to 8 or from 1 to 6. In a further embodiment, n is 1, 2, 3, 4 or 5. In a further embodiment, n is 2, 3 or 4, for example 3.

The present disclosure also relates to fluorescent dyes or salts thereof of formula IIIa, IIIb or IIIc:

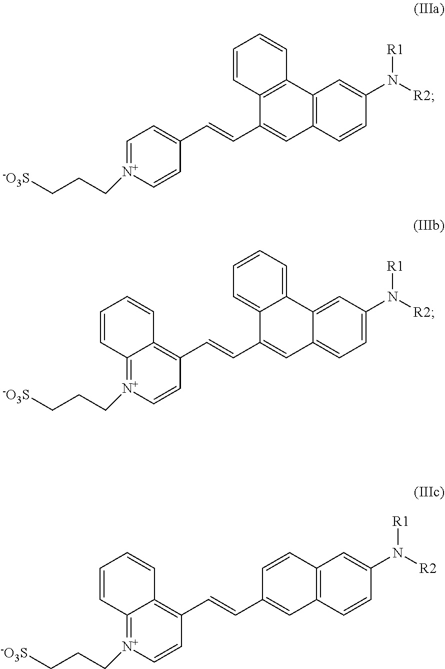

In an embodiment, the dye or salt thereof has one of the following structure:

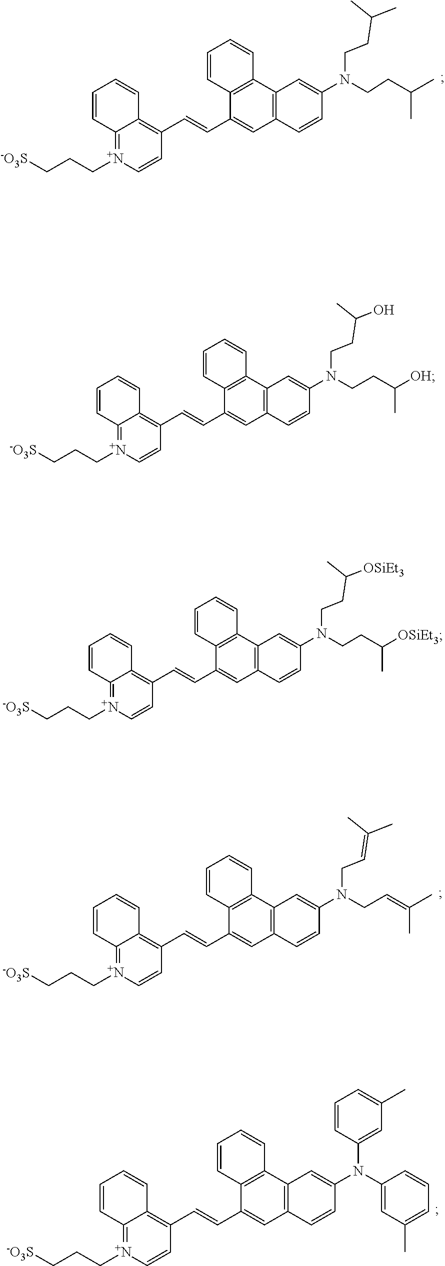

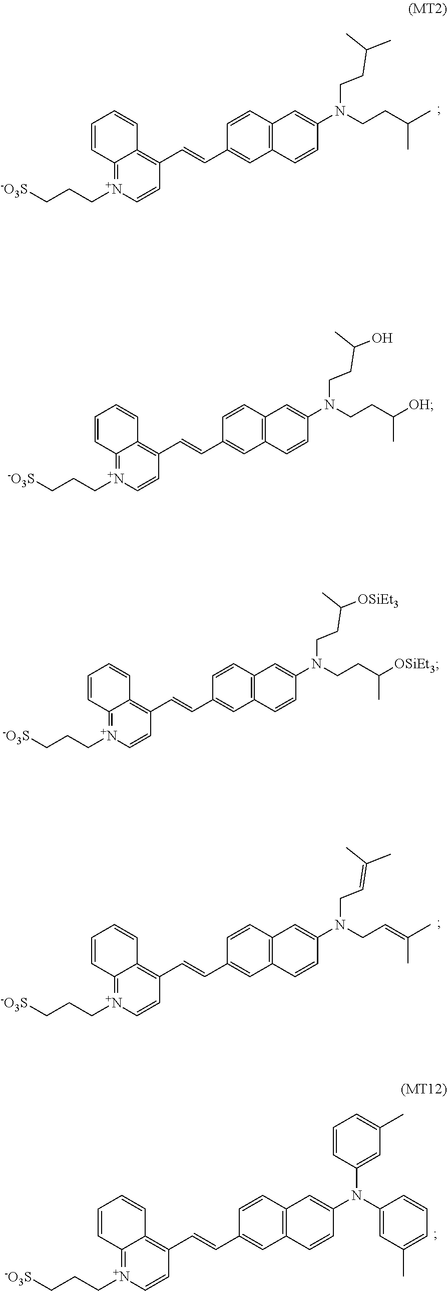

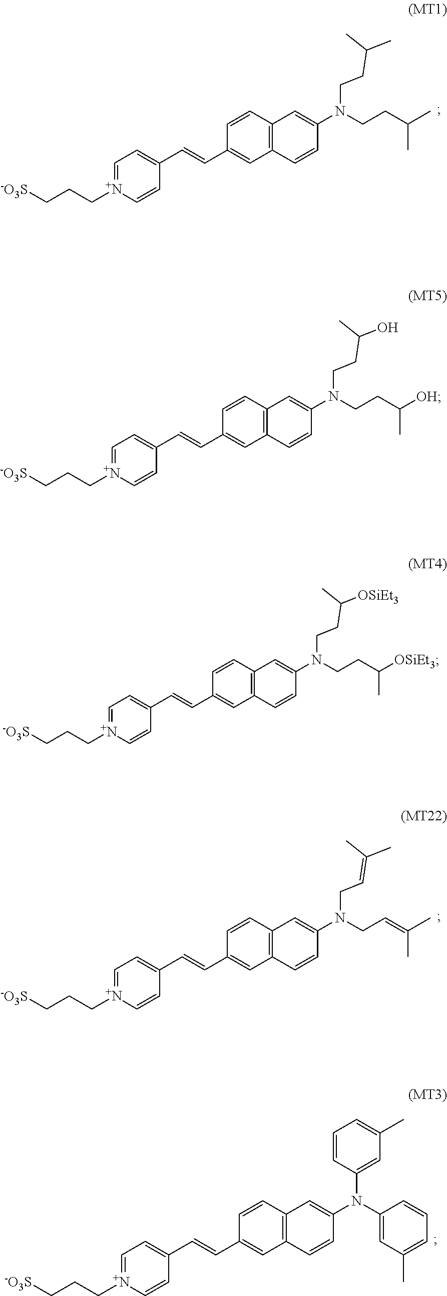

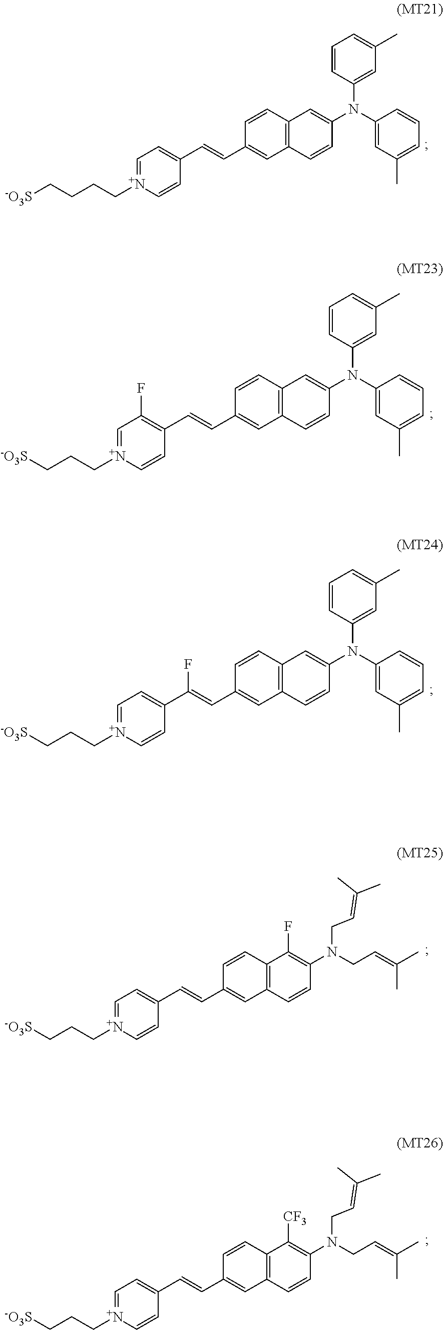

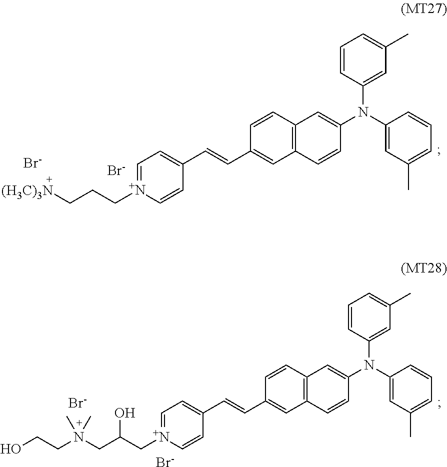

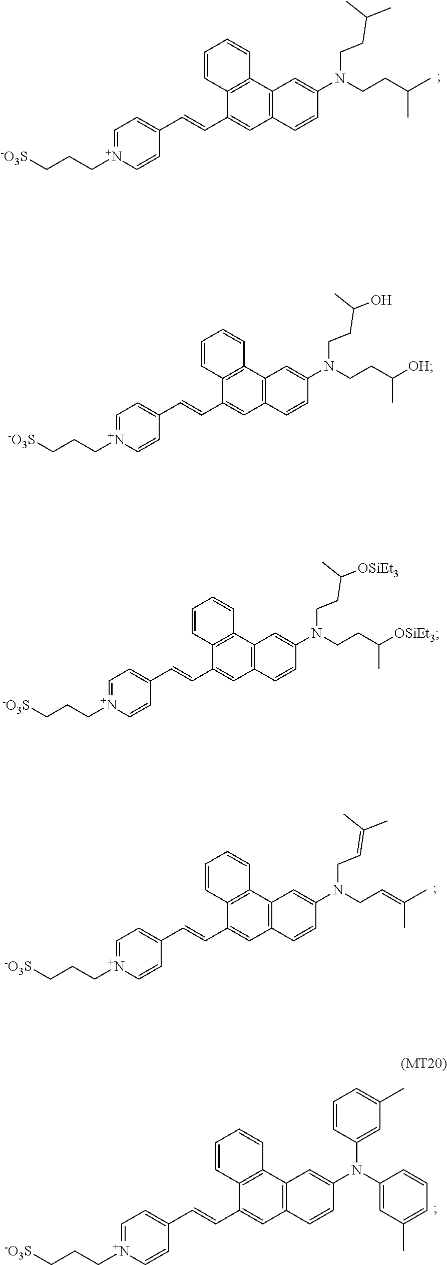

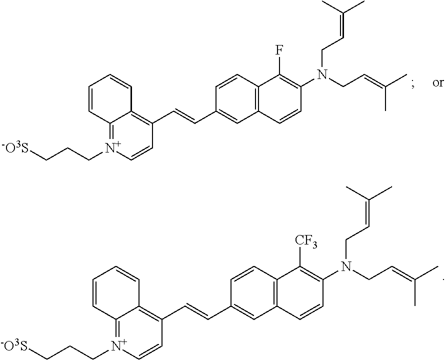

In an embodiment, the dye compound is MT3, MT20, MT21, MT23, MT24, MT27 or MT28, or a salt thereof.

In another embodiment, the dye compound is MT22, MT25 or MT26, or a salt thereof.

The present disclosure relates to dye compounds as hereinbefore defined as well as to salts thereof. The term “salt(s)”, as employed herein, denotes acidic salts formed with inorganic and/or organic acids, as well as basic salts formed with inorganic and/or organic bases. Salts for use in cell staining application will be non-cytotoxic or biologically compatible salts, but other salts may be useful in the production of the dye compounds.

The term “non-cytotoxic salt” (or “biologically compatible salt”) refers to salts of dye compounds that are substantially non-toxic to the cells to which they are added, e.g., it does not induce cell death and/or does not have a substantially deleterious effect on biomolecules. More specifically, these salts retain the staining properties of the dye compounds and are formed from suitable non-toxic organic or inorganic acids or bases.

For example, these salts include acid addition salts of the dye compounds described herein which are sufficiently basic to form such salts. Such acid addition salts include acetates, adipates, alginates, lower alkanesulfonates such as a methanesulfonates, trifluoromethanesulfonatse or ethanesulfonates, arylsulfonates such as a benzenesulfonates, 2-naphthalenesulfonates, or toluenesulfonates (also known as tosylates), ascorbates, aspartates, benzoates, benzenesulfonates, bisulfates, borates, butyrates, citrates, camphorates, camphorsulfonates, cinnamates, cyclopentanepropionates, digluconates, dodecylsulfates, ethanesulfonates, fumarates, glucoheptanoates, glycerophosphates, hemisulfates, heptanoates, hexanoates, hydrochlorides, hydrobromides, hydroiodides, hydrogen sulphates, 2-hydroxyethanesulfonates, itaconates, lactates, maleates, mandelates, methanesulfonates, nicotinates, nitrates, oxalates, pamoates, pectinates, perchlorates, persulfates, 3-phenylpropionates, phosphates, picrates, pivalates, propionates, salicylates, succinates, sulfates, sulfonates, tartrates, thiocyanates, undecanoates and the like.

Also, where the dye compounds are sufficiently acidic, the salts of the disclosure include base salts formed with an inorganic or organic base. Such salts include alkali metal salts such as sodium, lithium, and potassium salts; alkaline earth metal salts such as calcium and magnesium salts; metal salts such as aluminium salts, iron salts, zinc salts, copper salts, nickel salts and a cobalt salts; inorganic amine salts such as ammonium or substituted ammonium salts, such as trimethylammonium salts; and salts with organic bases (for example, organic amines) such as chloroprocaine salts, dibenzylamine salts, dicyclohexylamine salts, dicyclohexylamines, diethanolamine salts, ethylamine salts (including diethylamine salts and triethylamine salts), ethylenediamine salts, glucosamine salts, guanidine salts, methylamine salts (including dimethylamine salts and trimethylamine salts), morpholine salts, morpholine salts, N,N′-dibenzylethylenediamine salts, N-benzyl-phenethylamine salts, N-methylglucamine salts, phenylglycine alkyl ester salts, piperazine salts, piperidine salts, procaine salts, t-butyl amines salts, tetramethylammonium salts, t-octylamine salts, tris-(2-hydroxyethyl)amine salts, and tris(hydroxymethyl)aminomethane salts.

Such salts can be formed quite readily by those skilled in the art using standard techniques. Indeed, the chemical modification of compound into a salt is a technique well known to organic chemists. Salts of the dye compounds disclosed herein may be formed, for example, by reacting a compound of the invention with an amount of acid or base, such as an equivalent amount, in a medium such as one in which the salt precipitates or in an aqueous medium followed by lyophilization.

The dye compounds or salts thereof disclosed herein may exist in unsolvated forms as well as solvated forms, including hydrated forms. These compounds may exist in multiple crystalline or amorphous forms. In general, all physical forms are equivalent for the uses described herein and are intended to be within the scope of the present disclosure. The dye compounds or salts thereof disclosed herein may possess asymmetric carbon atoms (i.e., chiral centers) or double bonds; the racemates, diastereomers, geometric isomers and individual isomers of the dye compounds or salts thereof described herein are within the scope of the present disclosure. The dye compounds or salts thereof described herein may be prepared as a single isomer or as a mixture of isomers.

A dye compound or salt thereof described herein may be part of a composition. Exemplary compositions include a dye compound or salt thereof described herein and an additional component such as a solvent, substrate or reagent.

### Synthetic Methods

In some aspects, the dyes of the present disclosure can be synthesized using the methods of organic chemistry as described in this application. These methods can be further modified and optimized using the principles and techniques of organic chemistry as applied by a person skilled in the art. Such principles and techniques are taught, for example, in March's Advanced Organic Chemistry: Reactions, Mechanisms, and Structure (2007), which is incorporated by reference herein.

### Process Scale-Up

The synthetic methods described herein can be further modified and optimized for preparative, pilot- or large-scale production, either batch of continuous, using the principles and techniques of process chemistry as applied by a person skilled in the art. Such principles and techniques are taught, for example, in Practical Process Research & Development (2000), which is incorporated by reference herein. The synthetic methods described herein may be used to produce preparative scale amounts of dyes.

### Uses of the Dyes

In view of the advantageous properties of the novel fluorescent dyes according to the disclosure, a further aspect of the present disclosure relates to their use as fluorescent dyes, in particular cell permeable fluorescent dyes, in a variety of applications.

In another aspect, the present disclosure provides a method for staining or detecting a cell comprising contacting the cells with a fluorescent dye as described herein. In an embodiment, the method further comprises exposing the cell labelled with the dye compound as described herein to a source of light selected to excite the dye; and detecting fluorescence emission from the dye. The source of light may be any suitable light source capable of emitting light at a wavelength within the visible light range, that is, within the range of about 300 nm to about 1000 nm. In some embodiments, the light source emits light at a wavelength between about 400 to about 700 nm. In some embodiments, the light source emits light at a wavelength between about 450 to about 700 nm, preferably about 400 nm to about 565 nm or about 450 nm to about 550 nm.

The results presented in the present application show that the staining pattern/behavior obtained with the fluorescent dye described herein differs from the staining pattern/behavior obtained with other dyes, and may vary from one cell type to another, and thus may provide information about the cells (e.g., cell type, cell state, etc.) that cannot be obtained with other dyes. In another aspect, the present disclosure provides a method for determining whether an agent induces a change in a cell phenotypic state comprising detecting the fluorescence of the fluorescent dye as described herein in the cell in the presence or absence of the agent, wherein a change in the florescence intensity and/or distribution in the cell in the presence of the agent relative to the absence thereof is indicative that the agent induces a change in the cell phenotypic state.

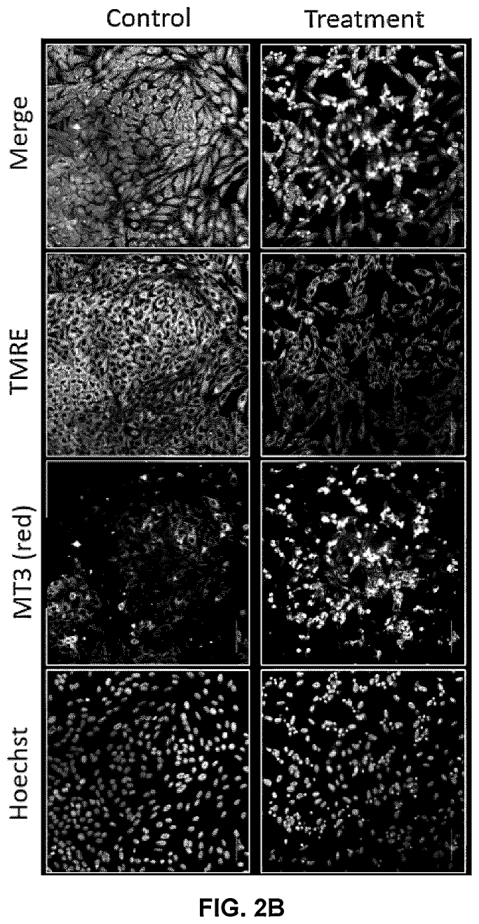

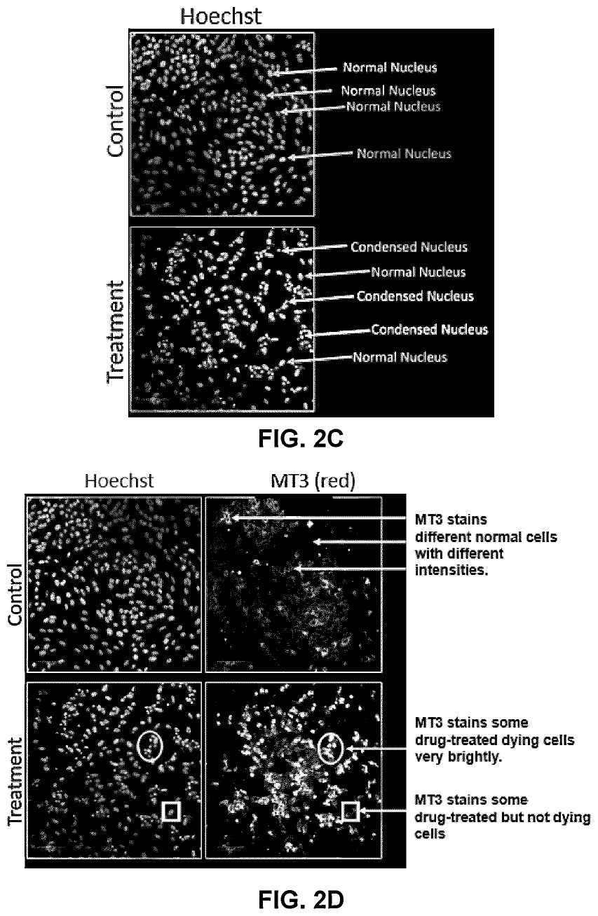

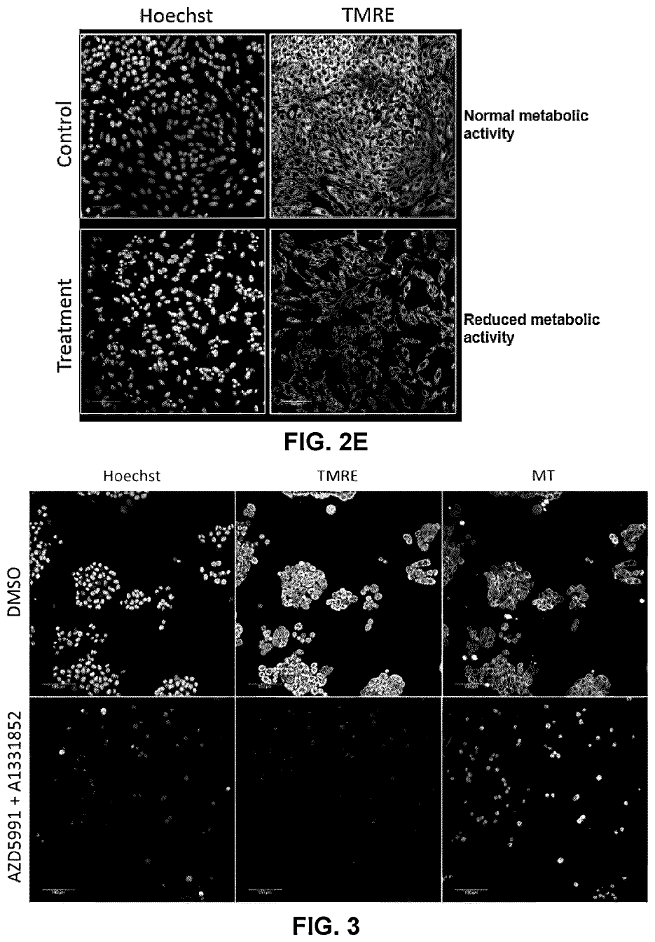

In another aspect, the present disclosure provides a method for determining whether an agent induces apoptosis in a cell comprising measuring the fluorescence intensity of the fluorescent dye as described herein in the cell in the presence or absence of the agent, wherein a higher florescence intensity in the presence of the agent relative to the absence thereof is indicative that the agent induces apoptosis in the cell (as exemplified in FIG. 2).

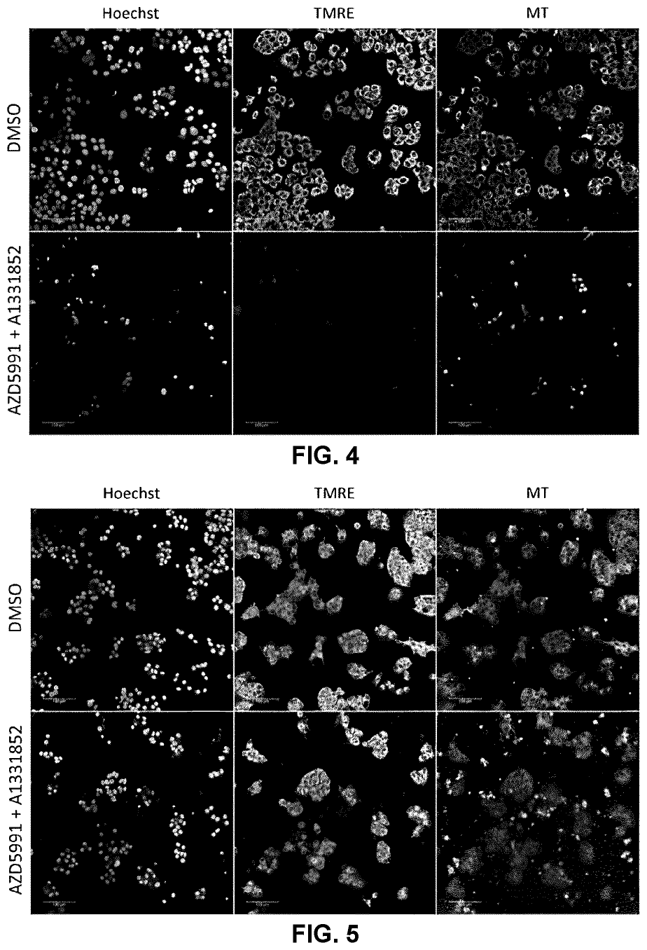

In another aspect, the present disclosure provides a method for determining whether an agent induces apoptosis in a cell comprising measuring the fluorescence intensity of the fluorescent dye as described herein in the cell in the presence or absence of the agent, wherein a change in the distribution of the dye resulting in staining of the nuclei of cells is indicative is indicative that the agent induces apoptosis in the cell (as exemplified in FIGS. 3 and 4).

Thus, the dye according to the present disclosure permits to detect or monitor changes in cell state (e.g., cell physiology, behavior) in response to an agent or a stimuli such as changes in pH, temperature, salt concentration, contact with other cells, treatment with a drug or drug candidate, etc. Examples of changes of phenotypic state that may be detected or monitored using the dye according to the present disclosure include apoptosis, cell stress (e.g., ER stress, mitochondrial stress), autophagy, cell differentiation, etc.

The dye according to the present disclosure permits to detect or monitor changes in the physiological state of any type of cells including primary cells, cell lines, hybridomas, plant cells, fungi, procaryotic cells, etc. In an embodiment, the cell is an eucaryotic cell, for example an animal cell such as a mammalian cell. The cells may be derived from various tissues or organs, such as skin, breast, lung, liver, pancreas, kidney, blood, stomach, intestine, spleen, ovary, heart, cervix, bladder, oral cavity, esophagus, etc. The cell may also be a stem cell. In a further embodiment, the cell is a human cell. In another embodiment, the cell is a tumor cell such as a primary tumor cell or a tumor cell line. Tumor cells stained with the dye according to the present disclosure may be used for testing the antitumor activity of a drug or drug candidate, e.g., to test the ability of the drug or drug candidate at inducing tumor cell apoptosis. The tumor cell may be derived from any type of cancers such as heart sarcoma, lung cancer, small cell lung cancer (SCLC), non-small cell lung cancer (NSCLC), bronchogenic carcinoma (squamous cell, undifferentiated small cell, undifferentiated large cell, adenocarcinoma), alveolar (bronchiolar) carcinoma, bronchial adenoma, sarcoma (e.g., Ewing's sarcoma, Karposi's sarcoma), lymphoma, chondromatous hamartoma, mesothelioma; cancer of the gastrointestinal system, for example, esophagus (squamous cell carcinoma, adenocarcinoma, leiomyosarcoma, lymphoma), stomach (carcinoma, lymphoma, leiomyosarcoma), gastric, pancreas (ductal adenocarcinoma, insulinoma, glucagonoma, gastrinoma, carcinoid tumors, vipoma), small bowel (adenocarcinoma, lymphoma, carcinoid tumors, Karposi's sarcoma, leiomyoma, hemangioma, lipoma, neurofibroma, fibroma), large bowel (adenocarcinoma, tubular adenoma, villous adenoma, hamartoma, leiomyoma); cancer of the genitourinary tract, for example, kidney cancer (adenocarcinoma, Wilm's tumor [nephroblastoma], lymphoma, leukemia), bladder and/or urethra cancer (squamous cell carcinoma, transitional cell carcinoma, adenocarcinoma), prostate cancer (adenocarcinoma, sarcoma), testis cancer (seminoma, teratoma, embryonal carcinoma, teratocarcinoma, choriocarcinoma, sarcoma, interstitial cell carcinoma, fibroma, fibroadenoma, adenomatoid tumors, lipoma); liver cancer, for example, hepatoma (hepatocellular carcinoma, HCC), cholangiocarcinoma, hepatoblastoma, angiosarcoma, hepatocellular adenoma, hemangioma, pancreatic endocrine tumors (such as pheochromocytoma, insulinoma, vasoactive intestinal peptide tumor, islet cell tumor and glucagonoma); bone cancer, for example, osteogenic sarcoma (osteosarcoma), fibrosarcoma, malignant fibrous histiocytoma, chondrosarcoma, malignant lymphoma (reticulum cell sarcoma), multiple myeloma, malignant giant cell tumor chordoma, osteochronfroma (osteocartilaginous exostoses), benign chondroma, chondroblastoma, chondromyxofibroma, osteoid osteoma and giant cell tumors; cancer of the nervous system, for example, neoplasms of the central nervous system (CNS), primary CNS lymphoma, skull cancer (osteoma, hemangioma, granuloma, xanthoma, osteitis deformans), meninges (meningioma, meningiosarcoma, gliomatosis), brain cancer (astrocytoma, medulloblastoma, glioma, ependymoma, germinoma [pinealoma], glioblastoma multiform, oligodendroglioma, schwannoma, retinoblastoma, congenital tumors), spinal cord neurofibroma, meningioma, glioma, sarcoma); cancer of the reproductive system, for example, gynecological cancer, uterine cancer (endometrial carcinoma), cervical cancer (cervical carcinoma, pre-tumor cervical dysplasia), ovarian cancer (ovarian carcinoma [serous cystadenocarcinoma, mucinous cystadenocarcinoma, unclassified carcinoma], granulosa-thecal cell tumors, Sertoli-Leydig cell tumors, dysgerminoma, malignant teratoma), vulvar cancer (squamous cell carcinoma, intraepithelial carcinoma, adenocarcinoma, fibrosarcoma, melanoma), vaginal cancer (clear cell carcinoma, squamous cell carcinoma, botryoid sarcoma (embryonal rhabdomyosarcoma), fallopian tube cancer (carcinoma); placenta cancer, penile cancer, prostate cancer, testicular cancer; cancer of the hematologic system, for example, blood cancer (acute myeloid leukemia (AML), chronic myeloid leukemia (CML), acute lymphoblastic leukemia (ALL), chronic lymphocytic leukemia (CLL), myeloproliferative diseases, multiple myeloma, myelodysplastic syndrome), Hodgkin's disease, non-Hodgkin's lymphoma [malignant lymphoma]; cancer of the oral cavity, for example, lip cancer, tongue cancer, gum cancer, palate cancer, oropharynx cancer, nasopharynx cancer, sinus cancer; skin cancer, for example, malignant melanoma, cutaneous melanoma, basal cell carcinoma, squamous cell carcinoma, Karposi's sarcoma, moles dysplastic nevi, lipoma, angioma, dermatofibroma, and keloids; adrenal gland cancer: neuroblastoma; and cancers of other tissues including connective and soft tissue, retroperitoneum and peritoneum, eye cancer, intraocular melanoma, and adnexa, breast cancer (e.g., ductal breast cancer), head or/and neck cancer (head and neck squamous cell carcinoma), anal cancer, thyroid cancer, parathyroid cancer; secondary and unspecified malignant neoplasm of lymph nodes, secondary malignant neoplasm of respiratory and digestive systems and secondary malignant neoplasm of other sites.

The fluorescent dyes may be used as labels in microscopic, spectroscopic and other imaging techniques, in particular fluorescence microscopy and spectroscopy, in microfluidic devices, capillary electrophoresis, flow cytometry and fluorescence-activated cell sorting (FACS). Said imaging techniques comprise, e.g., stimulated emission depletion microscopy [STED], single molecule spectroscopy, single molecule switching (SMS) “nanoscopy” (diffraction unlimited optical resolution by using switching of the fluorescence of the single molecules, such as single molecule localization microscopy [SMLM], structured illumination microscopy (SIM), light-sheet microscopy, photoactivation localization microscopy [PALM, PALMIRA, fPALM], stochastic optical reconstruction microscopy [STORM]), fluorescence correlation spectroscopy [FCS] or fluorescence anisotropy spectroscopy, fluorescence recovery after photobleaching [FRAP], fluorescence lifetime imaging [FLIM], ground state depletion with individual molecular return [GSDIM], and fluorescence resonant energy transfer [FRET], correlative fluorescence—electron microscopy, correlative fluorescence—cryo-electron microscopy, microscale thermophoresis, fluorescence in situ hybridization (FISH), nuclear magnetic resonance spectroscopy.

As shown in the Examples, the dyes of the disclosure fluoresce and are capable of acting as fluorescent markers that can be detected and tracked with a fluorimeter using methods known in the art. The dyes of the disclosure exhibit fluorescence in the visible range between about 450 to about 850 nm, or about 450 nm to about 700 nm. In some embodiments, the dye of the disclosure may be detected by excitation at a wavelength of about 488 nm and detection at a wavelength of about 640 nm.

The dye compound and the cell are suitably combined such that the dye compound labels the cell. For example, the cell to be labelled may be incubated with the dye compound under suitable conditions and a suitable time period, for example at 37° C. for a period of about 10 minutes to 2 hours, for example about 1 hour. Typically, the dye compound may be added to an aqueous solution comprising the cells. The aqueous solution comprises water, and may comprise other water miscible solvents at levels capable of sustaining cell viability. Suitable water miscible solvents include dimethyl sulfoxide (DMSO), acetone, ethyl acetate (EtOAc), dimethylformamide (DMF), methanol (MeOH), ethanol (EtOH), and the like. The aqueous solution may comprise one or more additives selected from buffers, surfactants, culture medium, cryoprotectants and combinations thereof.

The dye according to the present disclosure may be used in combination with one or more additional dyes (multiplexing). Examples of dyes that may be used in combination with the fluorescent dyes according to the present disclosure include fluorescein isothiocyanate (FITC), Alexa Fluor® dyes, tetramethylrhodamine-5-(and 6)-isothiocyanate (TRITC), DAPI, BODIPY-based dyes, Hoechst dyes, Propidium-lodide (PI), SYBR Green I, Cy5, Acridine Orange, MitoTracker® dyes, LysoTracker® dyes, TMRE, TMRM, and the like. In an embodiment, the dye according to the present disclosure is used in combination with dyes that do not strongly fluoresce with 488 nm excitation such as standard blue, red, or far red dyes.

The present disclosure provides a kit for fluorescently labelling a cell, the kit comprising: a dye compound or salt thereof as described herein, or any combination thereof; and optionally information material. The informational material may be descriptive, instructional, marketing or other material that relates to the use of a dye described herein for the methods described herein. The informational material of the kits is not limited in its form. In one embodiment, the informational material can include information about production of the dye, molecular weight of the dye, concentration, date of expiration, batch or production site information, and so forth. In one embodiment, the informational material relates to methods for labeling a cell with the dye. In an embodiment, the informational material comprises instructions for the use of the dye compound or salt thereof to fluorescently label a cell.

The informational material of the kits is not limited in its form. In many cases, the informational material, e.g., instructions, is provided in printed matter, e.g., a printed text, drawing, and/or photograph, e.g., a label or printed sheet. However, the informational material can also be provided in other formats, such as computer readable material, video recording, or audio recording. In another embodiment, the informational material of the kit is contact information, e.g., a physical address, email address, website, or telephone number, where a user of the kit can obtain substantive information about a dye described herein and/or its use in the methods described herein. Of course, the informational material can also be provided in any combination of formats. A dye described herein can be provided in any form, e.g., solution, dried or lyophilized form. It is preferred that a dye described herein be substantially pure. When a dye described herein is provided in a liquid solution, the liquid solution may be an aqueous solution or an organic solution. When a dye described herein is provided as a dried form, reconstitution generally is by the addition of a suitable solvent. The solvent, e.g., water, buffer or DMSO, can optionally be provided in the kit.

The kit can include one or more containers for the composition containing a dye described herein. In some embodiments, the kit contains separate containers, dividers or compartments for the composition and informational material. For example, the composition can be contained in a bottle or vial, and the informational material can be contained in a plastic sleeve or packet. In other embodiments, the separate elements of the kit are contained within a single, undivided container. For example, the composition is contained in a bottle or vial that has attached thereto the informational material in the form of a label. In some embodiments, the kit includes a plurality (e.g., a pack) of individual containers, each containing one or more samples of a dye described herein. For example, the kit includes a plurality of ampules, vials or bottles, each containing a sample of a dye described herein. The containers of the kits can be air tight, waterproof (e.g., impermeable to changes in moisture or evaporation), and/or light-tight.

### Examples

The present disclosure is illustrated in further details by the following non-limiting examples.

### Example 1: General Synthetic Approach to Dye Synthesis

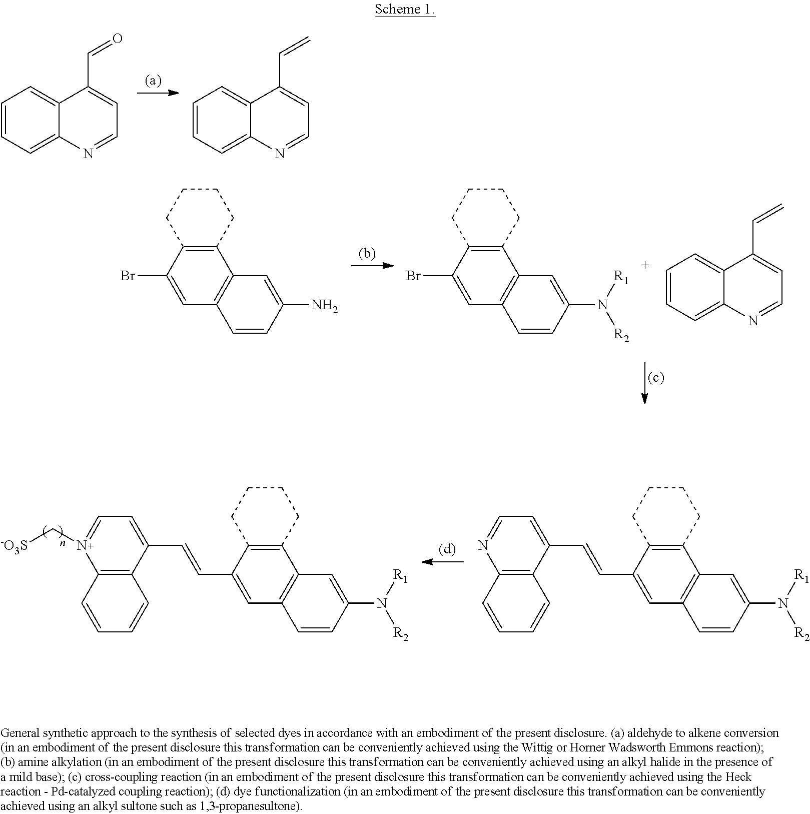

### Example 2: General Synthetic Approach to Dye Synthesis

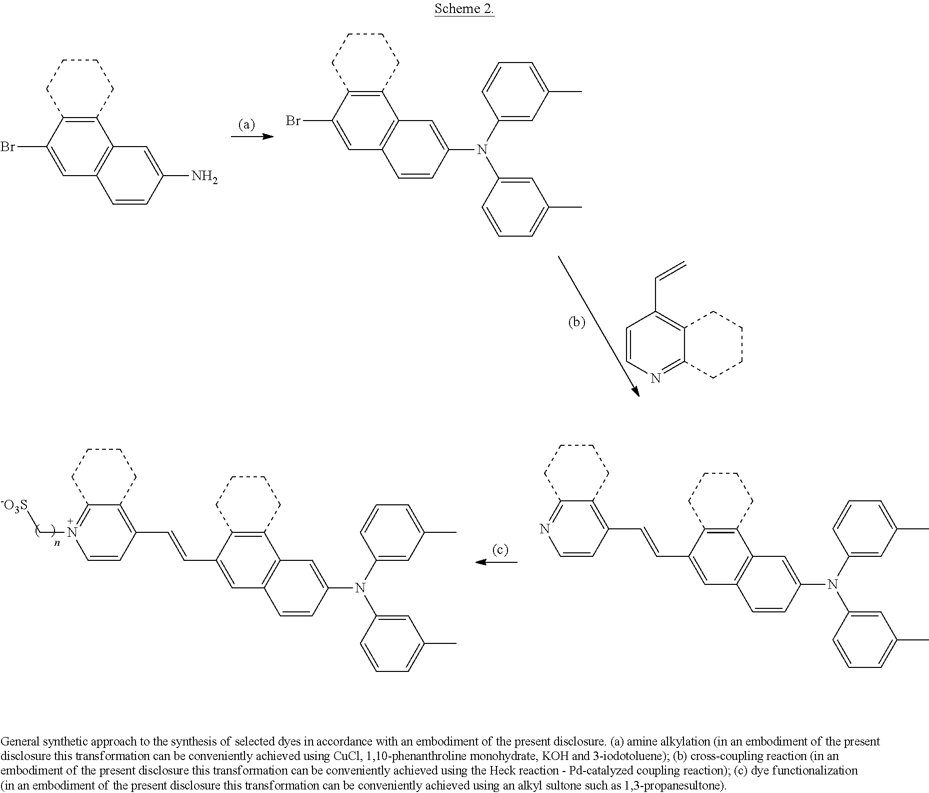

### Example 3: General Methods and Materials for Compound Synthesis and Characterization

Reagents and solvents were obtained from commercial suppliers and used without further purification, unless otherwise noted. Reaction progress was monitored by thin layer chromatography (TLC), using EMD silica gel 60 F254 aluminum plates (E. Merck; Darmstadt, Germany). Spots could be visualized with UV light (254 nm), and/or followed by staining using a potassium bismuth iodide solution (Dragendorff's reagent), a cerium ammonium molybdate (CAM) solution or a potassium-permanganate solution, followed by heating on a hot plate. Silica gel was used for flash chromatography. Nuclear magnetic resonance (NMR) spectra were recorded on a digital spectrometer.

### Example 4: Compound Synthesis and Characterization

### 1. Synthesis of 4-(2-[6-(diisopentylamino)-2-naphthalenyl]ethenyl)-1-(3-sulfopropyl)quinolinium inner salt (Mutachrome 2. MT2)

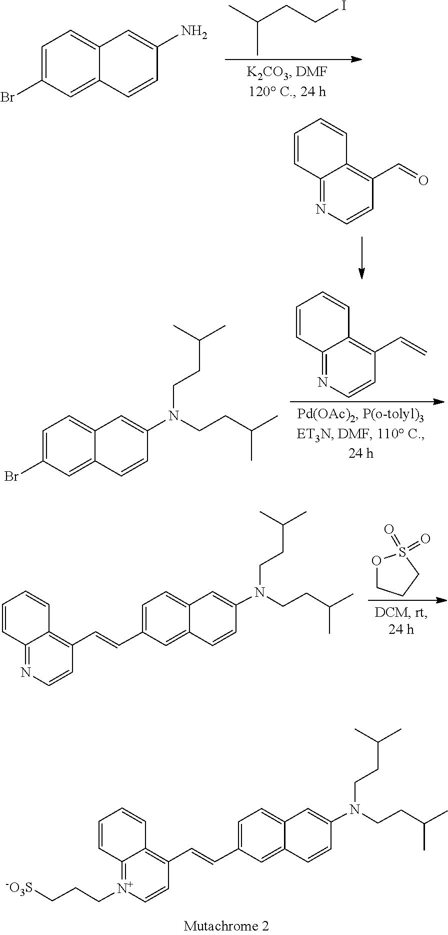

### Step 1—Synthesis of 4-vinylguinoline

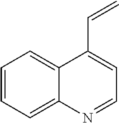

A solution of sodium hydride (3.05 g, 76.35 mmol) in dimethylsulfoxide (60 mL) under argon was warmed at 70° C. until the evolution of hydrogen ceased. After cooling down to r.t., a solution of methyl triphenylphosphonium bromide (27.27 g, 76.35 mmol) in dimethylsulfoxide (60 mL) was added and the resulting orange solution stirred for 15 minutes. A solution of 4-quinoline carboxaldehyde (6 g, 38.18 mmol) in dimethylsulfoxide (45 mL) was then added and the reaction stirred at r.t. for 14 h. The reaction mixture was hydrolyzed with water (400 mL) and extracted with hexane (3×400 mL). The combined organic layer was washed with brine (100 mL), dried over sodium sulfate and concentrated in vacuo. Purification by flash chromatography (50-65% EtOAc in hexanes) gave the title product as yellow oil (1.32 g, 22% yield). ¹H NMR (700 MHz, CHLOROFORM-d) δ=8.89 (d, J=4.4 Hz, 1H), 8.13 (t, J=8.2 Hz, 2H), 7.73 (ddd, J=1.3, 6.9, 8.3 Hz, 1H), 7.58 (ddd, J=1.3, 6.8, 8.3 Hz, 1H), 7.49 (d, J=4.4 Hz, 1H), 7.45 (dd, J=11.0, 17.3 Hz, 1H), 6.00 (dd, J=1.2, 17.3 Hz, 1H), 5.69 (dd, J=1.1, 11.1 Hz, 1H).

### Step 2—Synthesis of 6-bromo-N,N-diisopentylnaphthalen-2-amine

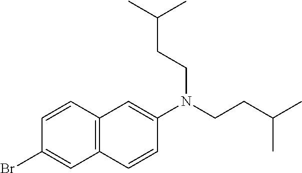 [SMILES: CC(C)CCN(CCC(C)C)c1ccc2cc(Br)ccc2c1]

To a solution of 6-bromonaphthalen-2-amine (803 mg, 3.618 mmol) and potassium carbonate (1.5 g, 11 mmol) in anhydrous N,N-dimethylformamide (7.5 mL) under argon was added 1-iodo-3-methylbutane (1.46 mL, 11 mmol) dropwise and the mixture stirred at 120° C. for 24 h. The reaction mixture was cooled down to r.t, diluted with water (30 mL) and extracted with ethyl acetate (3×20 mL). The combined organic layer was washed with water (2×30 mL) and brine (20 mL), dried over sodium sulfate and concentrated in vacuo. Purification by flash chromatography (100% hexanes) gave the title product as a pale yellow oil (630 mg, 48% yield).

¹H NMR (700 MHz, DMSO-d₆) δ=7.89 (d, J=1.9 Hz, 1H), 7.68 (d, J=9.1 Hz, 1H), 7.56 (d, J=8.7 Hz, 1H), 7.38 (dd, J=2.1, 8.7 Hz, 1H), 7.13 (dd, J=2.5, 9.1 Hz, 1H), 6.82 (d, J=2.3 Hz, 1H), 3.36 (t, J=7.8 Hz, 4H), 1.64 (td, J=6.6, 13.3 Hz, 2H), 1.49-1.41 (m, 4H), 0.94 (d, J=6.6 Hz, 12H).

### Step 3—Synthesis of N,N-diisopentyl-6-((E)-2-(quinolin-4-yl)vinyl)naphthalen-2-amine

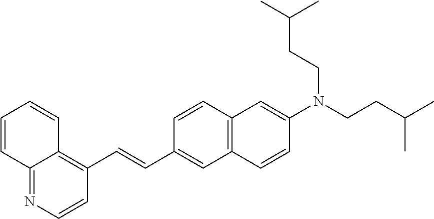 [SMILES: CC(C)CCN(CCC(C)C)c1ccc2cc(/C=C/c3ccnc4ccccc34)ccc2c1]

To a solution of 6-bromo-N,N-diisopentylnaphthalen-2-amine (600 mg, 1.656 mmol) in anhydrous N,N-dimethylformamide (2 mL) under argon were added palladium (II) acetate (11.2 mg, 0.05 mmol), tri-(o-tolyl) phosphine (101 mg, 0.331 mmol), triethylamine (3.92 mL, 28.15 mmol) and 4-vinylquinoline (360 mg, 2.318 mmol). After stirring at 110° C. for 24 h, the reaction mixture was cooled down to r.t, diluted with water (30 mL) and extracted with ethyl acetate (2×20 mL). The combined organic layer was washed with water (30 mL) and brine (20 mL), dried over sodium sulfate and concentrated in vacuo. Purification by flash chromatography (0-50% EtOAc in hexanes) gave the title product as an orange solid (254 mg, 37% yield). ¹H NMR (700 MHz, DMSO-d₆) δ=8.87 (t, J=4.6 Hz, 1H), 8.58 (d, J=7.9 Hz, 1H), 8.06 (d, J=16.0 Hz, 1H), 8.04-8.01 (m, 1H), 7.97 (s, 1H), 7.94 (dd, J=1.7, 8.7 Hz, 1H), 7.87 (d, J=4.6 Hz, 1H), 7.80-7.76 (m, 1H), 7.75 (d, J=9.2 Hz, 1H), 7.71-7.65 (m, 3H), 7.12 (dd, J=2.5, 9.1 Hz, 1H), 6.86 (d, J=2.5 Hz, 1H), 3.40 (t, J=7.8 Hz, 4H), 1.70-1.62 (m, 2H), 1.51-1.45 (m, 4H), 0.96 (d, J=6.7 Hz, 12H).

### Step 4—Synthesis of 4-(2-[6-(diisopentylamino)-2-naphthalenyl]ethenyl)-1-(3-sulfopropyl)quinolinium Inner Salt (Mutachrome 2, MT2)

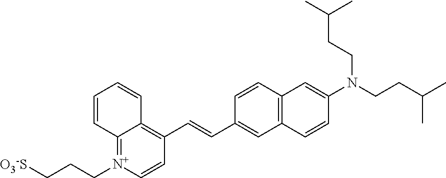

To a solution of 1,3-propanesultone (214 mg, 1.75 mol) in anhydrous dichloromethane (20 mL) under argon was added N,N-diisopentyl-6-((E)-2-(quinolin-4-yl)vinyl)naphthalen-2-amine (254 mg, 0.58 mmol). After stirring at r.t. for 24 h, the solvent was removed in vacuo. Crystallization from methanol-diethyl ether and subsequent wash with cold diethyl ether gave the title compound MT2 as deep purple crystals (20 mg, 6% yield). ¹H NMR (700 MHz, DMSO-d₆) δ=9.28 (d, J=6.6 Hz, 1H), 9.10 (d, J=8.1 Hz, 1H), 8.62 (d, J=9.1 Hz, 1H), 8.48 (d, J=6.6 Hz, 1H), 8.29 (d, J=2.1 Hz, 2H), 8.24 (t, J=8.4 Hz, 1H), 8.15 (s, 1H), 8.09 (d, J=9.1 Hz, 1H), 8.02 (t, J=7.7 Hz, 1H), 7.81 (d, J=9.2 Hz, 1H), 7.71 (d, J=8.9 Hz, 1H), 7.16 (dd, J=2.2, 9.2 Hz, 1H), 6.90 (d, J=1.9 Hz, 1H), 5.10 (t, J=7.6 Hz, 2H), 3.44 (t, J=8.1 Hz, 4H), 2.57 (t, J=6.8 Hz, 2H), 2.30-2.24 (m, 2H), 1.68 (td, J=6.7, 13.2 Hz, 2H), 1.53-1.47 (q, J=7.0, 15.6 Hz, 4H), 0.97 (d, J=6.6 Hz, 12H). [M+H]⁺: 559.4 (ES+).

### 2. Synthesis of 4-(2-[6-(dim-tolylamino)-2-naphthalenyl]ethenyl)-1-(3-sulfopropyl) pyridinium Inner Salt (Mutachrome 3, MT3)

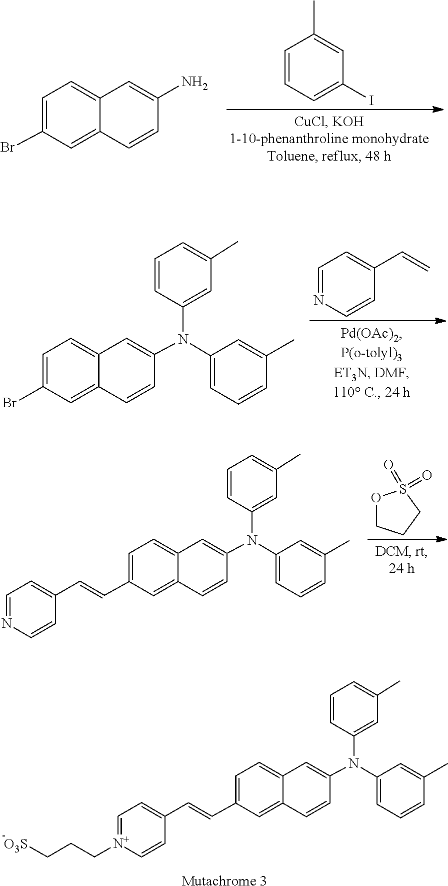

### Step 1—Synthesis of 6-bromo-N,N-dim-tolylnaphthalen-2-amine

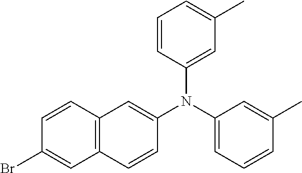 [SMILES: Cc1cccc(N(c2cccc(C)c2)c2ccc3cc(Br)ccc3c2)c1]

To a solution of 6-bromonaphthalen-2-amine (4 g, 18 mmol) in anhydrous toluene (40 mL) under argon were added sequentially copper (I) chloride (196 mg, 1.98 mmol), 1,10-phenanthroline monohydrate (392.4 mg, 1.98 mmol), potassium hydroxide (11.12 g, 198 mol) and 3-iodotoluene (6 mL, 46.8 mmol), and the mixture heated to 125° C. for 48 h. After cooling down to r.t., the mixture was poured in water (200 mL) and extracted with dichloromethane (3×200 mL).

The combined organic layer was washed with water (100 mL) and brine (100 mL), dried over sodium sulfate and concentrated in vacuo. Purification (twice) by flash chromatography (0-5% EtOAc in hexanes) gave the title product as a white solid (4.365 g, 60% yield). ¹H NMR (700 MHz, CHLOROFORM-d) δ: 7.89 (s, 1H), 7.60 (d, J=8.9 Hz, 1H), 7.44 (s, 2H), 7.32 (s, 1H), 7.29 (dd, J=8.9, 2.3 Hz, 1H), 7.17 (t, J=7.7 Hz, 2H), 6.91-6.96 (m, 4H), 6.89 (d, J=7.5 Hz, 2H), 2.28 (s, 6H).

Step 2—Synthesis of 6-((E)-2-(pyridin-4-yl)vinyl)-N,N-dim-tolylnaphthalen-2-amine

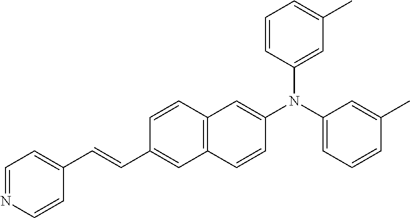 [SMILES: Cc1cccc(N(c2cccc(C)c2)c2ccc3cc(/C=C/c4ccncc4)ccc3c2)c1]

To a solution of 6-bromo-N,N-dim-tolylnaphthalen-2-amine (4.365 g, 10.85 mmol) in anhydrous N,N-dimethylformamide (13 mL) under argon were added palladium (II) acetate (73.2 mg, 0.326 mmol), tri-(o-tolyl) phosphine (660.5 mg, 2.17 mmol), triethylamine (26 mL, 184.45 mmol) and 4-vinylpyridine (1.64 mL, 15.19 mmol). After stirring at 110° C. for 24 h, the reaction mixture was cooled down to r.t, diluted with water (200 mL) and extracted with ethyl acetate (3×250 mL). The combined organic layer was washed with water (100 mL) and brine (100 mL), dried over sodium sulfate and concentrated in vacuo. Purification by flash chromatography (0-50% EtOAc in hexanes) gave the title product as an orange solid (3.117 g, 67% yield). ¹H NMR (700 MHz, CHLOROFORM-d) δ: 8.58 (d, J=5.3 Hz, 2H), 7.8 (br. s, 1H), 7.70 (d, J=8.7 Hz, 1H), 7.68 (d, J=8.9 Hz, 1H), 7.57 (d, J=8.6 Hz, 1H), 7.43 (d, J=16.2 Hz, 1H), 7.39 (d, J=5.4 Hz, 2H), 7.33 (br s, 1H), 7.27 (dd, J=9 Hz, 2 Hz, 1H), 7.18 (t. J=7.8 Hz, 2H), 7.1 (d, J=16.4 Hz, 1H), 6.88-6.97 (m, 6H), 2.28 (s, 6H).

### Step 3—Synthesis of 4-(2-[6-(dim-tolylamino)-2-naphthalenyl]ethenyl)-1-(3-sulfopropyl) pyridinium Inner Salt (Mutachrome 3, MT3)

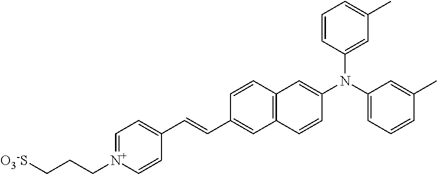

To a solution of 1,3-propanesultone (2.677 g, 21.922 mmol) in anhydrous dichloromethane (130 mL) under argon was added a solution of 6-((E)-2-(pyridin-4-yl)vinyl)-N,N-dim-tolylnaphthalen-2-amine (3.117 g, 7.307 mmol) in anhydrous dichloromethane (20 mL). After stirring at r.t. for 24 h, the solvent was removed in vacuo. Crystallization from methanol-diethyl ether and subsequent wash with cold diethyl ether gave the title compound MT3 as bright orange crystals (2.965 g, 74% yield). ¹H NMR (700 MHz, CHLOROFORM-d) δ: 8.94 (br. s, 2H), 7.94 (d, J=5.5 Hz, 2H), 7.92 (s, 1H), 7.81 (d, J=15.6 Hz, 1H), 7.70 (d, J=8.7 Hz, 1H), 7.64 (d, J=8.9 Hz, 1H), 7.55 (d, J=8.9 Hz, 1H), 7.19 (t., J=7.6 Hz, 2H), 7.13 (d, J=16.2 Hz, 1H), 6.93-6.97 (m, 6H), 4.99 (br. s., 2H), 2.92 (br. s., 2H), 2.56 (br. s., 2H), 2.52 (br. s., 2H), 2.29 (s, 6H). [M+H]⁺: 549.4 (ES+).

### 3. Synthesis of (E)-3-(4-(2-(3-(di-m-tolylamino)phenanthren-9-yl)vinyl)pyridin-1-ium-1-yl)propane-1-sulfonate (MT20)

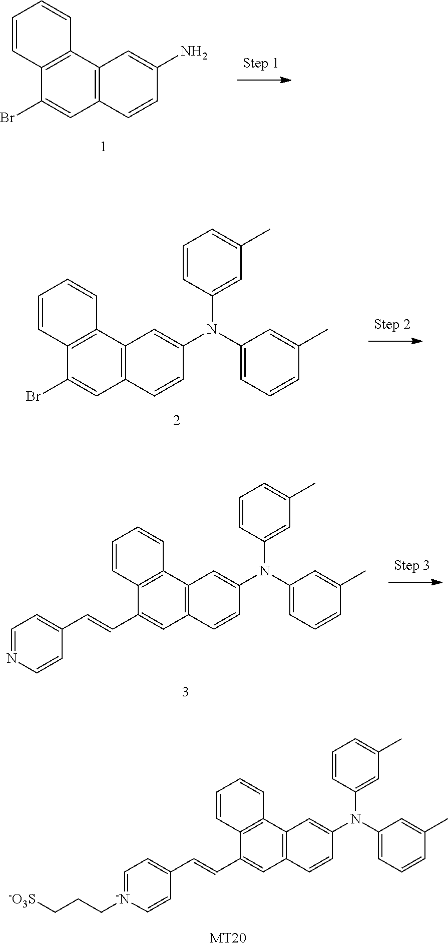

### Step 1—Synthesis of 9-bromo-N,N-di-m-tolylphenanthren-3-amine (2)

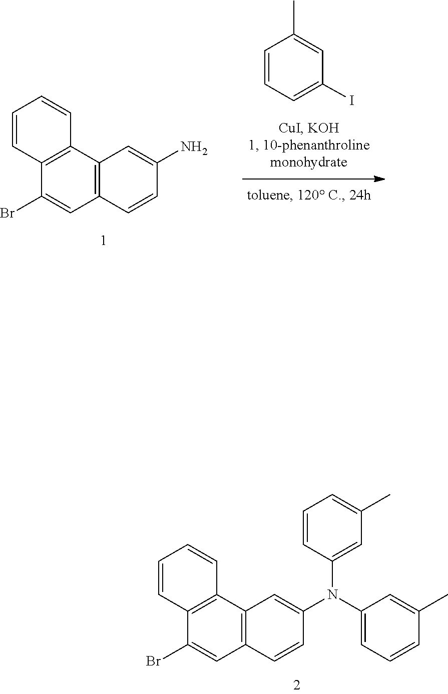

To a sealed tube charged with 9-bromophenanthren-3-amine (1) (500 mg, 1.8 mmol), 3-iodotoluene (1.2 ml, 9.3 mmol), Cul (350 mg, 1.8 mmol), 1,10-phenanthroline monohydrate (364 mg, 1.8 mmol), and KOH (2.0 g, 36.7 mmol) was added anhydrous toluene (5 ml) under a nitrogen atmosphere. The mixture was stirred at 120° C. for 24 h and then warmed to room temperature. The reaction mixture was filtered and then brine solution (20 mL) was added. The aqueous layer was extracted with CH₂Cl₂ (3×15 mL). The combined organic layer was dried over anhydrous Na₂SO₄, filtered, and concentrated under reduced pressure. The resulting crude product was subjected to flash column chromatography (0-10% hexanes/ethyl acetate) to afford 9-bromo-N,N-di-m-tolylphenanthren-3-amine (2) (751 mg, 90%) as a pale-yellow fluffy solid. ¹H NMR (500 MHz, CDCl₃) δ 8.3 (td, J=8.6, 1.3 Hz, 2H), 8.3 (d, J=2.2 Hz, 1H), 8.0 (s, 1H), 7.7-7.6 (m, 2H), 7.6 (ddd, J=8.3, 7.0, 1.4 Hz, 1H), 7.3 (dd, J=8.6, 2.2 Hz, 1H), 7.2-7.2 (m, 2H), 7.0 (dt, J=7.6, 0.9 Hz, 4H), 6.9 (ddt, J=7.9, 1.7, 0.9 Hz, 2H), 2.3 (s, 6H); ¹³C NMR (125 MHz, CDCl₃) δ 147.7, 147.2, 139.3, 130.9, 130.7, 130.6, 130.1, 129.2, 128.7, 128.0, 127.8, 127.5, 127.0, 125.3, 124.4, 124.2, 123.0, 121.9, 119.5, 115.9, 21.5; HRMS (ESI-TOF): m/z [M+H]⁺ calcd. for C₂₈H₂₃BrN: 454.0992, found: 454.1007.

### Step 2—Synthesis of (E)-9-(2-(pyridin-4-yl)vinyl)-N,N-di-m-tolylphenanthren-3-amine (3)

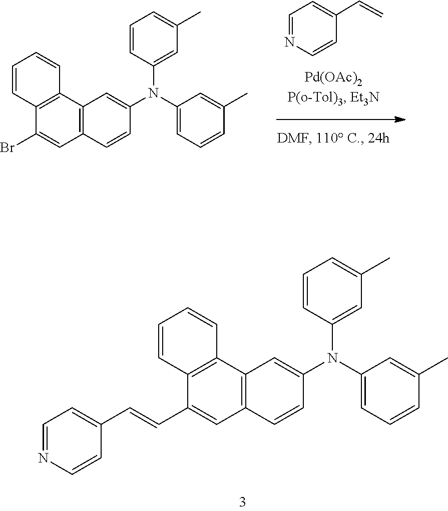

To a sealed tube containing a solution of 9-bromo-N,N-di-m-tolylphenanthren-3-amine (2) (500 mg, 1.1 mmol) in anhydrous N,N-dimethylformamide (5 mL) under nitrogen were added palladium (II) acetate (7.5 mg, 0.035 mmol), tri-(o-tolyl) phosphine (67.0 mg, 0.22 mmol), triethylamine (2.6 mL, 18.8 mmol) and 4-vinylpyridine (0.178 mL, 1.65 mmol). After stirring at 110° C. for 24 h, the reaction mixture was cooled down to room temperature, diluted with water (20 mL) and extracted with ethyl acetate (3×30 mL). The combined organic layer was washed with water (20 mL) and brine (20 mL), dried over anhydrous Na₂SO₄, filtered and concentrated under reduced pressure. The crude product was purified by flash chromatography (0-60% hexanes/ethyl acetate+1% triethylamine) to afford (E)-9-(2-(pyridin-4-yl)vinyl)-N,N-di-m-tolylphenanthren-3-amine (3) (364 mg, 69%) as a yellow solid. ¹H NMR (500 MHz, CDCl₃) δ 8.6 (d, J=5.3 Hz, 2H), 8.4 (dd, J=8.3, 1.4 Hz, 1H), 8.3 (d, J=2.2 Hz, 1H), 8.2 (dd, J=8.2, 1.4 Hz, 1H), 8.1 (d, J=15.9 Hz, 1H), 7.9 (s, 1H), 7.8 (d, J=8.6 Hz, 1H), 7.6 (ddd, J=8.2, 6.9, 1.4 Hz, 1H), 7.6 (ddd, J=8.2, 6.9, 1.4 Hz, 1H), 7.5-7.5 (m, 2H), 7.4 (dd, J=8.6, 2.2 Hz, 1H), 7.2 (t, J=7.7 Hz, 2H), 7.1 (d, J=15.9 Hz, 1H), 7.0-7.0 (m, 4H), 6.9 (dd, J=7.1, 1.1 Hz, 2H), 2.3 (s, 6H); ¹³C NMR (125 MHz, CDCl₃) δ 149.4, 147.6, 147.4, 145.8, 139.3, 131.8, 131.7, 130.6, 130.6, 129.9, 129.8, 129.2, 128.1, 127.0, 126.4, 125.4, 125.2, 124.3, 124.1, 124.1, 123.5, 122.0, 121.2, 115.6, 21.5; HRMS (ESI-TOF): m/z [M+H]⁺ calcd. for C₃₅H₂₉N₂: 477.2325, found: 477.2345.

### Step 3—Synthesis of (E)-3-(4-(2-(3-(di-m-tolylamino)phenanthren-9-yl)vinyl)pyridin-1-ium-1-yl)propane-1-sulfonate (MT20)

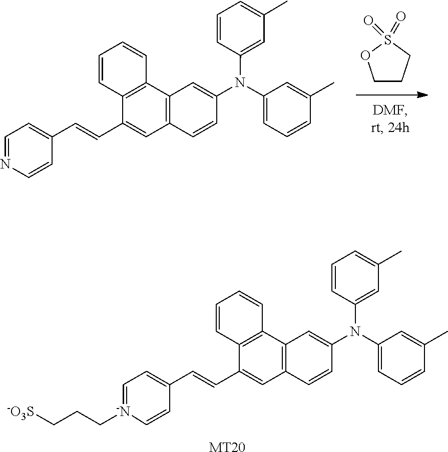

To a solution of 1,3-propanesultone (54 mg, 0.44 mmol) in anhydrous dichloromethane (2 mL) under nitrogen was added a solution of (E)-9-(2-(pyridin-4-yl)vinyl)-N,N-di-m-tolylphenanthren-3-amine (3) (70 mg, 0.14 mmol) in anhydrous dichloromethane (2 mL). The reaction mixture was subsequently stirred at room temperature for 24 h. Then the solvent was removed under reduced pressure and the residue subjected to silica gel column chromatography (0-10% DCM/MeOH) to afford (E)-3-(4-(2-(3-(di-m-tolylamino)phenanthren-9-yl)vinyl)pyridin-1-ium-1-yl)propane-1-sulfonate (MT20) as a bright orange solid (46 mg, 52% yield). ¹H NMR (400 MHz, CD₂Cl₂:CD₃OD (4:1)) δ 8.8-8.7 (m, 2H), 8.6 (d, J=15.8 Hz, 1H), 8.3 (d, J=8.3 Hz, 1H), 8.3 (d, J=8.3 Hz, 1H), 8.2 (s, 1H), 8.2 (s, 1H), 8.1 (d, J=6.9 Hz, 2H), 7.8 (d, J=8.8 Hz, 1H), 7.7 (ddt, J=8.2, 7.0, 1.3 Hz, 1H), 7.6 (ddt, J=8.3, 7.0, 1.3 Hz, 1H), 7.4 (d, J=15.8 Hz, 1H), 7.3 (ddd, J=8.7, 2.2, 1.1 Hz, 1H), 7.2-7.1 (m, 2H), 7.0 (d, J=7.0 Hz, 3H), 7.0-6.9 (m, 3H), 4.8 (t, J=7.2 Hz, 2H), 2.9-2.8 (m, 2H), 2.5-2.4 (m, 2H), 2.3 (s, 6H); ¹³C NMR (100 MHz, CD₂Cl₂:CD₃OD (4:1)) δ 154.1, 148.6, 147.2, 143.9, 139.7, 139.5, 132.7, 130.3, 130.2, 129.7, 129.2, 128.3, 127.2, 127.0, 126.6, 126.0, 125.9, 124.7, 124.1, 123.7, 123.5, 123.3, 123.1, 122.3, 113.9, 58.8, 46.4, 27.0, 20.8; HRMS (ESI-TOF): m/z [M+H]⁺ calcd. for C₃₈H₃₅N₂O₃S: 599.2363, found: 599.2390.

### 4. Synthesis of (E)-4-(4-(2-(6-(di-m-tolylamino)naphthalen-2-yl)vinyl)pyridin-1-ium-1-yl)butane-1-sulfonate (MT21)

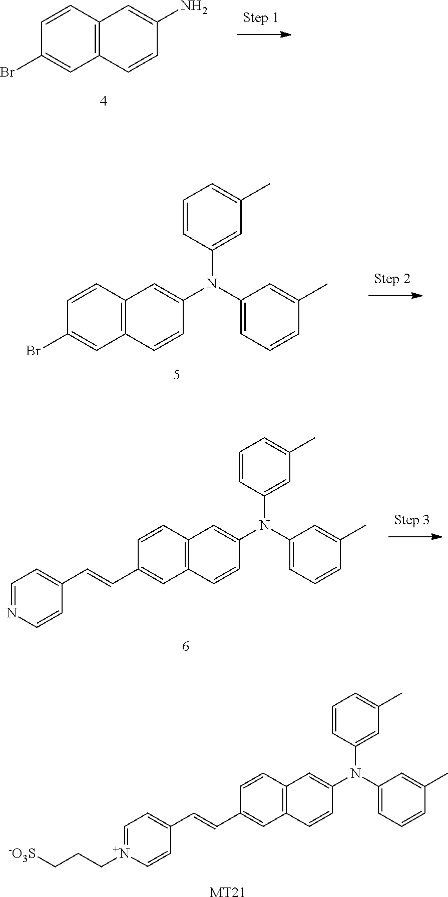

### Step 1—Synthesis of 6-bromo-N,N-di-m-tolylnaphthalen-2-amine (5)

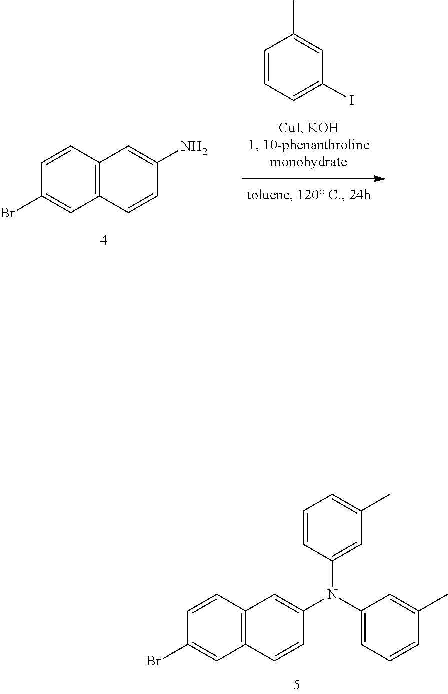

To a sealed tube charged with 6-bromonaphthalen-2-amine (4) (300 mg, 1.35 mmol), 3-iodotoluene (0.9 ml, 6.95 mmol), Cul (257 mg, 1.35 mmol), 1,10-phenanthroline monohydrate (243 mg, 1.35 mmol), and KOH (1.5 g, 27.01 mmol) was added anhydrous toluene (5 ml) under a nitrogen atmosphere. The mixture was stirred and refluxed at 120° C. for 24 h. After cooling to room temperature, the reaction mixture was filtered, followed by the addition of a brine solution (20 mL) to the filtrate. The aqueous layer was extracted with CH₂Cl₂ (3×15 mL) and the combined organic phase was dried over anhydrous Na₂SO₄, filtered, and concentrated under reduced pressure. The resulting crude product was subjected to flash column chromatography (0-10% hexanes/ethyl acetate) to afford 6-bromo-N,N-di-m-tolylnaphthalen-2-amine (5) (498 mg, 92%) as a pale-yellow fluffy solid. ¹H NMR (500 MHz, CDCl₃) δ 7.9 (dd, J=1.7, 0.9 Hz, 1H), 7.6 (d, J=8.9 Hz, 1H), 7.5 (d, J=1.7 Hz, 2H), 7.4 (dd, J=1.9, 1.1 Hz, 1H), 7.3 (dd, J=8.9, 2.3 Hz, 1H), 7.2 (t, J=7.7 Hz, 2H), 7.0 (td, J=1.7, 0.9 Hz, 2H), 7.0 (ddt, J=8.0, 2.3, 0.9 Hz, 2H), 6.9 (ddt, J=7.5, 1.8, 0.9 Hz, 2H), 2.3 (s, 6H); ¹³C NMR (125 MHz, CDCl₃) δ 147.6, 146.3, 139.3, 133.0, 130.7, 129.6, 129.5, 129.2, 128.5, 127.8, 125.4, 125.1, 124.3, 122.0, 119.0, 117.8, 21.5.

### Step 2—Synthesis of (E)-9-(2-(pyridin-4-yl)vinyl)-N,N-di-m-tolylphenanthren-3-amine (6)

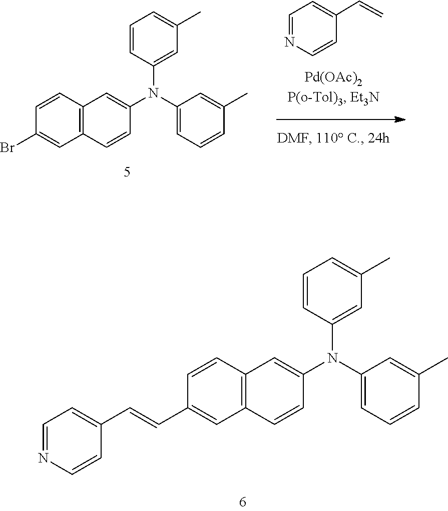

To a sealed tube containing a solution of 6-bromo-N,N-di-m-tolylnaphthalen-2-amine (5) (300.0 mg, 0.74 mmol) in anhydrous N,N-dimethylformamide (5 mL) under nitrogen were added palladium (II) acetate (5.0 mg, 0.022 mmol), tri-(o-tolyl)phosphine (45.0 mg, 0.14 mmol), triethylamine (1.8 mL, 12.95 mmol) and 4-vinylpyridine (0.12 mL, 1.11 mmol). After stirring at 110° C. for 24 h, the reaction mixture was cooled down to room temperature, diluted with water (20 mL) and extracted with ethyl acetate (3×30 mL). The combined organic layer was washed with water (20 mL) and brine (20 mL), dried over anhydrous Na₂SO₄, filtered and concentrated under reduced pressure. The crude product was purified by flash chromatography (0-60% hexanes/ethyl acetate+1% triethylamine) to afford (E)-6-(2-(pyridin-4-yl)vinyl)-N,N-di-m-tolylnaphthalen-2-amine (6) (194 mg, 61%) as a yellow solid. ¹H NMR (400 MHz, CDCl₃) δ 8.6-8.6 (m, 2H), 7.8 (d, J=1.7 Hz, 1H), 7.7 (d, J=8.9 Hz, 1H), 7.6 (dd, J=8.7, 1.8 Hz, 1H), 7.6 (d, J=8.6 Hz, 1H), 7.4 (d, J=16.4 Hz, 1H), 7.4 (dd, J=4.6, 1.7 Hz, 2H), 7.3 (d, J=2.2 Hz, 1H), 7.3 (dd, J=8.9, 2.3 Hz, 1H), 7.2 (t, J=7.7 Hz, 2H), 7.1 (d, J=16.3 Hz, 1H), 7.0-6.9 (m, 4H), 6.9-6.9 (m, 2H), 2.3 (s, 6H); ¹³C NMR (100 MHz, CDCl₃) δ 150.0, 147.5, 146.6, 139.3, 134.7, 133.5, 131.9, 129.6, 129.1, 129.0, 127.6, 127.5, 125.5, 125.1, 124.5, 124.2, 123.7, 122.0, 120.8, 118.8, 21.4; HRMS (ESI-TOF): m/z [M+H]⁺ calcd for C₃₁H₂₇N₂: 427.2169, found: 477.215.

### Step 3—Synthesis of (E)-4-(4-(2-(6-(di-m-tolylamino)naphthalen-2-yl)vinyl)pyridin-1-ium-1-yl)butane-1-sulfonate (MT21)

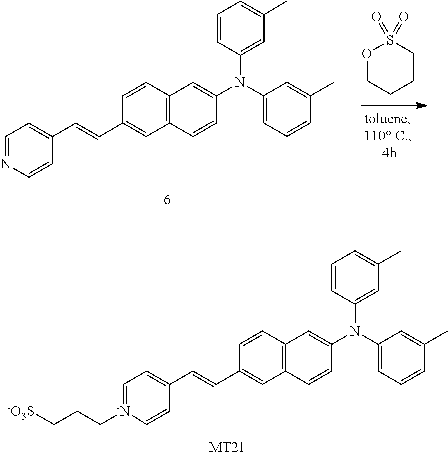

To a solution of 1,4-butanesultone (30 mg, 0.22 mmol) in anhydrous toluene (2 mL) under nitrogen was added a solution of (E)-6-(2-(pyridin-4-yl)vinyl)-N,N-di-m-tolylnaphthalen-2-amine (6) (30 mg, 0.07 mmol) in anhydrous toluene (2 mL) at room temperature. The reaction mixture was subsequently stirred at 110° C. for 4 h. The solvent was then removed under reduced pressure and the residue subjected to silica gel column chromatography (0-10% DCM/MeOH) to afford (E)-4-(4-(2-(6-(di-m-tolylamino)naphthalen-2-yl)vinyl)pyridin-1-ium-1-yl)butane-1-sulfonate (MT21) as a bright orange solid (29 mg, 73% yield). ¹H NMR (400 MHz, CD2Cl2:CD3OD (4:1)) δ 8.7-8.6 (m, 2H), 8.0-7.9 (m, 3H), 7.9 (d, J=16.1 Hz, 1H), 7.7-7.7 (m, 2H), 7.6 (d, J=8.7 Hz, 1H), 7.3-7.2 (m, 3H), 7.2 (t, J=7.7 Hz, 2H), 7.0-6.9 (m, 6H), 4.5 (t, J=7.5 Hz, 2H), 2.9 (t, J=7.0 Hz, 2H), 2.3 (s, 6H), 2.2 (p, J=7.4 Hz, 2H), 1.8 (p, J=7.1 Hz, 2H); ¹³C NMR (100 MHz, CD₂Cl₂:CD₃OD (4:1)) δ 54.1, 147.9, 147.0, 143.5, 142.6, 139.5, 135.9, 130.6, 130.1, 129.5, 129.1, 128.9, 127.6, 125.9, 124.8, 123.7, 123.6, 122.4, 120.8, 117.1, 60.1, 49.7, 29.8, 21.2, 20.9; HRMS (ESI-TOF): m/z [M+H]⁺ calcd. for C₃₅H₃₅N₂O₃S: 563.2363, found: 563.2345.

### 5. Synthesis of (E)-3-(4-(2-(6-(bis(3-methylbut-2-en-1-yl)amino)naphthalen-2-yl)vinyl)pyridin-1-ium-1-yl)propane-1-sulfonate (MT22)

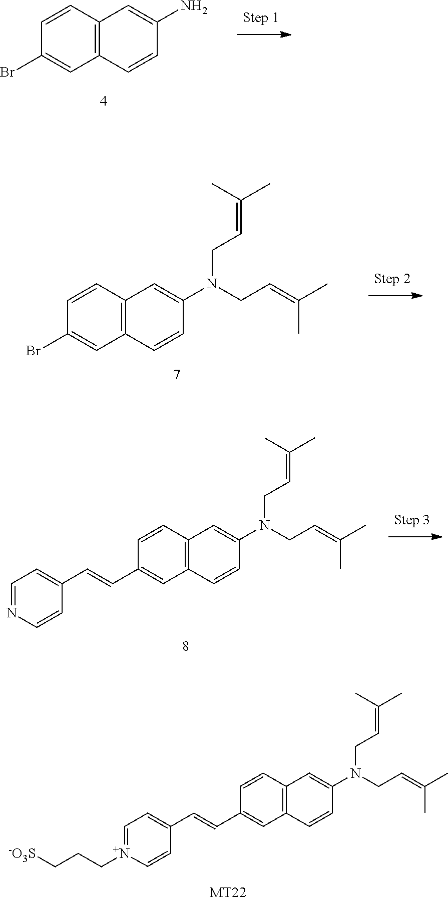

### Step 1—Synthesis of 6-bromo-N,N-bis(3-methylbut-2-en-1-yl)naphthalen-2-amine (7)

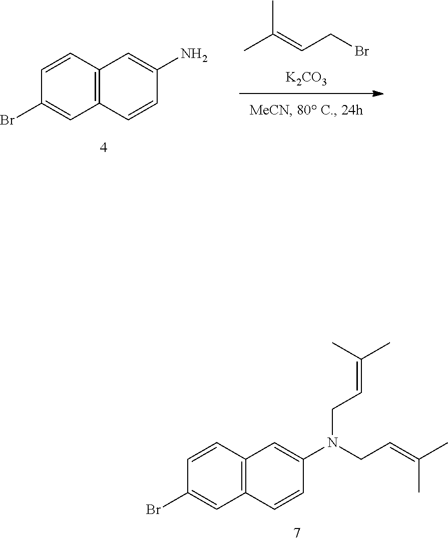

In a sealed tube, 6-bromonaphthalen-2-amine (4) (200.0 mg, 0.9 mmol), K₂CO₃ (249.0 mg, 1.8 mmol), molecular sieves (4 Å, 150.0 mg) and prenyl bromide (460.0 μL, 4.0 mmol), were dissolved in acetonitrile (4 ml). The mixture was heated to 80° C. and stirred for 48 h. After cooling to room temperature, the reaction mixture was filtered through a celite pad, and the filtrate evaporated under reduced pressure. The resulting crude product was subjected to flash column chromatography (0-10% hexanes/ethyl acetate) to afford 6-bromo-N,N-bis(3-methylbut-2-en-1-yl)naphthalen-2-amine (7) (202.0 mg, 63%) as a pale-yellow fluffy solid. ¹H NMR (400 MHz, CDCl₃) δ 7.8 (s, 1H), 7.6 (d, J=9.2 Hz, 1H), 7.5 (d, J=8.7 Hz, 1H), 7.5-7.4 (m, 1H), 7.2-7.1 (m, 1H), 6.9 (s, 1H), 5.3 (d, J=6.6 Hz, 2H), 4.0 (d, J=6.2 Hz, 4H), 1.8 (s, 12H); ¹³C NMR (100 MHz, CDCl₃) δ 122.0, 119.0, 117.8, 21.5. 147.3, 134.6, 133.6, 129.3, 129.2, 127.8, 127.8, 127.6, 121.4, 117.5, 114.7, 111.6, 106.3, 48.4, 25.8, 18.0; HRMS (ESI-TOF): m/z [M+H]⁺ calcd. for C₂₀H₂₅BrN: 358.1165, found: 358.1116.

### Step 2—Synthesis of (E)-N,N-bis(3-methylbut-2-en-1-yl)-6-(2-(pyridin-4-yl)vinyl)naphthalen-2-amine (8)

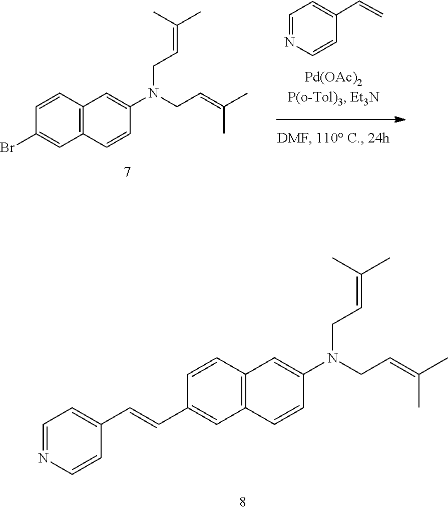

To a sealed tube containing a solution of 6-bromo-N,N-bis(3-methylbut-2-en-1-yl)naphthalen-2-amine (7) (100.0 mg, 0.28 mmol) in anhydrous N,N-dimethylformamide (3 mL) under nitrogen were added palladium (II) acetate (2.0 mg, 0.09 mmol), tri-(o-tolyl)phosphine (17.0 mg, 0.6 mmol), triethylamine (0.68 mL, 4.9 mmol) and 4-vinylpyridine (45.0 μL, 0.41 mmol). After stirring at 110° C. for 24 h, the reaction mixture was cooled down to room temperature, diluted with water (20 mL) and extracted with ethyl acetate (3×15 mL). The combined organic layer was washed with water (20 mL) and brine (20 mL), dried over anhydrous Na₂SO₄, filtered and concentrated under reduced pressure. The crude product was purified by flash chromatography (0-60% hexanes/ethyl acetate+1% triethylamine) to afford the title compound (E)-N,N-bis(3-methylbut-2-en-1-yl)-6-(2-(pyridin-4-yl)vinyl)naphthalen-2-amine (8) (68 mg, 64%) as a yellow solid. ¹H NMR (400 MHz, CDCl₃) δ 8.6 (d, J=5.6 Hz, 2H), 7.7 (s, 1H), 7.7 (d, J=9.1 Hz, 1H), 7.6-7.6 (m, 2H), 7.4 (d, J=16.2 Hz, 1H), 7.4-7.4 (m, 2H), 7.1 (dd, J=9.1, 2.6 Hz, 1H), 7.0 (d, J=16.2 Hz, 1H), 6.9 (d, J=2.6 Hz, 1H), 5.3 (tp, J=6.3, 1.4 Hz, 2H), 4.0 (d, J=6.3 Hz, 4H), 1.8 (s, 12H); ¹³C NMR (100 MHz, CDCl₃) δ 149.8, 147.7, 145.4, 135.5, 134.6, 134.1, 129.4, 129.2, 128.0, 126.7, 126.2, 123.6, 123.5, 121.3, 120.7, 116.9, 106.3, 48.3, 25.8, 18.0.

### Step 3—Synthesis of (E)-3-(4-(2-(6-(bis(3-methylbut-2-en-1-yl)amino)naphthalen-2-yl)vinyl)pyridin-1-ium-1-yl)propane-1-sulfonate (MT22)

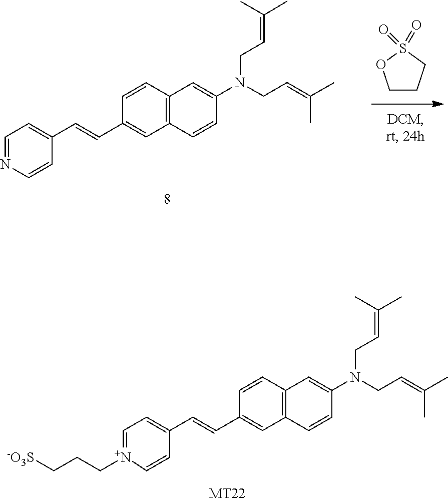

To a solution of 1,3-propanesultone (60.0 mg, 0.49 mmol) in anhydrous DCM (2 mL) under nitrogen was added a solution of (E)-6-(2-(pyridin-4-yl)vinyl)-N,N-di-m-tolylnaphthalen-2-amine (8) (30 mg, 0.07 mmol) in anhydrous DCM (2 mL) at room temperature. The reaction mixture was subsequently stirred for 24 h. The solvent was then removed under reduced pressure, and the residue was subjected to silica gel column chromatography (0-10% DCM/MeOH) to afford the title compound (E)-3-(4-(2-(6-(bis(3-methylbut-2-en-1-yl)amino)naphthalen-2-yl)vinyl)pyridin-1-ium-1-yl)propane-1-sulfonate (MT22) as a bright orange solid (33 mg, 44% yield). ¹H NMR (400 MHz, CD₂Cl₂:CD₃OD (4:1)) δ 8.7-8.6 (m, 2H), 7.9-7.9 (m, 2H), 7.9 (s, 1H), 7.8 (d, J=16.5 Hz, 1H), 7.7 (d, J=9.1 Hz, 1H), 7.7 (dd, J=8.8, 1.8 Hz, 1H), 7.6 (d, J=8.7 Hz, 1H), 7.2 (d, J=16.0 Hz, 1H), 7.1 (dd, J=9.2, 2.6 Hz, 1H), 6.9 (d, J=2.5 Hz, 1H), 5.2 (ddq, J=6.3, 4.8, 1.4 Hz, 2H), 4.7 (t, J=7.2 Hz, 2H), 4.0 (d, J=6.3 Hz, 4H), 2.9-2.8 (m, 2H), 2.4-2.3 (m, 2H), 1.7 (d, J=1.4 Hz, 6H), 1.7 (d, J=1.4 Hz, 6H); ¹³C NMR (100 MHz, CD₂Cl₂:CD₃OD (4:1)) δ 154.4, 148.7, 143.5, 143.3, 136.8, 135.0, 131.3, 129.9, 127.7, 126.9, 125.7, 123.4, 123.3, 120.7, 119.1, 116.8, 105.8, 58.5, 48.6, 48.2, 46.4, 27.0, 25.2, 17.5; HRMS (ESI-TOF): m/z [M+H]⁺ calcd. for C₃₀H₃₇N₂O₃S: 505.2519, found: 505.25.

### 6. Synthesis of 4-[(1E)-2-{6-[Bis(3-methylphenyl)amino]naphthalen-2-yl}ethenyl]-3-fluoro-1-(3-sulfopropyl)pyridin-1-ium (MT23)

### Step 1—Synthesis of 3-fluoro-4-methyl-1-(3-sulfopropyl)pyridin-1-ium

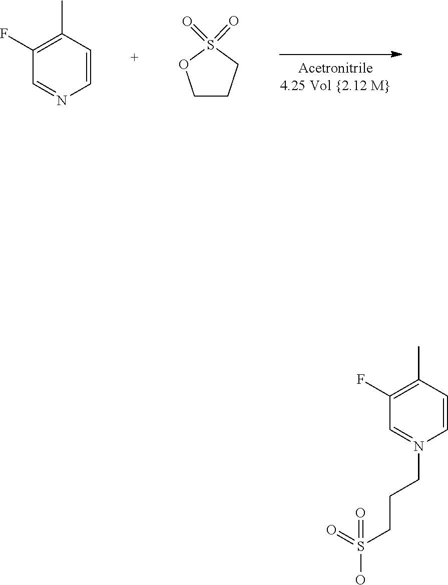

To a solution of 3-fluoro-4-methylpyridine (400.0 mg, 3.600 mmol) in acetonitrile (1.70 mL, 4.25 Vol) was added 1,2λ6-oxathiolane-2,2-dione (332 μl, 3.780 mmol) at room temperature. The mixture was stirred at 80° C. for 4 h. After cooling, the precipitate was recovered by filtration and washed twice with MeCN to give 3-fluoro-4-methyl-1-(3-sulfopropyl)pyridin-1-ium (635.6 mg, 76% yield) as a white solid.

### Step 2—Synthesis of 6-bromo-N,N-bis(3-methylphenyl)naphthalen-2-amine

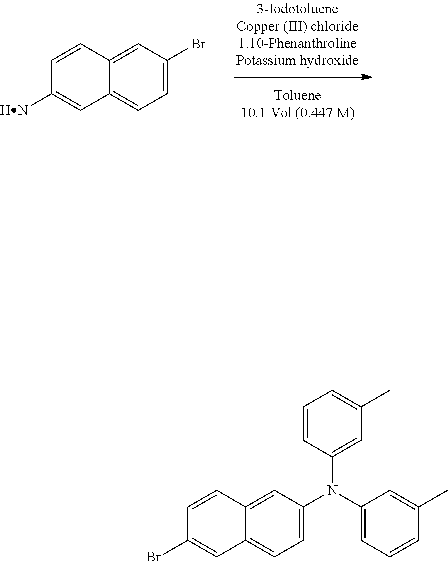

In a sealable tube containing a solution of 2-amino-6-bromonaphthalene (1.50 g, 6.754 mmol) in anhydrous Toluene (15.11 mL, 142.1 mmol) under argon were added sequentially copper (II) chloride (99.9 mg, 0.7430 mmol), 1,10-phenanthroline (133.9 mg, 0.7430 mmol), potassium hydroxide (4.17 g, 74.30 mmol) and 3-iodotoluene (2.26 mL, 17.56 mmol). The tube was subsequently capped and the mixture was stirred at 125° C. for 20 h.

After cooling to r.t., the reaction mixture was poured into water and extracted thrice with dichloromethane. The combined organic layer was washed with brine, dried with sodium sulfate and concentrated under vacuum. The residue was purified on silica gel column chromatography (0-4% EtOAc in heptanes) to give two fractions containing 6-bromo-N,N-bis(3-methylphenyl)naphthalen-2-amine (2.31 g, 5.742 mmol, 85% yield).

### Step 3—Synthesis of 6-[bis(3-methylphenyl)amino]naphthalene-2-carbaldehyde

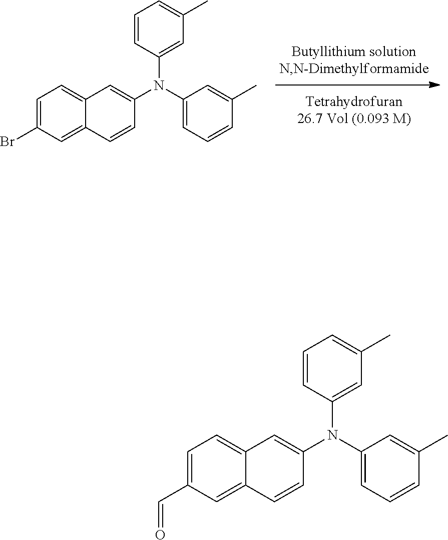 [SMILES: Cc1cccc(N(c2cccc(C)c2)c2ccc3cc(Br)ccc3c2)c1 ; Cc1cccc(N(c2cccc(C)c2)c2ccc3cc(C=O)ccc3c2)c1]

To a solution of 6-bromo-N,N-bis(3-methylphenyl)naphthalen-2-amine (663.3 mg, 1.649 mmol) in tetrahydrofuran (17.68 mL, 218.1 mmol) at −78° C. was added a butyllithium solution (910.05 μl, 2.275 mmol). The mixture was stirred at −78° C. for 1 h followed by the addition of N,N-dimethylformamide (456.99 μl, 5.902 mmol) at −78° C. The reaction mixture was subsequently allowed to warm 0° C. for 4 h.

The reaction mixture was quenched with water and extracted thrice with dichloromethane. The combined organic layer was washed with brine, dried with Na₂SO₄, filtered, and concentrated under vacuum. The residue was purified on silica gel column chromatography (0-20% EtOAc in heptanes) to give 6-[bis(3-methylphenyl)amino]naphthalene-2-carbaldehyde (531.3 mg, 92% yield) as a yellow solid.

### Step 4—Synthesis of 4-[(1E)-2-{6-[bis(3-methylphenyl)amino]naphthalen-2-yl}ethenyl]-3-fluoro-1-(3-sulfopropyl)pyridin-1-ium (MT23)

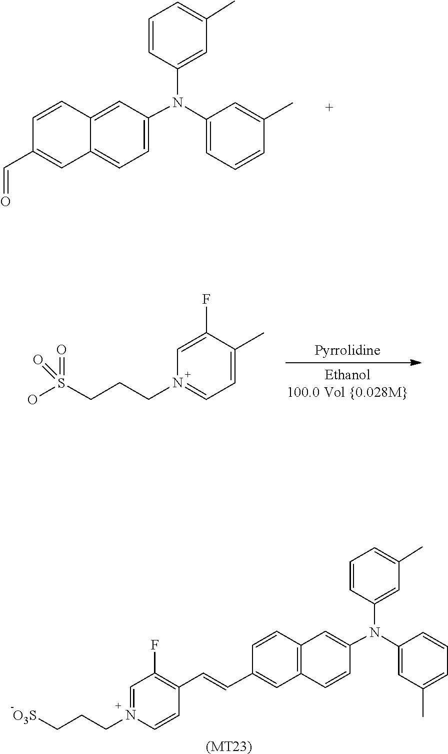

To a solution of 6-[bis(3-methylphenyl)amino]naphthalene-2-carbaldehyde (100.0 mg, 0.2845 mmol) and 3-fluoro-4-methyl-1-(3-sulfopropyl)pyridin-1-ium (66.4 mg, 0.2845 mmol) in ethanol (10 ml, 171.3 mmol) was added pyrrolidine (7.04 μl, 0.0854 mmol). The mixture was stirred at room temperature for 4 h.

Water was added and the reaction mixture extracted with EtOAc resulting in significant emulsion formation. The combined organic layer and a little of the aqueous phase were concentrated under vacuum. The residue was purified by silica gel column chromatography (DCM/MeOH) to give the desired impure product (102 mg, 84.9% purity). The product was repurified on C18 column chromatography (H₂O/MeOH) to give 4-[(1E)-2-{6-[bis(3-methylphenyl)amino]naphthalen-2-yl}ethenyl]-3-fluoro-1-(3-sulfopropyl)pyridin-1-ium (59.4 mg, 37% yield) as a red solid.

¹H NMR (400 MHz, DMSO-d6) δ 9.34 (d, J=5.1 Hz, 1H), 8.90 (d, J=6.6 Hz, 1H), 8.52 (t, J=7.1 Hz, 1H), 8.23-8.12 (m, 2H), 7.95-7.83 (m, 2H), 7.74 (d, J=8.8 Hz, 1H), 7.51 (d, J=16.4 Hz, 1H), 7.31-7.22 (m, 3H), 7.20 (dd, J=9.0, 2.2 Hz, 1H), 6.99-6.89 (m, 6H), 4.65 (t, J=6.8 Hz, 2H), 2.49-2.45 (m, 2H), 2.30-2.21 (m, 8H). ¹⁹F NMR (377 MHz, DMSO-d6) δ-124.75 (br, s, 1F). HRMS (ESI-TOF): m/z [M+H]⁺ calcd. for C₃₄H₃₁FN₂O₃S: 566.68, found: 567.10.

### 7. Synthesis of 4-[(1Z)-2-{6-[Bis(3-methylphenyl)amino]naphthalen-2-yl}-1-fluoroethenyl]-1-(3-sulfopropyl)pyridin-1-ium (MT24)

### Step 1—Synthesis of 4-(fluoromethyl)-1-(3-sulfopropyl)pyridin-1-ium

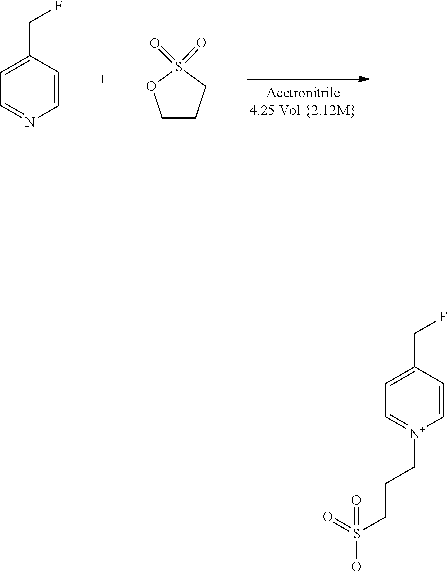 [SMILES: FCc1ccncc1 ; O=S1(=O)CCCO1 ; O=S(=O)(O)CCC[n+]1ccc(CF)cc1]

To a solution of 4-(fluoromethyl)pyridine (100.0 mg, 0.8999 mmol) in acetonitrile (424.94 μl, 8.138 mmol) was added 1,2λ6-oxathiolane-2,2-dione (115.4 mg, 0.9449 mmol) at room temperature. The mixture was stirred at room temperature for 19 h. After cooling, the precipitate was recovered by filtration and washed twice with MeCN to give 4-(fluoromethyl)-1-(3-sulfopropyl)pyridin-1-ium (139.4 mg, 0.5976 mmol, 66% yield) as a beige solid.

### Step 2—Synthesis of 6-bromo-N,N-bis(3-methylphenyl)naphthalen-2-amine See Step 2 of the Synthesis of MT23 Above

### Step 3—Synthesis of 6-[bis(3-methylphenyl)amino]naphthalene-2-carbaldehyde See Step 3 of the Synthesis of MT23 Above

### Step 4—Synthesis of 4-[(1Z)-2-{6-[bis(3-methylphenyl)amino]naphthalen-2-yl}-1-fluoroethenyl]-1-(3-sulfopropyl)pyridin-1-ium (MT24)

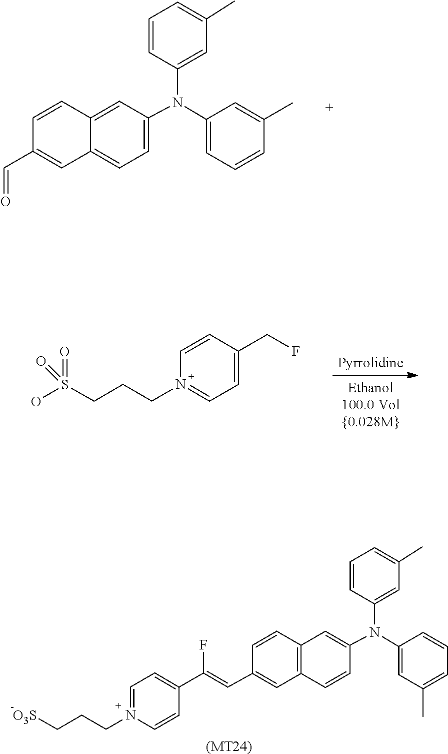

To a solution of 6-[bis(3-methylphenyl)amino]naphthalene-2-carbaldehyde (100.0 mg, 0.2845 mmol) and 4-(fluoromethyl)-1-(3-sulfopropyl)pyridin-1-ium (66.4 mg, 0.2845 mmol) in ethanol (10 ml, 171.3 mmol) was added pyrrolidine (7.04 μl, 0.0854 mmol). The reaction mixture was stirred at room temperature for 24 h.

The reaction mixture was subsequently concentrated under vacuum. The residue was purified using silica gel column chromatography (DCM/MeOH) and freeze-dried to give 4-[(1Z)-2-{6-[bis(3-methylphenyl)amino]naphthalen-2-yl}-1-fluoroethenyl]-1-(3-sulfopropyl)pyridin-1-ium (141.1 mg, 87% yield) as a red solid.

¹H NMR (400 MHz, DMSO-d6) δ 9.09 (d, J=5.1 Hz, 2H), 8.37 (d, J=4.9 Hz, 2H), 8.21 (br, s, 1H), 7.90 (d, J=8.6 Hz, 1H), 7.83-7.67 (m, 3H), 7.33-7.13 (m, 4H), 7.03-6.82 (m, 6H), 4.79-4.60 (m, 2H), 2.47-2.38 (m, 2H), 2.35-2.15 (m, 8H). ¹⁹F NMR (377 MHz, DMSO-d6) δ-120.77 (br, s, 1F). HRMS (ESI-TOF): m/z [M+H]⁺ calcd. for C₃₄H₃₁FN₂O₃S: 566.68, found: 567.10.

### 8. Synthesis of 4-[(1E)-2-{6-[Bis(3-methylbut-2-en-1-yl)amino]-5-fluoronaphthalen-2-yl}ethenyl]-1-(3-sulfopropyl)pyridin-1-ium (MT25)

### Step 1—Synthesis of 4-methyl-1-(3-sulfopropyl)pyridin-1-ium

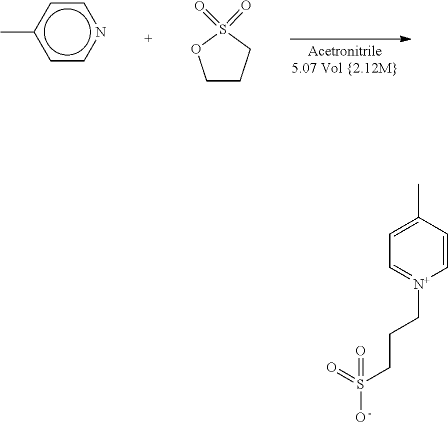

To a solution of 4-picoline (600.0 μl, 6.166 mmol) in acetonitrile (2.91 ml, 55.75 mmol) was added 1,2λ6-oxathiolane-2,2-dione (790.7 mg, 6.474 mmol) at room temperature. The reaction mixture was stirred at 80° C. for 1 h. After cooling, the precipitate was recovered by filtration and washed twice with MeCN to give 4-methyl-1-(3-sulfopropyl)pyridin-1-ium (1.005 g, quantitative) as a white solid.

### Step 2—Synthesis of 6-bromo-N,N-bis(3-methylbut-2-en-1-yl)naphthalen-2-amine

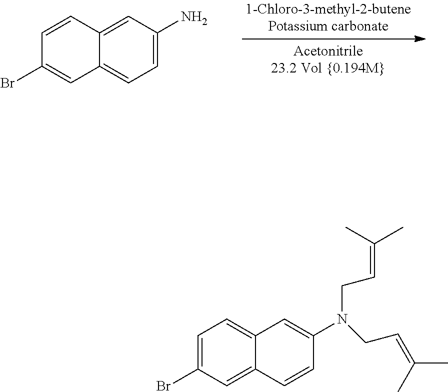 [SMILES: Nc1ccc2cc(Br)ccc2c1 ; CC(C)=CCN(CC=C(C)C)c1ccc2cc(Br)ccc2c1]

### Step 3—Synthesis of 6-[bis(3-methylbut-2-en-1-yl)amino]naphthalene-2-carbaldehyde

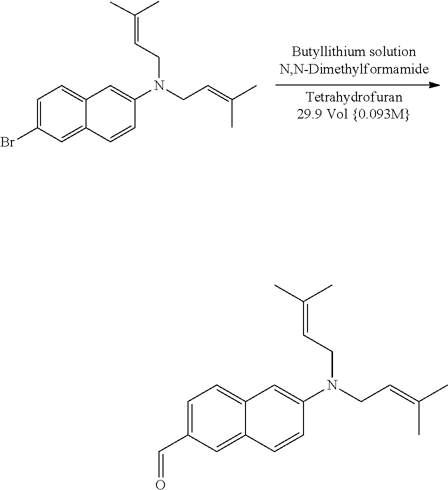 [SMILES: CC(C)=CCN(CC=C(C)C)c1ccc2cc(Br)ccc2c1 ; CC(C)=CCN(CC=C(C)C)c1ccc2cc(C=O)ccc2c1]

To a solution of 6-bromo-N,N-bis(3-methylbut-2-en-1-yl)naphthalen-2-amine (800.0 mg, 2.233 mmol) in tetrahydrofuran (23.95 ml, 29.9 Vol) at −78° C. was added a butyllithium solution (1.23 ml, 3.081 mmol). The mixture was stirred at −78° C. for 1 h followed by the addition of N,N-dimethylformamide (619 μl, 7.993 mmol) at −78° C. The reaction mixture was subsequently allowed to warm to 0° C. for 3 h.

The reaction mixture was then quenched with water and extracted thrice with dichloromethane. The combined organic layer was washed with brine, dried with Na₂SO₄, filtered, and concentrated under vacuum. The residue was purified using silica gel column chromatography (0-20% EtOAc in heptanes) to give 6-[bis(3-methylbut-2-en-1-yl)amino]naphthalene-2-carbaldehyde (635.9 mg, 93% yield) as a yellow solid.

### Step 4—Synthesis of 6-[bis(3-methylbut-2-en-1-yl)amino]-5-fluoronaphthalene-2-carbaldehyde

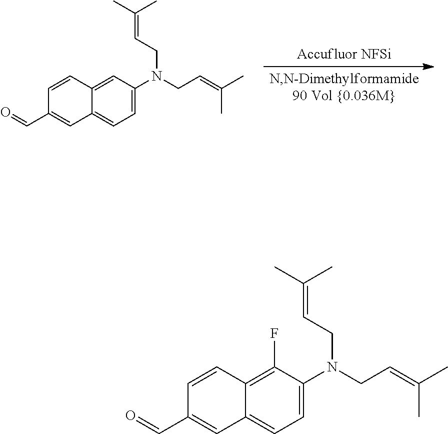 [SMILES: CC(C)=CCN(CC=C(C)C)c1ccc2cc(C=O)ccc2c1 ; CC(C)=CCN(CC=C(C)C)c1ccc2cc(C=O)ccc2c1F]

To a solution of 6-[bis(3-methylbut-2-en-1-yl)amino]naphthalene-2-carbaldehyde (200.0 mg, 0.6506 mmol) in N,N-dimethylformamide (18.00 ml, 232.5 mmol) at −40° C. was added Accufluor NFSi (205.1 mg, 0.6506 mmol). The reaction mixture was then allowed to warm up to room temperature for 5 h.

An aqueous potassium carbonate solution (10% w/w) was subsequently added and the product extracted thrice with EtOAc. The combined organic layer was washed with brine, dried with Na₂SO₄, filtered, and concentrated under vacuum. The residue was purified by C18 column chromatography (H₂O+0.1% FA/MeCN) to give 6-[bis(3-methylbut-2-en-1-yl)amino]-5-fluoronaphthalene-2-carbaldehyde (113.0 mg, 0.3472 mmol, 53% yield).

### Step 5—Synthesis of 4-[(1E)-2-{6-[bis(3-methylbut-2-en-1-yl)amino]-5-fluoronaphthalen-2-yl}ethenyl]-1-(3-sulfopropyl)pyridin-1-ium (MT25)

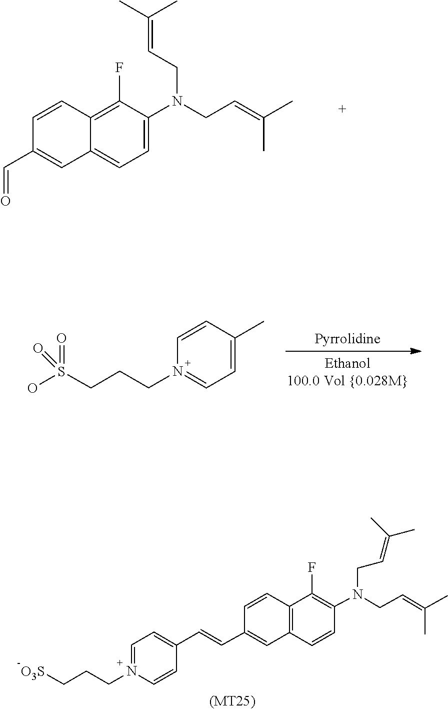

To a solution of 6-[bis(3-methylbut-2-en-1-yl)amino]-5-fluoronaphthalene-2-carbaldehyde (60.0 mg, 0.1844 mmol) and 4-methyl-1-(3-sulfopropyl)pyridin-1-ium (39.7 mg, 0.1844 mmol) in ethanol (6.48 ml, 108 Vol) was added pyrrolidine (5 μl, 0.05531 mmol). The mixture was stirred at room temperature for 24 h.

The reaction mixture was subsequently concentrated under vacuum. The residue was purified using silica gel column chromatography (0 to 50% MeOH in DCM) and freeze-dried to give 4-[(1E)-2-{6-[bis(3-methylbut-2-en-1-yl)amino]-5-fluoronaphthalen-2-yl}ethenyl]-1-(3-sulfopropyl)pyridin-1-ium (76.7 mg, 80% yield) as an orange solid.

¹H NMR (400 MHz, DMSO-d6) δ 8.95 (d, J=6.6 Hz, 2H), 8.24 (d, J=6.6 Hz, 2H), 8.17-8.07 (m, 2H), 7.99-7.88 (m, 2H), 7.71 (d, J=9.0 Hz, 1H), 7.59 (d, J=16.1 Hz, 1H), 7.31 (t, J=8.8 Hz, 1H), 5.30-5.17 (m, 2H), 4.64 (t, J=6.7 Hz, 2H), 3.88 (d, J=6.1 Hz, 4H), 2.44 (t, J=7.1 Hz, 2H), 2.23 (quin, J=6.8 Hz, 2H), 1.68 (s, 6H), 1.64 (s, 6H). ¹⁹F NMR (377 MHz, DMSO-d6) δ-136.07 (s, 1F). HRMS (ESI-TOF): m/z [M+H]⁺ calcd. for C₃₀H₃₅FN₂O₃S: 522.67, found: 523.20.

### 9. Synthesis of 4-[(1E)-2-{6-[Bis(3-methylbut-2-en-1-yl)amino]-5-(trifluoromethyl)naphthalen-2-yl}ethenyl]-1-(3-sulfopropyl)pyridin-1-ium (MT26)

### Step 1—Synthesis of 4-methyl-1-(3-sulfopropyl)pyridin-1-ium See Step 1 of the Synthesis of MT25 Above

### Step 2—Synthesis of 6-bromo-N,N-bis(3-methylbut-2-en-1-yl)naphthalen-2-amine See Step 2 of the Synthesis of MT25 Above

Step 3—Synthesis of 6-bromo-N,N-bis(3-methylbut-2-en-1-yl)-1-(trifluoromethyl)naphthalen-2-amine

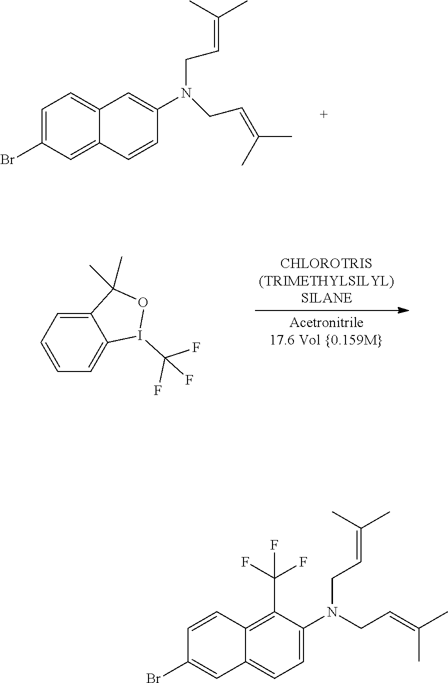 [SMILES: CC(C)=CCN(CC=C(C)C)c1ccc2cc(Br)ccc2c1 ; CC1(C)OI(C(F)(F)F)c2ccccc21 ; CC(C)=CCN(CC=C(C)C)c1ccc2cc(Br)ccc2c1C(F)(F)F]

To a solution of 3,3-Dimethyl-1-(trifluoromethyl)-1,2-benziodoxole (549.4 mg, 1.664 mmol) and Chlorotris(trimethylsilyl)silane (252.4 mg, 0.3329 mmol) in Acetonitrile (7.00 ml, 134.0 mmol) was added 6-bromo-N,N-bis(3-methylbut-2-en-1-yl)naphthalen-2-amine (397.6 mg, 1.110 mmol) at room temperature. The mixture was stirred at 80° C. for 3 h.

After cooling, the mixture was concentrated under vacuum. The crude was purified on silica gel column chromatography (0 to 10%, EtOAc in Heptanes) to give 6-bromo-N,N-bis(3-methylbut-2-en-1-yl)-1-(trifluoromethyl)naphthalen-2-amine (123.7 mg, 0.2902 mmol) as a yellow oil.

The resulting product had a purity of 74%, and was used as is for the next step.

### Step 4—Synthesis of 6-[bis(3-methylbut-2-en-1-yl)amino]-5-(trifluoromethyl)naphthalene-2-carbaldehyde

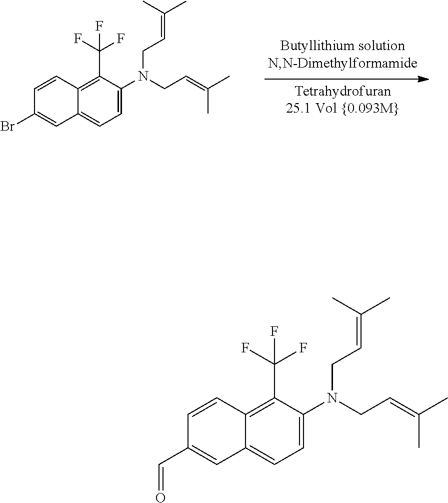 [SMILES: CC(C)=CCN(CC=C(C)C)c1ccc2cc(Br)ccc2c1C(F)(F)F ; CC(C)=CCN(CC=C(C)C)c1ccc2cc(C=O)ccc2c1C(F)(F)F]

To a solution of 6-bromo-N,N-bis(3-methylbut-2-en-1-yl)-1-(trifluoromethyl)naphthalen-2-amine (115.0 mg, 0.2698 mmol) in tetrahydrofuran (2.89 ml, 35.61 mmol) at −78° C. was added a butyllithium solution (148.91 μl, 0.3723 mmol). The reaction mixture was then stirred at −78° C. for 40 min, followed by the addition of N,N-dimethylformamide (74.79 μl, 0.9657 mmol) at −78° C. The reaction mixture was subsequently allowed to warm to 0° C. for 1 h, after which it was stirred at 0° C. for an additional 2 h.

The reaction was then quenched with water and the mixture was extracted thrice with dichloromethane. The combined organic layer was washed with brine, dried with Na₂SO₄, filtered, and concentrated under vacuum. The residue was purified using silica gel column chromatography (0-12% EtOAc in heptanes) to give 6-[bis(3-methylbut-2-en-1-yl)amino]-5-(trifluoromethyl)naphthalene-2-carbaldehyde (65.3 mg, 64% yield) as a yellow oil.

### Step 5—Synthesis of 4-[(1E)-2-{6-[bis(3-methylbut-2-en-1-yl)amino]-5-(trifluoromethyl)naphthalen-2-yl}ethenyl]-1-(3-sulfopropyl)pyridin-1-ium (MT26)

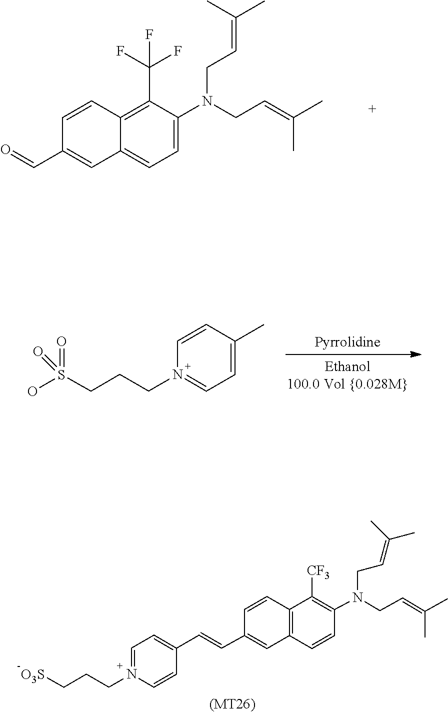

To a solution of 6-[bis(3-methylbut-2-en-1-yl)amino]-5-(trifluoromethyl)naphthalene-2-carbaldehyde (55.5 mg, 0.1478 mmol) and 4-methyl-1-(3-sulfopropyl)pyridin-1-ium (31.8 mg, 0.1478 mmol) in ethanol (5.20 ml, 88.98 mmol) was added pyrrolidine (3.70 μl, 0.0443 mmol).

The reaction mixture was then stirred at room temperature for 24 h and concentrated under vacuum. The residue was purified by C18 column chromatography and freeze-dried to give 4-[(1E)-2-{6-[bis(3-methylbut-2-en-1-yl)amino]-5-(trifluoromethyl)naphthalen-2-yl}ethenyl]-1-(3-sulfopropyl)pyridin-1-ium (35.0 mg, 41% yield) as an orange solid.

¹H NMR (400 MHz, DMSO-d6) δ 8.97 (d, J=6.8 Hz, 2H), 8.27 (d, J=6.8 Hz, 2H), 8.19 (s, 1H), 8.14 (d, J=16.1 Hz, 1H), 8.08 (d, J=9.3 Hz, 1H), 8.04-7.96 (m, 2H), 7.62 (d, J=16.1 Hz, 1H), 7.52 (d, J=9.0 Hz, 1H), 5.19 (t, J=6.2 Hz, 2H), 4.65 (t, J=6.8 Hz, 2H), 3.78 (d, J=6.4 Hz, 4H), 2.45 (t, J=7.1 Hz, 2H), 2.23 (quin, J=6.9 Hz, 2H), 1.66 (s, 6H), 1.57 (s, 6H). ¹⁹F NMR (377 MHz, DMSO-d6) δ-52.21 (s, 3F). HRMS (ESI-TOF): m/z [M+H]⁺ calcd. for C₃₁H₃₅F₃N₂O₃S: 572.68, found: 573.10.

### 10. Synthesis of 4-[(1E)-2-{6-[Bis(3-methylphenyl)amino]naphthalen-2-yl}ethenyl]-1-[3-(trimethylazaniumyl) propyl]pyridin-1-ium dibromide (MT27)

### Step 1—Synthesis of 6-bromo-N,N-bis(3-methylphenyl)naphthalen-2-amine See Steps 1 and 2 of the Synthesis of MT23 Above

### Step 2—Synthesis of N,N-bis(3-methylphenyl)-6-[(1E)-2-(pyridin-4-yl)ethenyl]naphthalen-2-amine

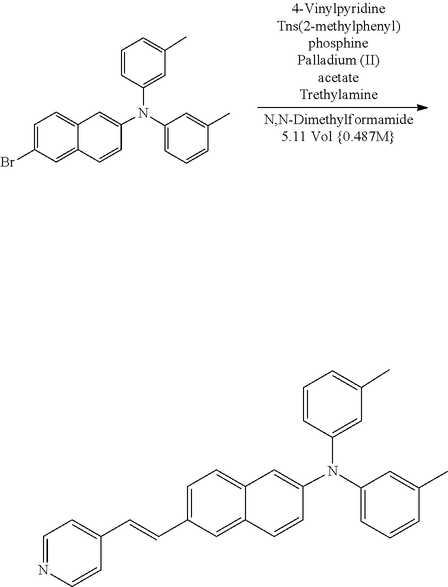 [SMILES: Cc1cccc(N(c2cccc(C)c2)c2ccc3cc(Br)ccc3c2)c1 ; Cc1cccc(N(c2cccc(C)c2)c2ccc3cc(/C=C/c4ccncc4)ccc3c2)c1]

A solution of 6-bromo-N,N-bis(3-methylphenyl)naphthalen-2-amine (600.0 mg, 1.491 mmol) in anhydrous N,N-dimethylformamide (3.06 ml, 39.58 mmol) was degassed by N₂ bubbling. Palladium (II) acetate (16.7 mg, 0.0746 mmol), tris(2-methylphenyl) phosphine (90.8 mg, 0.2983 mmol), triethylamine (415.70 μl, 2.983 mmol) and 4-vinylpyridine (225.13 μl, 2.088 mmol) were then added, and the resulting mixture stirred at 110° C. for 18 h.

The reaction mixture was subsequently cooled down to r.t, diluted with water and extracted thrice with ethyl acetate. The combined organic layer was washed with brine, dried with sodium sulfate, filtered, and concentrated under vacuum. The crude product was purified using silica gel column chromatography (0-60% EtOAc in hexanes) to give N,N-bis(3-methylphenyl)-6-[(1E)-2-(pyridin-4-yl)ethenyl]naphthalen-2-amine (593.7 mg, 93% yield) as an orange solid.

### Step 3—Synthesis of 4-[(1E)-2-{6-[bis(3-methylphenyl)amino]naphthalen-2-yl}ethenyl]-1-[3-(trimethylazaniumyl)propyl]pyridin-1-ium dibromide (MT27)

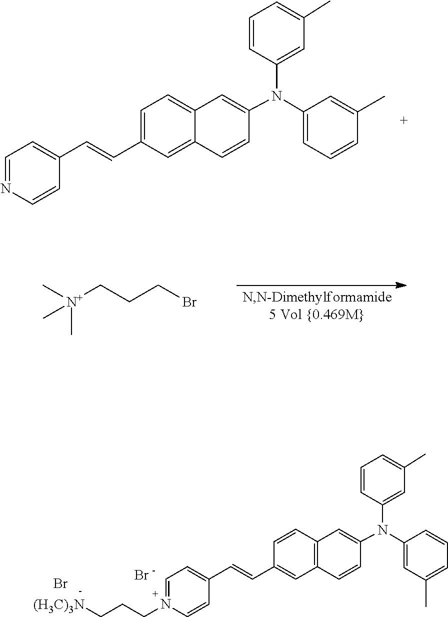

A solution of N,N-bis(3-methylphenyl)-6-[(1E)-2-(pyridin-4-yl)ethenyl]naphthalen-2-amine (100.0 mg, 0.2344 mmol) and (3-bromopropyl)trimethylazanium (42.5 mg, 0.2344 mmol) in N,N-dimethylformamide (500.0 μl, 6.458 mmol) was stirred at 100° C. for 10 h. Et₂O was added and the precipitate was recovered by filtration. The crude was recrystallized in MeOH/Et₂O, filtered and purified using C18 column chromatography to give 4-[(1E)-2-{6-[bis(3-methylphenyl)amino]naphthalen-2-yl}ethenyl]-1-[3-(trimethylazaniumyl)propyl]pyridin-1-ium dibromide (50.9 mg, 32% yield) as a red solid.

¹H NMR (400 MHz, CDCl₃) δ 9.59 (d, J=6.4 Hz, 2H), 7.98-7.87 (m, 3H), 7.79 (d, J=16.1 Hz, 1H), 7.67 (dd, J=18.0, 9.2 Hz, 2H), 7.55 (d, J=8.8 Hz, 1H), 7.27-7.25 (m, 2H), 7.22-7.14 (m, 3H), 7.00-6.91 (m, 6H), 5.14-5.00 (m, 2H), 4.19-4.05 (m, 2H), 3.43 (s, 9H), 3.09-2.94 (m, 2H), 2.29 (s, 6H). HRMS (ESI-TOF): m/z [M-Br₂]²⁺ calcd. for C₃₇H₄₁Br₂N₃: 525.74 (salt: 687.55), found: 526.30.

### 11. 4-[(1E)-2-{6-[Bis(3-methylphenyl)amino]naphthalen-2-yl}ethenyl]-1-{2-hydroxy-3-[(2 hydroxyethyl)dimethylazaniumyl]propyl}pyridin-1-ium dibromide (MT28)

### Step 1—Synthesis of (3-bromo-2-hydroxypropyl)(2-hydroxyethyl)dimethylazanium

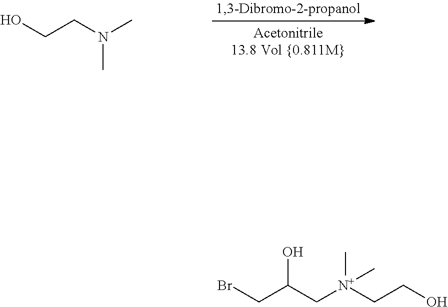

2-Dimethylaminoethanol (677.20 μl, 6.731 mmol) was added dropwise to a stirred solution of 1,3-dibromo-2-propanol (1.03 ml, 10.10 mmol) in acetonitrile (8.30 ml, 158.9 mmol) under an argon atmosphere. The reaction mixture was then stirred at 80° C. for 4 h, allowed to cool down to room temperature, and concentrated under vacuum. The crude product was subsequently purified using silica gel column chromatography (DCM/MeOH, 30-50%) to give three fractions. The fraction containing the desired product was then repurified by silica gel column chromatography to give (3-bromo-2-hydroxypropyl)(2-hydroxyethyl)dimethylazanium (546.1 mg, 36% yield) as a colorless oil.

### Step 2—Synthesis of 6-bromo-N,N-bis(3-methylphenyl)naphthalen-2-amine See Steps 1 and 2 of the Synthesis of MT23 Above

### Step 3—Synthesis of 4-[(1E)-2-{6-[bis(3-methylphenyl)amino]naphthalen-2-yl}ethenyl]-1-{2-hydroxy-3-[(2-hydroxyethyl)dimethylazaniumyl]propyl}pyridin-1-ium dibromide (MT28)

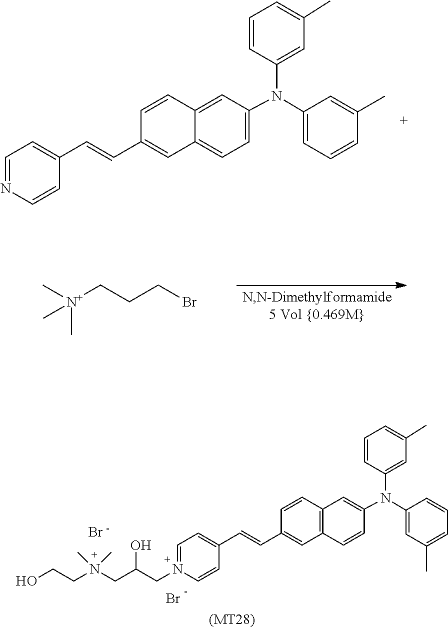

A solution of N,N-bis(3-methylphenyl)-6-[(1E)-2-(pyridin-4-yl)ethenyl]naphthalen-2-amine (100.0 mg, 0.2344 mmol) and (3-bromo-2-hydroxypropyl)(2-hydroxyethyl)dimethylazanium (106.5 mg, 0.4689 mmol) in N,N-Dimethylformamide (500.0 μl, 6.458 mmol) was first stirred at 100° C. for 4.5 h and then at 110° C. for 18 h. Et₂O was subsequently added and the resulting precipitate recovered by filtration. The crude product was then recrystallized in MeOH/Et₂O, filtered, and purified using C18 column chromatography to give 4-[(1E)-2-{6-[bis(3-methylphenyl)amino]naphthalen-2-yl}ethenyl]-1-{2-hydroxy-3-[(2-hydroxyethyl)dimethylazaniumyl]propyl}pyridin-1-ium dibromide (76.6 mg, 44% yield) as a red solid.

¹H NMR (400 MHz, DMSO-d6) δ 8.85 (d, J=6.6 Hz, 2H), 8.29 (d, J=6.6 Hz, 2H), 8.18 (d, J=16.4 Hz, 1H), 8.10 (s, 1H), 7.90-7.82 (m, 2H), 7.77 (d, J=8.8 Hz, 1H), 7.62 (d, J=16.1 Hz, 1H), 7.30-7.23 (m, 3H), 7.21 (dd, J=8.9, 2.3 Hz, 1H), 6.96 (d, J=7.8 Hz, 2H), 6.94-6.89 (m, 4H), 6.07 (d, J=6.4 Hz, 1H), 5.36 (t, J=4.8 Hz, 1H), 4.73-4.58 (m, 2H), 4.43-4.32 (m, 1H), 3.97-3.82 (m, 2H), 3.67 (d, J=13.7 Hz, 1H), 3.54 (t, J=4.6 Hz, 2H), 3.51-3.43 (m, 1H), 3.20 (d, J=3.2 Hz, 6H), 2.25 (s, 6H). HRMS (ESI-TOF): m/z [M-Br₂]²⁺ calcd. for C₃₈H₄₃Br₂N₃O₂: 571.77 (salt: 733.57), found: 572.30.

### Example 5: Staining of Cells with the Dyes

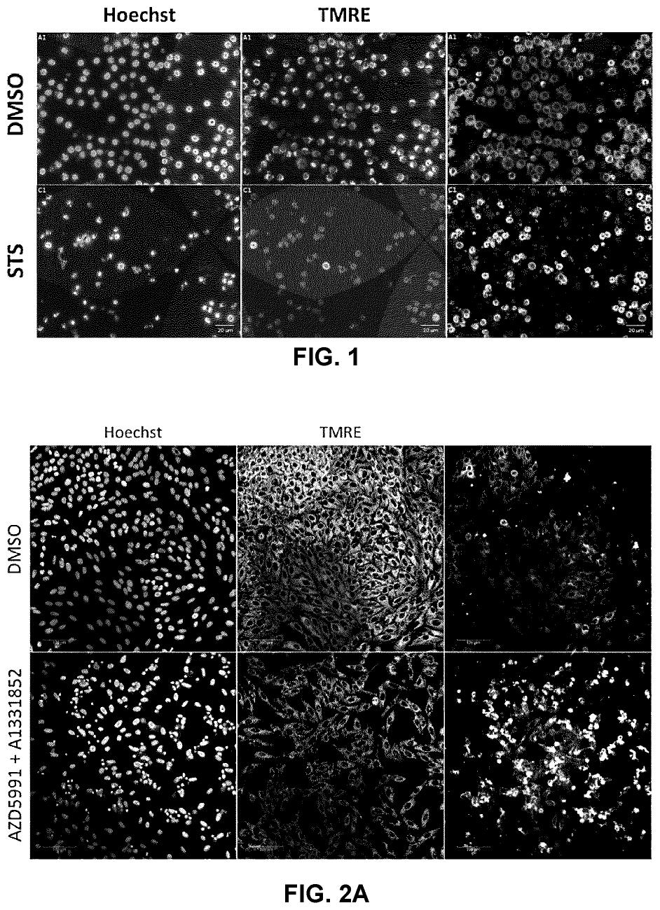

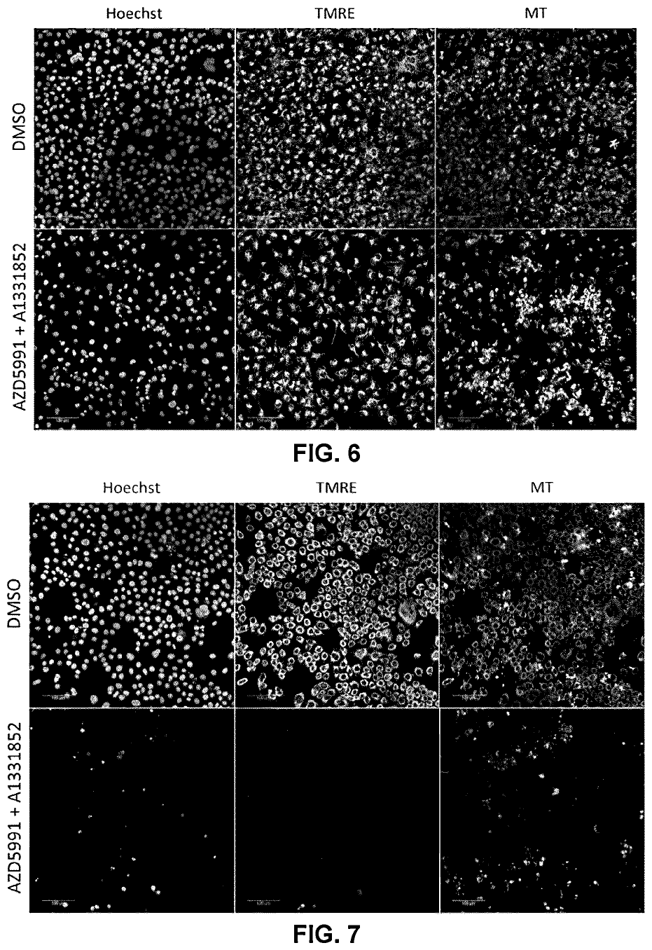

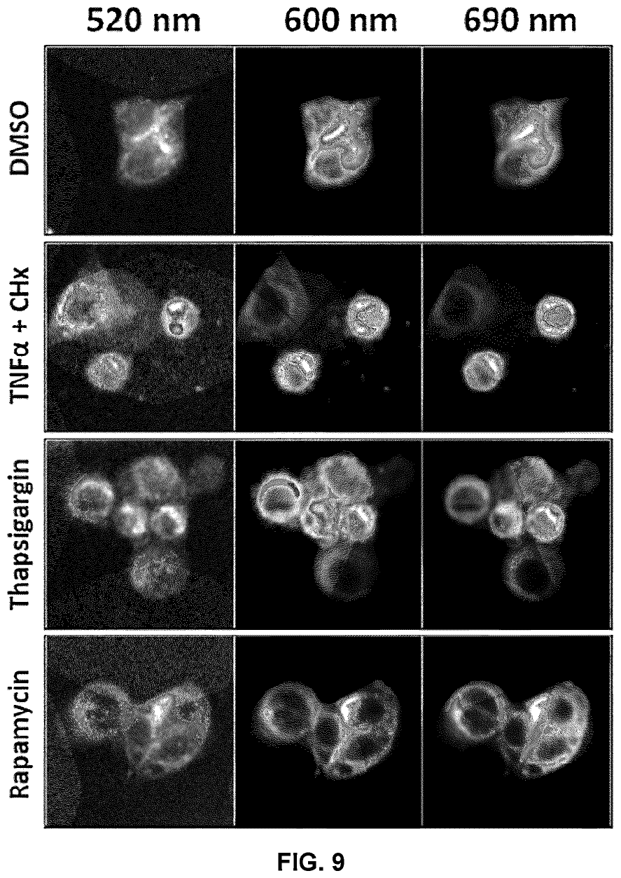

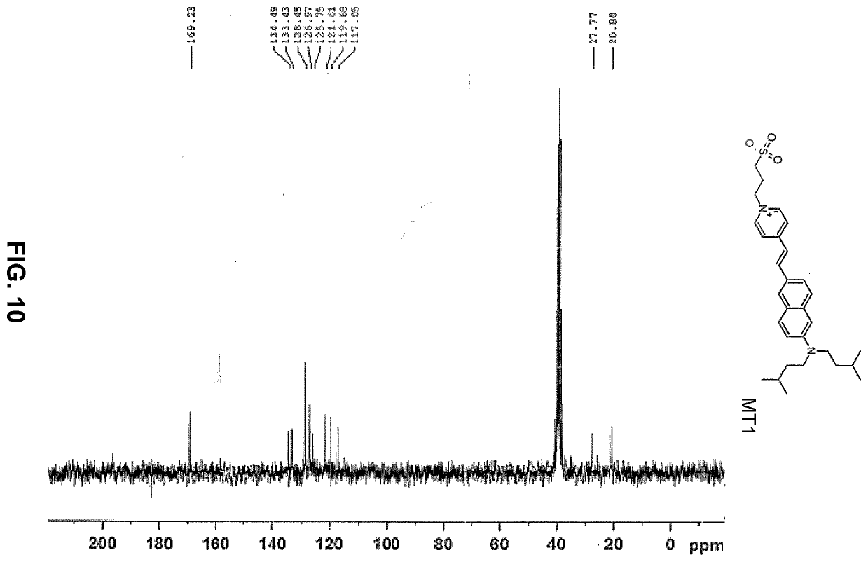

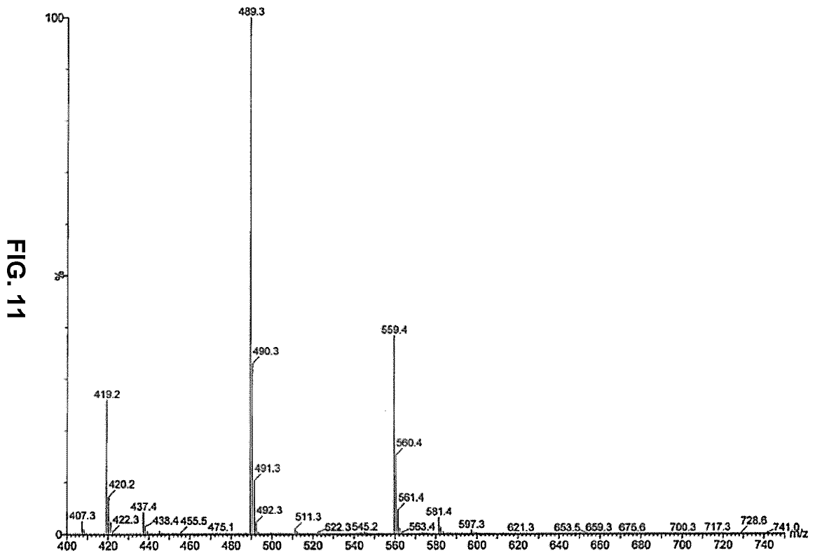

The results reported in FIGS. 1 to 8 show that the treatment of primary cells (lymphocytes) and cell lines (tumoral) stained with the representative dyes MT2 (FIGS. 1 and 9) or MT3 (FIGS. 2-8) with agents that induce cell death such as the pan-kinase inhibitor staurosporine and inhibitors of the anti-apoptotic Bcl-2 family proteins Mcl-1 (AZD 5991) and Bcl-XL (A1331852) leads to an increase in fluorescence intensity of the dyes in cells sensitive to these drugs but not in chemoresistant cells. These changes in fluorescence emission properties were shared by all dyes tested (MT2-MT5). MT2 and MT3 were typically shown to have better fluorescence intensity at low micromolar staining concentrations (e.g., 1 μM) and better signal-to-noise ratios relative to MT4 and MT5. In chemoresistant Zr-75-1 epithelial breast ductal carcinoma cells, cells with condensed nuclei (Hoechst staining) did not show bright MT3 staining (FIG. 5). The results shown in FIGS. 2B-E and 3 show that compared to Hoechst that stains the same structures in a predictable way, MT3 stains the plasma membrane under certain conditions and stains the nuclei under other conditions, and thus provides more information about the cell state. For example, MT3 was shown to stain normal cells with different intensities and drug-treated dying cells very brightly (FIG. 2D). The intensity of the staining with TMRE was shown to correlate with metabolic activity, with drug-treated dying cells showing reduced metabolic activity as evidenced by low staining with TMRE relative to control cells (FIGS. 2E and 3).

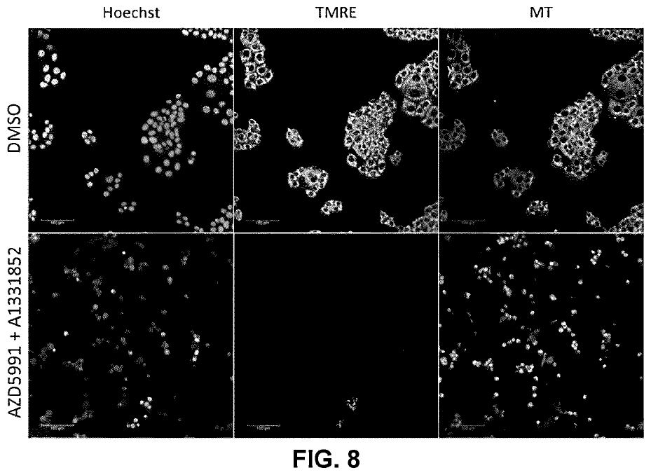

These results show that the dyes according to the present disclosure do not behave like other dyes. In the figures, Hoechst stains DNA in the nucleus, and if the nucleus condenses that staining becomes bright (i.e., more dye per unit area). The MT3 images in FIG. 2D show that the Hoechst staining does not predict MT3 staining in every case. In FIG. 2A, the TMRE gets dim and MT3 gets bright but again TMRE intensity does not predict MT3 intensity in all cells. Also, in FIG. 2 (MCF10A cells), MT3 staining is not confined to nuclei whereas in FIG. 3 (CAMA-1 cells) it is, demonstrating that the staining pattern of the dyes according to the present disclosure may vary from one cell type to another. In FIG. 2E, the TMRE staining has almost completely disappeared in drug treated cells, whereas MT3 is staining the nuclei. Also, it may be observed that the staining intensity of Hoechst and MT3 does not always correlate, which indicates that MT3 provides information about cell state that is different from Hoechst. Comparing FIG. 3 and FIG. 4, it may be seen that in both cases Hoechst condenses somewhat and TMRE disappears, but in this case Hoechst and MT3 staining are mutually exclusive so the cells in FIG. 4 do not behave the same as those in FIG. 3, which could not be detected with the other dyes. FIGS. 7 and 8 have similar lack of staining for TMRE, FIG. 7 is similar to FIG. 4 where the staining with Hoechst and MT3 are mutually exclusive, and FIG. 8 is similar to FIG. 3 where MT3 is staining nuclei where the Hoechst has not condensed. A comparison of FIGS. 2 (MCF10A cells) and 6 (MDA-MB-231 cells) also demonstrates that in the DMSO-treated cells, the MT3 staining, but not that with the other two dyes, is different. These results clearly show that the dyes according to the present disclosure have a staining pattern and behavior that differ from that of other dyes and provide information about the cells (e.g., cell type, cell state, etc.) that cannot be obtained with other dyes.

FIG. 9 shows the staining of MCF-7 breast epithelial cancer cells stained with 1-5 μM MT2 and treated with drugs that induce autophagy (Rapamycin), endoplasmic reticulum (ER) stress (Thapsigargin), or apoptosis (Tumor Necrosis Factor alpha, TNFα, and Cyclohexamide, CHx). The dye was excited at 488 nm, and emission was simultaneously collected at three wavelengths, 520 (Green), 600 (Red), and 690 (Far Red) nm. The images in FIG. 9 show that the different phenotypic states (autophagy, ER stress and apoptosis) resulted in different staining patterns. Image analysis by machine-learning algorithms trained on measurements of cellular intensity, morphology, and texture features permits to distinguish treatment-specific phenotypic states.

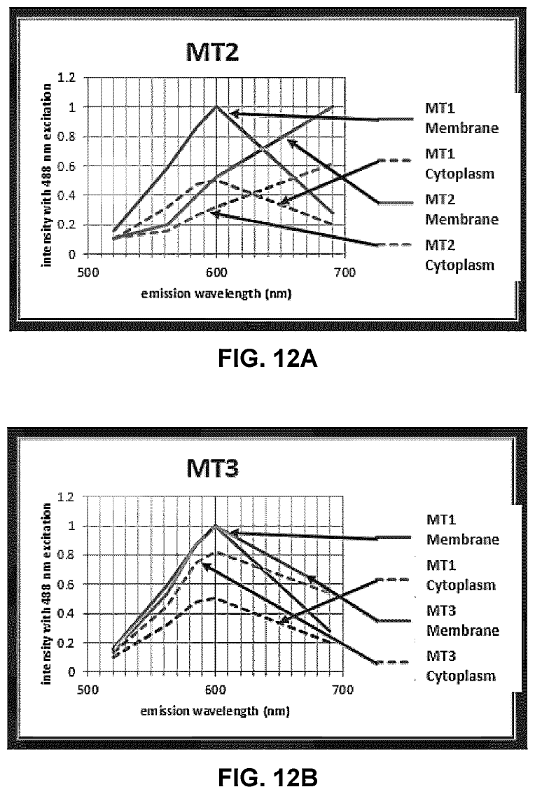

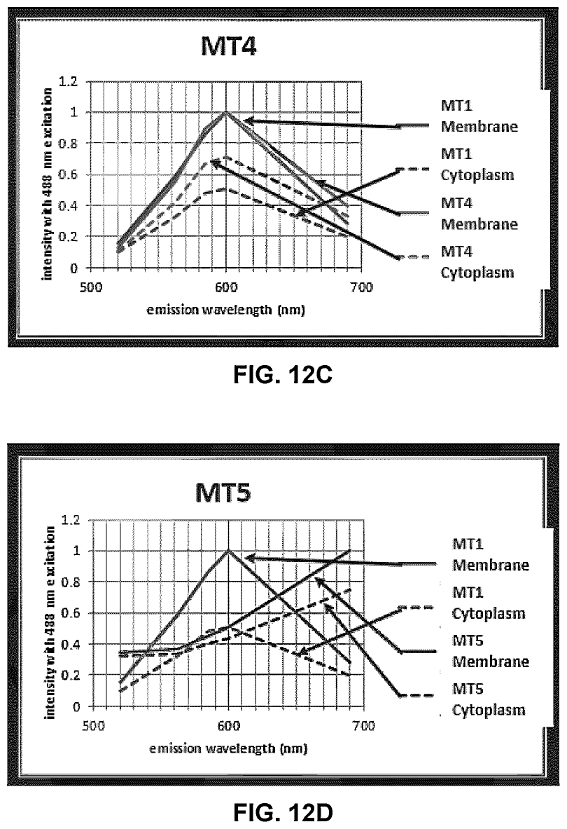

FIGS. 12A-D show the fluorescence intensity at various wavelength (520, 600 and 690 nm) of dyes MT1-MT5 in the plasma membrane and the cytoplasm.

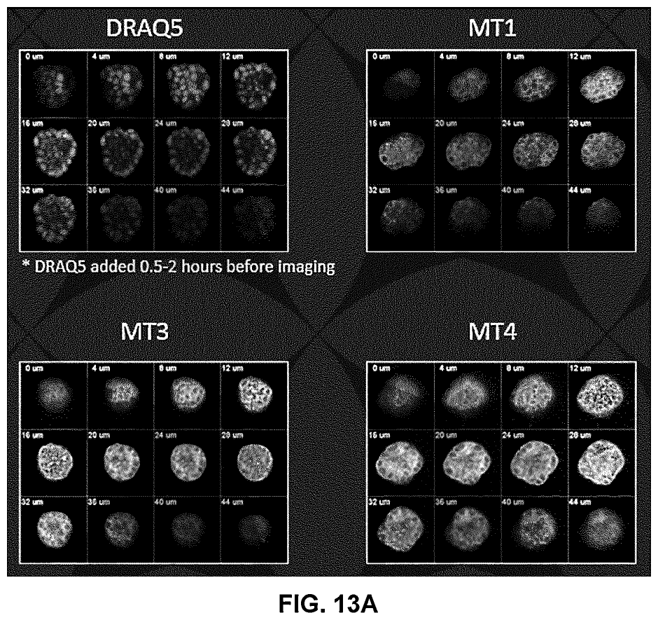

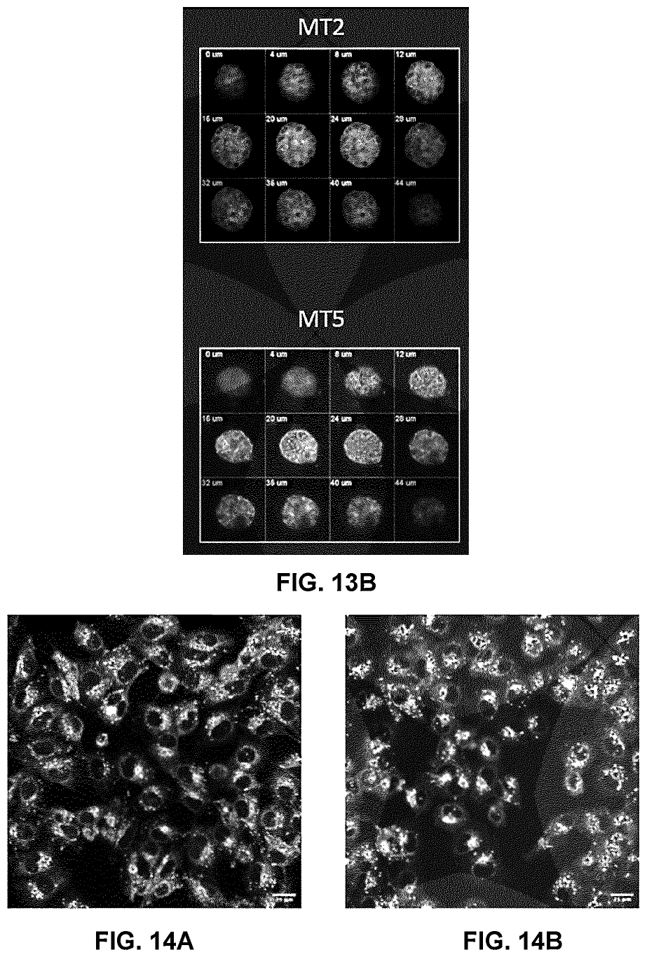

The results depicted in FIGS. 13A-B show that the ascinar structures of non-malignant breast epithelial MCF10A cells is maintained after 19 days in the presence of MT1-MT5 dye, indicating that the dyes are not toxic.

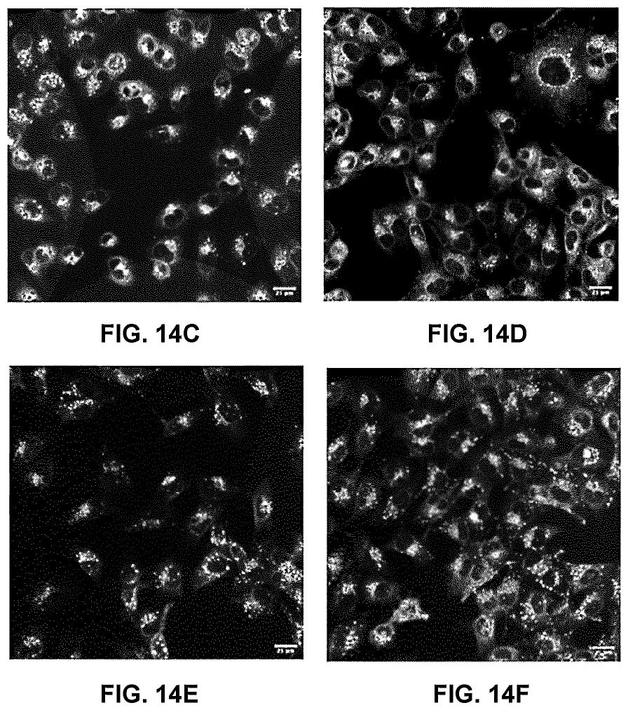

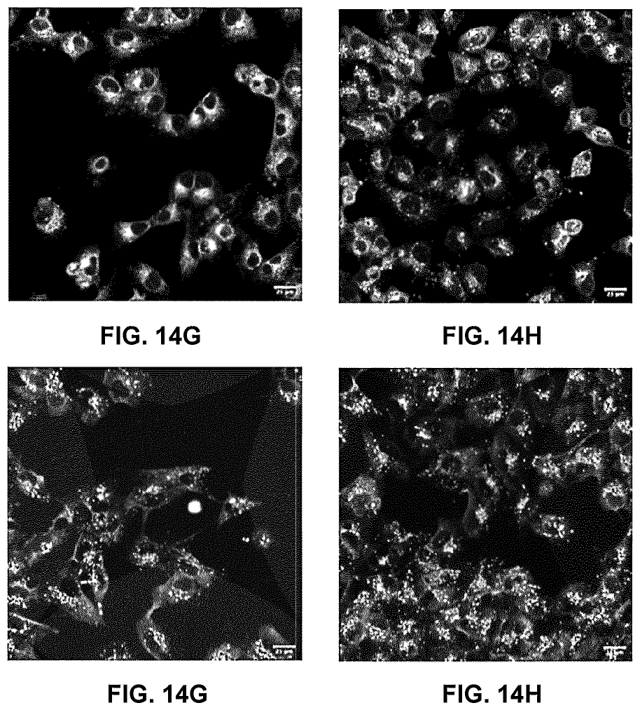

The microscopy images showed in FIGS. 14A-J, show that all dyes tested (MT3, MT20, MT21, MT22, MT23, MT24, MT25, MT26, MT27 and MT28) are cell-permeable and able to stain live cells (here MCF-7 tumoral cells). Used at a standard 1 μM concentration, the proposed dyes produce varying staining patterns and intensities. Furthermore, the proposed dyes display fluorescent properties only when labelling cell organelles and can therefore be used directly without washing steps.

All of the compounds and/or methods disclosed and claimed herein can be made and executed without undue experimentation in light of the present disclosure. While the compounds and methods of this disclosure have been described in terms of preferred embodiments, it will be apparent to those of skill in the art that variations may be applied to the compounds and/or methods and in the steps or in the sequence of steps of the methods described herein without departing from the concept, spirit, and scope of the disclosure. More specifically, it will be apparent that certain agents which are chemically related may be substituted for the agents described herein while the same or similar results would be achieved. All such similar substitutes and modifications apparent to those skilled in the art are deemed to be within the spirit, scope and concept of the disclosure as defined by the appended claims.

1. A dye compound of formula I: 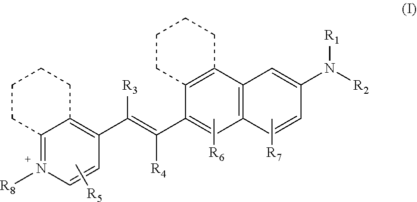
wherein:
R₁ is substituted alkyl_{(C≤14)}, alkenyl_{(C≤14)}, substituted alkenyl_{(C≤14)}, aryl, or substituted aryl;
R₂ is substituted alkyl_{(C≤14)}, alkenyl_{(C≤14)}, substituted alkenyl_{(C≤14)}, aryl, or substituted aryl;
R₃ is hydrogen, Cl, Br, F or CX₃;
R₄ is hydrogen, Cl, Br, F or CX₃;
R₅ is hydrogen, Cl, Br, F or CX₃;
R₆ is hydrogen, Cl, Br, F or CX₃;
R₇ is hydrogen, Cl, Br, F or CX₃; and
R₈ is —(CH₂)ₙSO₃⁻, —(CH₂)ₙN⁺(R₉)₃ or 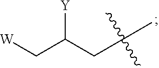
wherein
R₉ is alkyl_{(C≤14)}, substituted alkyl_{(C≤14)}, aryl, or substituted aryl;
Y is H or OH;
W is 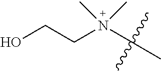
X is H, F, Cl, or Br; and
n is 1, 2, 3, 4, 5, 6, 7, 8, 9 or 10; and
wherein the dotted lines indicate the presence or absence of a phenyl ring or a substituted phenyl ring, wherein the substituent may be one or more selected from Cl, Br, F, CX₃, alkyl_{(C≤14)}, and substituted alkyl_{(C≤14)},
or a salt thereof.

2. The dye compound or salt thereof of claim 1, having the structure of formula II: 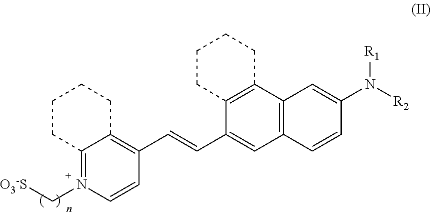
wherein:
R₁ is substituted alkyl_{(C≤14)}, alkenyl_{(C≤14)}, substituted alkenyl_{(C≤14)}, phenyl, or substituted phenyl;
R₂ is substituted alkyl_{(C≤14)}, alkenyl_{(C≤14)}, substituted alkenyl_{(C≤14)}, phenyl, or substituted phenyl; and
n is 1, 2, 3, 4, 5, 6, 7, 8, 9 or 10; and
wherein the dotted lines indicate the presence or absence of a phenyl ring.

3. The dye compound or salt thereof of claim 1, wherein n is an integer from 1 to 5.

4. (canceled)

5. The dye compound or salt thereof of claim 3, wherein n is 3.

6. The dye compound or salt thereof of claim 1, wherein R₁ and/or R₂ is alkenyl_{(C1-6)} or substituted alkenyl_{(C1-6)}.

7. The dye compound or salt thereof of claim 1, wherein R₁ and/or R₂ is phenyl, or substituted phenyl.

8. The dye compound or salt thereof of claim 1, wherein R₁ and R₂ are the same.

9. The dye compound or salt thereof of claim 8, wherein NR₁R₂ is

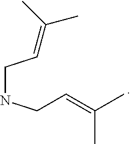

10. The dye compound or salt thereof of claim 8, wherein NR₁R₂ is

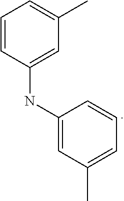

11. The dye compound or salt thereof of claim 1, having a structure selected from:

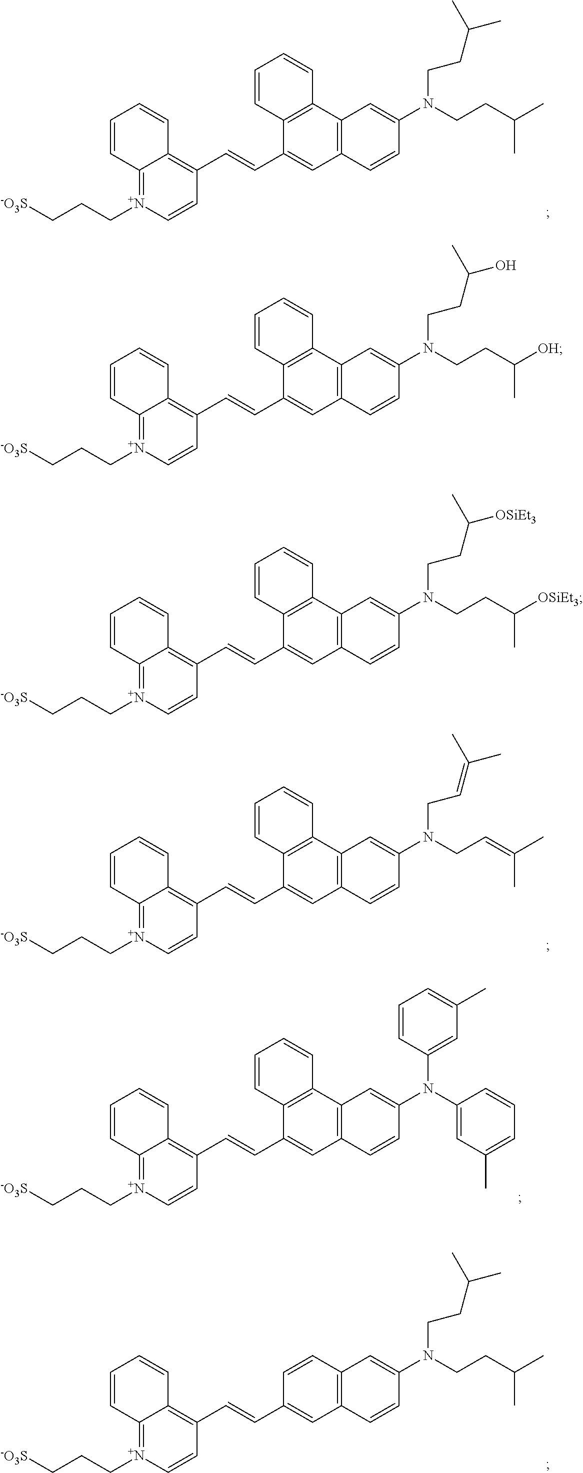

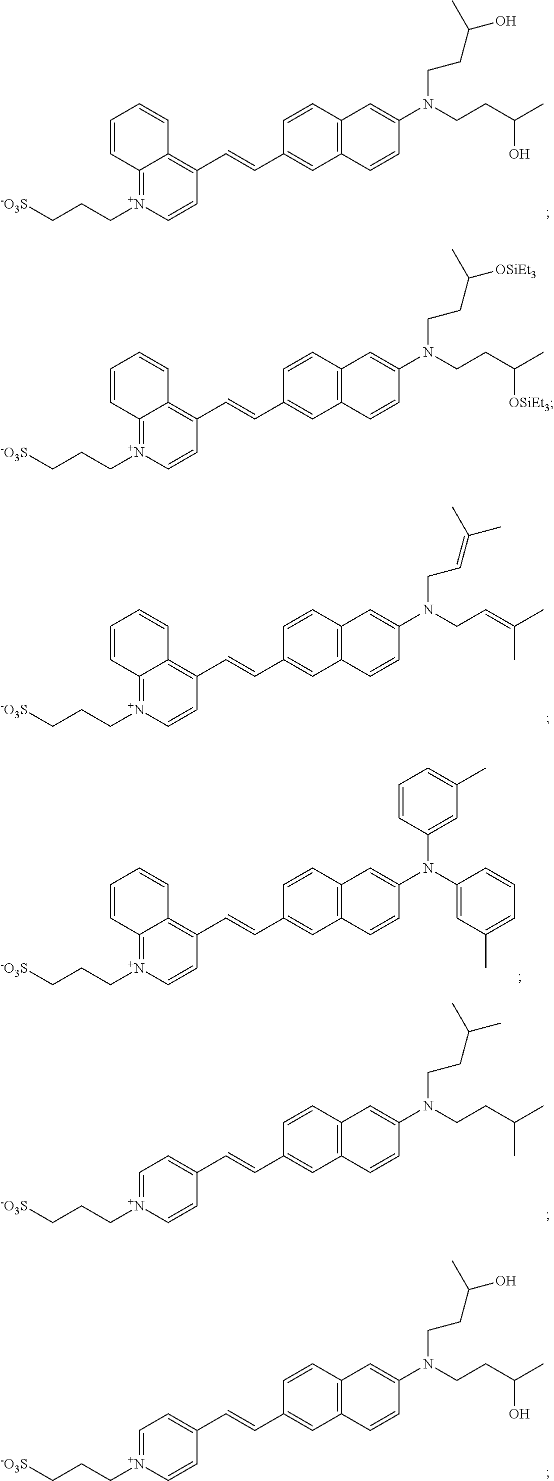

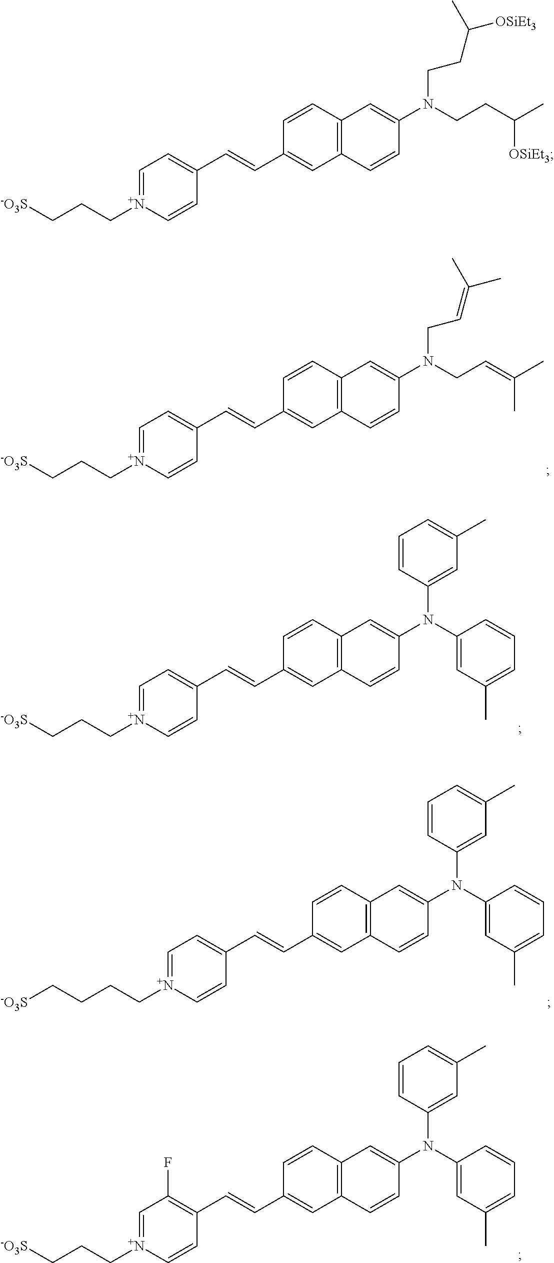

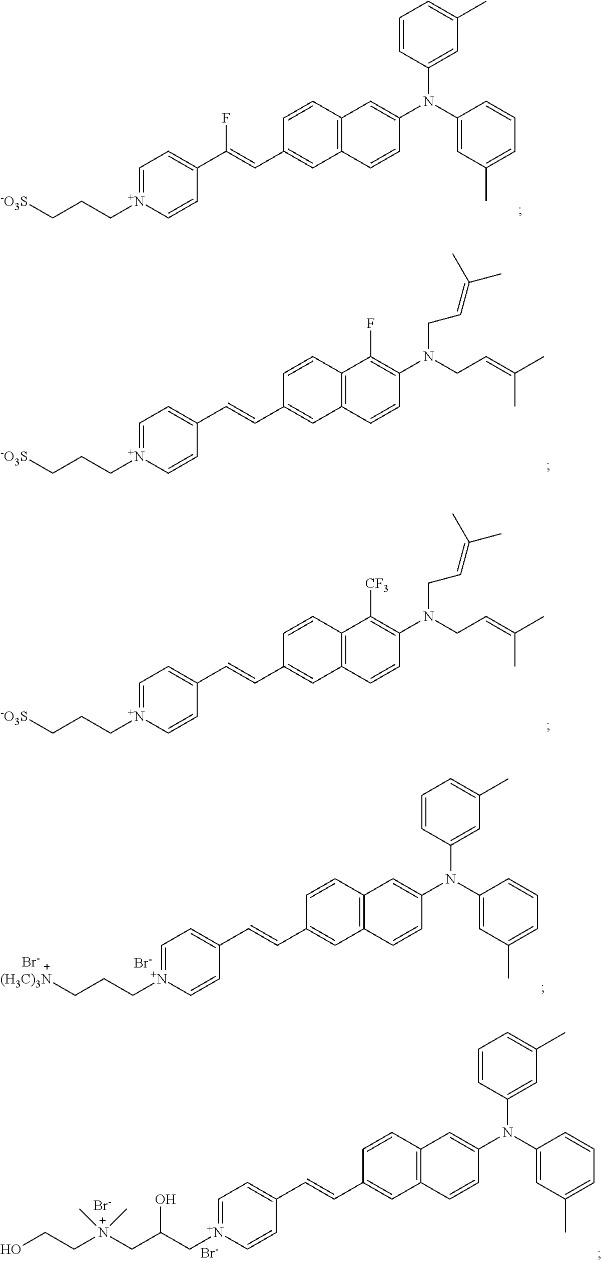

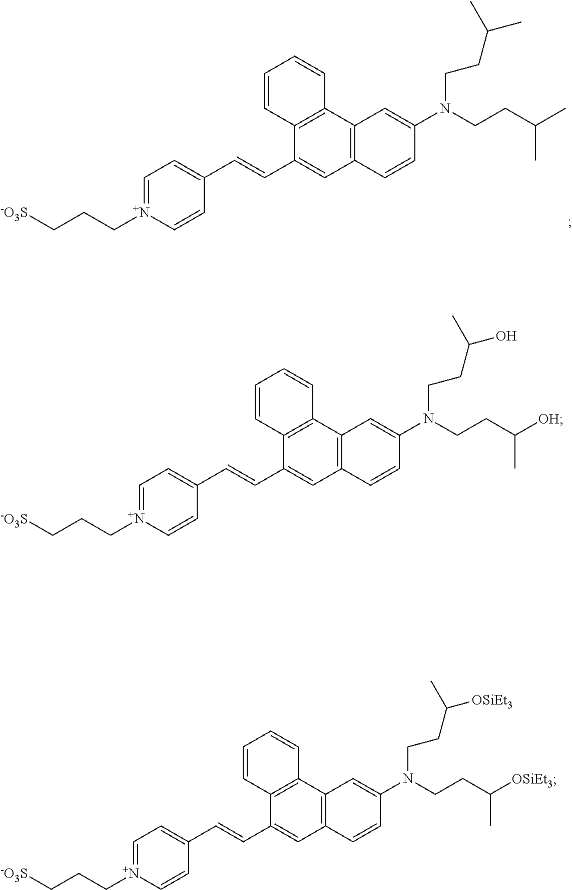

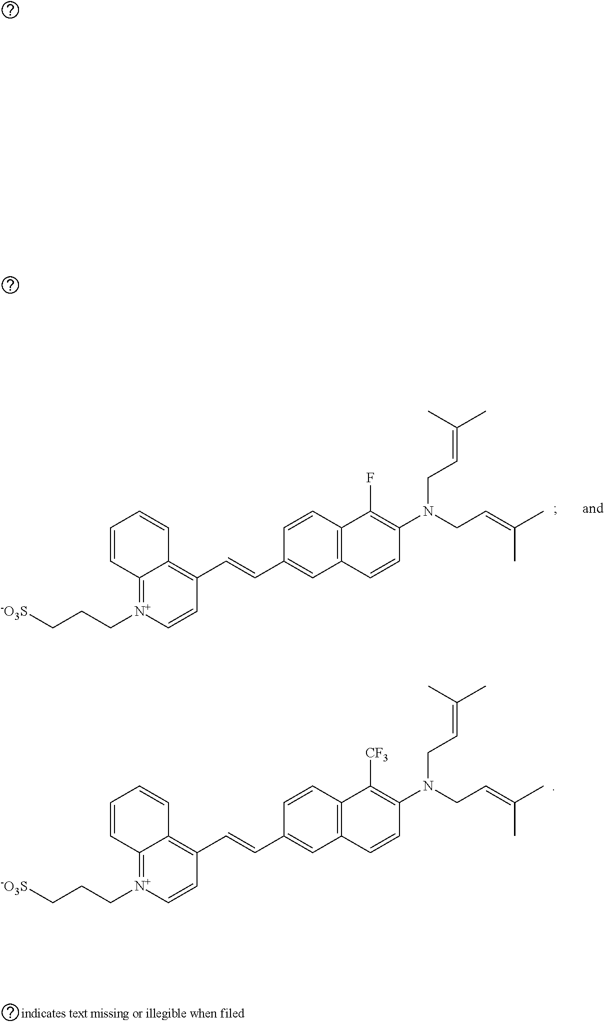

12. The dye compound or salt thereof of claim 11, having the following structure:

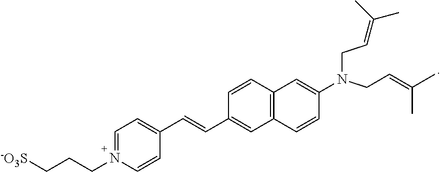

13. The dye compound or salt thereof of claim 11, having the following structure:

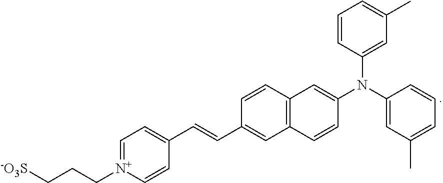

14. A kit comprising the dye compound according to claim 1.

15-16. (canceled)

17. The kit of claim 14, further comprising at least one additional dye.

18. A method for staining a cell comprising contacting the cell with the dye compound or salt thereof according to claim 1.

19. A method for determining whether an agent induces a change in a cell phenotypic state comprising detecting the fluorescence of a dye compound of formula (I): 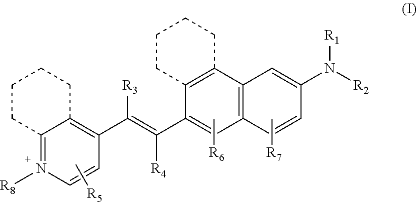
wherein:
R₁ is H, alkyl, substituted alkyl_{(C≤14)}, alkenyl_{(C≤14)}, substituted alkenyl_{(C≤14)}, aryl, or substituted aryl;
R₂ is H, alkyl, substituted alkyl_{(C≤14)}, alkenyl_{(C≤14)}, substituted alkenyl_{(C≤14)}, aryl, or substituted aryl;
R₃ is hydrogen, Cl, Br, F or CX₃;
R₄ is hydrogen, Cl, Br, F or CX₃;
R₅ is hydrogen, Cl, Br, F or CX₃;
R₆ is hydrogen, Cl, Br, F or CX₃;
R₇ is hydrogen, Cl, Br, F or CX₃; and
R₈ is —(CH₂)ₙSO₃⁻, —(CH₂)ₙN⁺(R₉)₃ or 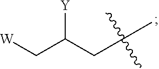
wherein
R₉ is alkyl_{(C≤14)}, substituted alkyl_{(C≤14)}, aryl, or substituted aryl;
Y is H or OH;
W is 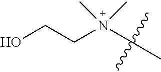
X is H, F, Cl, or Br; and
n is 1, 2, 3, 4, 5, 6, 7, 8, 9 or 10; and
wherein the dotted lines indicate the presence or absence of a phenyl ring or a substituted phenyl ring, wherein the substituent may be one or more selected from Cl, Br, F, CX₃, alkyl_{(C≤14)}, and substituted alkyl_{(C≤14)},
or a salt thereof;
in the cell in the presence or absence of the agent, wherein a change in the florescence intensity and/or distribution in the cell in the presence of the agent relative to the absence thereof is indicative that the agent induces a change in the cell phenotypic state.

20. (canceled)

21. The method of claim 19, wherein the dye compound or salt thereof is the dye compound or salt thereof according to claim 1.

22-24. (canceled)

25. The method of claim 19, wherein the method does not comprise a washing step.

26. The method of claim 18, wherein the method further comprises contacting the cell with at least one additional dye.

27. The method of claim 19, wherein the fluorescence intensity is measured by microscopy or flow cytometry.

28-30. (canceled)
